(19) United States
(12) Patent Application Publication
(10) Pub. No.: US 2015/0026573 A1
(43) Pub. Date: Jan. 22, 2015

(54) Media Editing and Playing System and Method Thereof

(71) Applicant: Zhiping MENG, Guangzhou (CN)

(72) Inventor: Zhiping MENG, Guangzhou (CN)

(21) Appl. No.: 14/333,474

(22) Filed: Jul. 16, 2014

Related U.S. Application Data
(60) Provisional application No. 61/847,060, filed on Jul. 16, 2013.

(51) Int. Cl. G06F 3/0484; G06F 9/445; G06F 3/0482

(52) U.S. Cl. CPC G06F 3/0484; G06F 3/0482; G06F 8/61
USPC 715/716

(57) ABSTRACT

A Media Editing and Playing System includes an editing engine and a playing engine. The editing engine edits a VXPLO media and the playing engine plays the VXPLO media. The VXPLO media includes at least one interactive media elements. The editing engine edits the interactive relationships in between the interactive media elements, and generates a recorder to record the properties of the interactive media elements and the interactive relationships. The playing engine analyzes the recorder and plays the VXPLO media.

### CROSS REFERENCE OF RELATED APPLICATION

This is a non-provisional application that claims the benefit of priority under 35 U.S.C. §119 to a provisional application, application No. 61/847,060, filed Jul. 16, 2013 .

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of Invention

The present invention relates to a media editing and playing system, which generates VXPLO media for easy and convenient transmission.

2. Description of Related Arts

Sharing is a characteristic of the Internet, but to share media through a webpage, the layout of the webpage needs to be changed and the new media file needs to be uploaded. Traditional media files must be inserted within the structure of a webpage, confining the playing of media files within the webpage. This requires a lot of work coding a webpage file. And before a shared media file can be played, it needs to be loaded. The user needs to master webpage programming skills to share media through a webpage. But a common user without webpage programming skills cannot enjoy the fun of media sharing. Also, the size of media files is quite large, and the process of uploading media and loading media takes a lot of time, making for a bad sharing experience.

Rich media is the buzzword of the moment. Rich media can exhibit dynamic motion. This motion can occur over time or in response to an interaction with the user. Hence, human-computer interaction receives heavy focus. People spend lots of time and energy studying human-computer interaction, but often ignore the interaction between media elements. A media element can be an image, video, audio file, text, flash file, etc. Currently, to create the interaction between media elements it is necessary to program using a tool, such as Adobe Flash. Adobe Flash provides a scripting language called Action Script to edit the interaction between media elements, and generate a flash file. That flash file is a media format of Adobe Flash, and contains media elements as resource files. If for example, Adobe Flash is used to edit the interaction between two videos, the size of the flash file generated is quite large and large flash files are difficult to transmit over the Internet. Were there a media format that could keep media elements and the relationship between media elements separate, and could relate the two automatically, the transmission of media files would be greatly improved. Unfortunately, there is no such media format used on the Internet.

Adobe Flash provides a flash player to play a flash file, which must be installed. And flash files can cause browsers to crash, which is one of reasons that iOS (iPhone Operating System) devices do not support flash files. Currently, encoding is the only way to create the interaction between different media elements on different devices, making encoding a necessary skill for interactive design; however, some users have strong design skills, but weak or no encoding background. A lack of encoding skills should not hinder the implementation of creative ideas and the Internet should see more, creative ideas from more people. Therefore, an editing tool to create interaction between media elements with no encoding is a necessity, but there is no such editing tool on the market currently.

Interactive design enhances a user's experience. In general, the provider of the design environment collects opinions of users, and the provider improves the design environment according to the users' opinions. But some users want more than to have their opinions heard—or not. Some want a greater level of participation. They want to customize their design environment by developing their own widgets. However, the common method to improve the design environment is the update method, which lacks the creative input of users.

### SUMMARY OF THE PRESENT INVENTION

The invention is advantageous in that it provides a VXPLO media, which provides a plurality of interactive media elements and a recorder, wherein the recorder records the interactive relationships in between the interactive media elements.

Another advantage of the invention is to provide a media editing and editing system, which provides editing and implementing the VXPLO media.

Another advantage of the invention is to provide a media editing and playing system, which provides an editing engine for editing the VXPLO media, wherein the editing engine provides for creating a plurality of interactive media elements and editing the interactions in between the plurality of interactive media elements, and then generating a recorder for recording the properties of each of the interactive media elements and interactive relationships so as to form the VXPLO media.

Another advantage of the invention is to provide a media editing and playing system, wherein the editing engine provides for setting and editing a plurality of properties of each of the interactive media elements.

Another advantage of the invention is to provide a media editing and playing system, wherein the editing engine provides a graphical user interface for editing the VXPLO media.

Another advantage of the invention is to provide a media editing and playing system, which provides a playing engine for playing VXPLO media.

Another advantage of the invention is to provide a media editing and playing system, wherein the playing engine provides a recorder analysis module for analyzing the recorder.

Another advantage of the invention is to provide a media editing and playing system, wherein the editing engine provides an indicator for indicating the location of the playing engine included in the media editing and playing system, wherein the indicator is easy and convenient to share through network.

Another advantage of the invention is to provide a media editing and playing system, wherein the editing engine and the playing engine are supported through browser, so that the editing and playing the VXPLO media do not require installation of any software.

Another advantage of the invention is to provide a playing tool bar meanwhile a VXPLO media is being played, wherein users conduct a plurality of operations through the playing tool bar when playing a VXPLO media.

Another advantage of the invention is to provide a system to create and use plug-in software applications, wherein the system enables developers to create child applications for a mother application, wherein the child applications appear in the GUI of mother applications as additional functions and widgets.

Another advantage of the invention is to provide a method to create and use plug-in software applications, wherein the method enables developers to create child applications for a mother application, wherein the child applications appear in the GUI of mother applications as additional functions and widgets.

Another advantage of the invention is to provide a graphic user interface to create and use plug-in software applications, wherein the graphic user interface enables developers to create child applications for a mother application, wherein the child applications appear in the GUI of mother applications as additional functions and widgets.

Another advantage of the invention is to provide a system to create and use plug-in software applications, wherein the system enables developers to create child applications for a mother application, wherein the child applications appear in the GUI of mother applications as additional functions and widgets, wherein users are capable to select, buy and use the child applications created by the developers.

Another advantage of the invention is to provide a method to create and use plug-in software applications, wherein the method enables developers to create child applications for a mother application, wherein the child applications appear in the GUI of mother applications as additional functions and widgets, wherein users are capable to select, buy and use the child applications created by the developers.

Another advantage of the invention is to provide a graphic user interface to create and use plug-in software applications, wherein the graphic user interface enables developers to create child applications for a mother application, wherein the child applications appear in the GUI of mother applications as additional functions and widgets, wherein users are capable to select, buy and use the child applications created by the developers.

Another advantage of the invention is to provide a system to use a VXPLO media, wherein users are capable of access the VXPLO medias from a mobile device.

Another advantage of the invention is to provide a method to use a VXPLO media, wherein users are capable of access the VXPLO medias from a mobile device.

Another advantage of the invention is to provide a graphic user interface to use a VXPLO media, wherein users are capable of access the VXPLO medias from a mobile device.

Another advantage of the invention is to provide a system to use a VXPLO media, wherein users are capable of access the VXPLO medias from a mobile device, wherein users are capable of selecting which VXPLO medias to be accessed from their mobile devices, meanwhile the mobile device is capable of automatically acquire certain VXPLO medias to be accessed from the mobile device according to remote instructions from an application server.

Another advantage of the invention is to provide a method to use a VXPLO media, wherein users are capable of access the VXPLO medias from a mobile device, wherein users are capable of selecting which VXPLO medias to be accessed from their mobile devices, meanwhile the mobile device is capable of automatically acquire certain VXPLO medias to be accessed from the mobile device according to remote instructions from an application server.

Another advantage of the invention is to provide a graphic user interface to use a VXPLO media, wherein users are capable of access the VXPLO medias from a mobile device, wherein users are capable of selecting which VXPLO medias to be accessed from their mobile devices, meanwhile the mobile device is capable of automatically acquire certain VXPLO medias to be accessed from the mobile device according to remote instructions from an application server.

Another advantage of the invention is to provide a graphic user interface for creating and editing a VXPLO media.

Another advantage of the invention is to provide a system for creating and editing a VXPLO media.

Another advantage of the invention is to provide a method for creating and editing a VXPLO media.

Another advantage of the invention is to provide a graphic user interface for creating and editing the VXPLO media, wherein the graphic user interface comprises a tool panel.

Another advantage of the invention is to provide a graphic user interface for creating and editing the VXPLO media, wherein the graphic user interface comprises a property panel.

Another advantage of the invention is to provide a graphic user interface for creating and editing the VXPLO media, wherein the graphic user interface comprises an object panel.

Another advantage of the invention is to provide a graphic user interface for creating and editing the VXPLO media, wherein the graphic user interface comprises a timeline panel.

Another advantage of the invention is to provide a graphic user interface for creating and editing the VXPLO media, wherein the graphic user interface comprises a history panel.

Another advantage of the invention is to provide a graphic user interface for creating and editing the VXPLO media, wherein the graphic user interface comprises a menu bar.

Another advantage of the invention is to provide a method for creating a VXPLO media, wherein users are capable of creating a VXPLO media through creating at least one interactive media elements.

Another advantage of the invention is to provide a system for creating a VXPLO media, wherein users are capable of creating a VXPLO media through the system.

Another advantage of the invention is to provide a system for editing a VXPLO media, wherein users are capable of editing a VXPLO media through the system.

Another advantage of the invention is to provide a method to create an interactive media element of the VXPLO project with the graphic user interface, wherein users are capable of using mouse-dragging operations to define the position and size of an interactive media element, and further to create it.

Another advantage of the invention is to provide a method to create an interactive media element of the VXPLO project with the graphic user interface, wherein users are capable of using mouse-dragging operations to create an interactive media element.

Another advantage of the invention is to provide a method to create an interactive media element of the VXPLO project with the graphic user interface, wherein users are capable of using mouse-dragging operations to edit an interactive media element.

Another advantage of the invention is to provide a tool panel within the above-mentioned graphic user interface, wherein users are able to use tools or widgets from the tool panel to create an interactive media element within the VXPLO media.

Another advantage of the invention is to provide a property panel within the above-mentioned graphic user interface, wherein users are capable of editing a plurality of properties of each selected interactive media element within the VXPLO media.

Another advantage of the invention is to provide an object panel within the above-mentioned graphic user interface, wherein the object panel further comprises an object three, which is a graphic structure comprising a set of graphic items shown as nodes organized in a tree structure.

Another advantage of the invention is to provide an object panel within the graphic user interface, wherein each node in the object tree corresponds to an interactive media element within the VXPLO media, wherein the organization of the nodes reflects certain properties and structure of the interactive media elements the nodes corresponding to.

Another advantage of the invention is to provide an object panel within the graphic user interface, wherein users are capable of managing or editing the interactive media elements through managing or editing the nodes in the object tree corresponding to the interactive media elements.

Another advantage of the invention is to provide a parent-child relationship in between the interactive media elements within the VXPLO media, wherein a parent element affects its child elements in certain properties.

Another advantage of the invention is to provide a method to create an animation based on an interactive media element, wherein users are capable of setting the whole animation process through setting the properties of an interactive media element on a certain key time points.

Another advantage of the invention is to provide a method to set the properties of an interactive media element to change over a period of time.

Another advantage of the invention is to provide a graphic user interface to set the properties of an interactive media element to change over a period of time.

Another advantage of the invention is to provide a system to play the VXPLO media, wherein the properties of the interactive media elements within the VXPLO media are capable to change over a period of time.

Another advantage of the invention is to provide a method to play the VXPLO media, wherein the properties of the interactive media elements within the VXPLO media are capable to change over a period of time.

Another advantage of the invention is to provide a timer element, wherein users are capable of managing and editing the changing of certain properties of an interactive media element through a period of time.

Another advantage of the invention is to provide a track element, wherein users are capable of editing the changing process of the properties of an interactive media element using the track element.

Another advantage of the invention is to provide a method for including multiple timer elements within a VXPLO media, wherein one timer element may trigger certain actions of another timer element.

Another advantage of the invention is to provide a graphic user interface for including multiple timer elements within a VXPLO media, wherein one timer element may trigger certain actions of another timer element.

Another advantage of the invention is to provide a system for including multiple timer elements within a VXPLO media, wherein one timer element may trigger certain actions of another timer element.

Another advantage of the invention is to provide a method for the VXPLO media to interact with operations of the viewer of the VXPLO media, wherein the user operations include mouse operations, touch or tap operations, keyboard operations, physical operations of mobile devices transmitted by physical sensors.

Another advantage of the invention is to provide a system for the VXPLO media to interact with operations of the viewer of the VXPLO media, wherein the user operations include mouse operations, touch or tap operations, keyboard operations, physical operations of mobile devices transmitted by physical sensors.

Another advantage of the invention is to provide a graphic user interface to create a VXPLO media, wherein the VXPLO media is able to interact with operations of the viewer of the VXPLO media, wherein the user operations include mouse operations, touch or tap operations, keyboard operations, physical operations of mobile devices transmitted by physical sensors.

Another advantage of the invention is to provide a method for the interactive media elements within the VXPLO media to interact with each other, wherein the satisfying of certain conditions of one interactive media element is capable of triggering another one or multiple interactive media elements to perform certain actions.

Another advantage of the invention is to provide a system for the interactive media elements within the VXPLO media to interact with each other, wherein the satisfying of certain conditions of one interactive media element is capable of triggering another one or multiple interactive media elements to perform certain actions.

Another advantage of the invention is to provide a graphic user interface for editing and creating a VXPLO media, wherein the interactive media elements within the VXPLO media are able to interact with each other, wherein the satisfying of certain conditions of one interactive media element is capable of triggering another one or multiple interactive media elements to perform certain actions.

Another advantage of the invention is to provide a graphic user interface for editing and creating a VXPLO media, wherein the VXPLO media is capable of interact with or respond to operations of the viewer of the VXPLO media.

Another advantage of the invention is to provide an event element, wherein users are able to create and edit interactive relationships in between the interactive media elements within a VXPLO media through the event element.

Another advantage of the invention is to provide an event element, wherein users are able to create and edit interactive relationships between interactive media elements within a VXPLO media and the operations of the viewer of the VXPLO media through the event element.

Another advantage of the invention is to provide a triggering element, a triggering condition, a target element and a target function, wherein the satisfying of the triggering condition of the triggering element triggers the target element to perform the target function.

Another advantage of the invention is to provide a graphic user interface to create and edit an event element, wherein through the event element, interactive relationships of the interactive media elements within a VXPLO media are created and edited, wherein the interactive relationships of the interactive media elements comprise the interaction in between the interactive media elements, and the interactive relationships in between the interactive media element and the operations of the viewer of the VXPLO media.

Another advantage of the invention is to provide a method to realize the interactive relationships of the interactive media elements within a VXPLO media, wherein the interactive relationships of the interactive media elements comprise the interactive relationships in between different interactive media elements of the VXPLO media, and the interactive relationships in between the interactive media elements and the operations of the viewers of the VXPLO media.

Another advantage of the invention is to provide a system to realize the interactive relationships of the interactive media elements within a VXPLO media, wherein the interactive relationships of the interactive media elements comprise the interactive relationships in between different interactive media elements of the VXPLO media, and the interactive relationships in between the interactive media elements and the operations of the viewers of the VXPLO media.

Another advantage of the invention is to provide a method to create and edit a VXPLO media, wherein the VXPLO media is capable of being displayed on different windows or screens.

Another advantage of the invention is to provide a system to create and edit a VXPLO media, wherein the VXPLO media is capable of being displayed on different windows or screens.

Another advantage of the invention is to provide a graphic user interface to create and edit a VXPLO media, wherein the VXPLO media is capable of being displayed on different windows or screens.

Another advantage of the invention is to provide a method to create and edit a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a method to create and edit a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a system to create and edit a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a graphic user interface to create and edit a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a method to play a VXPLO media, wherein the VXPLO media is capable of being displayed on different windows or screens.

Another advantage of the invention is to provide a system to play a VXPLO media, wherein the VXPLO media is capable of being displayed on different windows or screens.

Another advantage of the invention is to provide a graphic user interface to play a VXPLO media, wherein the VXPLO media is capable of being displayed on different windows or screens.

Another advantage of the invention is to provide a method to play a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a method to play a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a system to play a VXPLO media, wherein the VXPLO media is capable of being displayed on different windows or screens, wherein the VXPLO media displayed on one window or screen is capable of interacting with the VXPLO media displayed on another one window or screen.

Another advantage of the invention is to provide a graphic user interface to play a VXPLO media, wherein the VXPLO media is capable of being displayed on different windows or screens, wherein the VXPLO media displayed on one window or screen is capable of interacting with the VXPLO media displayed on another one window or screen.

The invention is advantageous in that it provides a web case, which provides a plurality of web objects and a sharing code, wherein the sharing code records the interactive relationships in between the web objects.

Another advantage of the invention is to provide a media editing and editing system, which provides editing and implementing the web case.

Another advantage of the invention is to provide a media editing and playing system, which provides an editing engine for editing the web case, wherein the editing engine provides for creating a plurality of web objects and editing the interactions in between the plurality of web objects, and then generating a resource description file for recording the properties of each of the web objects and interactive relationships so as to form the web case.

Another advantage of the invention is to provide a media editing and playing system, wherein the editing engine provides for setting and editing a plurality of properties of each of the web objects.

Another advantage of the invention is to provide a media editing and playing system, wherein the editing engine provides a graphical user interface for editing the web case.

Another advantage of the invention is to provide a media editing and playing system, which provides a playing engine for playing web case.

Another advantage of the invention is to provide a media editing and playing system, wherein the playing engine provides a RDF (resource description file) analysis module for analyzing the resource description file.

Another advantage of the invention is to provide a media editing and playing system, wherein the editing engine provides a sharing code for indicating the location of the playing engine included in the media editing and playing system, wherein the sharing code is easy and convenient to share through network.

Another advantage of the invention is to provide a media editing and playing system, wherein the editing engine and the playing engine are supported through browser, so that the editing and playing the web case do not require installation of any software.

Additional advantages and features of the invention will become apparent from the description which follows, and may be realized by means of the instrumentalities and combinations particular point out in the appended claims.

According to the present invention, the foregoing and other objects and advantages are attained by a system of editing and playing a VXPLO media, comprising an editing engine and a playing engine, wherein said editing engine creates said VXPLO media through creating at least one interactive media elements and a plurality of properties of each of said interactive media elements, wherein said playing engine plays said VXPLO media, through displaying said interactive media elements of said VXPLO media according to said properties of said interactive media elements.

In accordance with another aspect of the invention, the present invention comprises a method of creating a VXPLO media, comprising the steps of:

(a) creating at least one interactive media elements, wherein said interactive media elements further comprises a plurality of content elements, and a plurality of function elements, wherein each of said content elements corresponds to a resource file having media content; and

(b) editing a plurality of properties of each of said interactive media elements;

(c) recording said properties of said interactive media elements into a recorder.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram of a media editing and playing system according to a preferred embodiment of the present invention, illustrating that the media editing and playing system structure.

FIG. 2 is a more detailed block diagram of the structure of the media editing and playing system according to above preferred embodiment of the present invention.

FIG. 3 is a block diagram of the structure of an offline media file generated from the media editing and playing system according to above preferred embodiment of the present invention.

FIG. 4 is a block diagram of the media editing and playing system according to another preferred embodiment of the present invention, illustrating the editing and playing process of playing the web case.

FIG. 5 is a schematic diagram of the indicator according to another preferred embodiment of the present invention, illustrating that the indicator is embedded into a webpage.

FIG. 6 is a flow chart of the working process of the editing engine according to another preferred embodiment of the present invention.

FIG. 7 is a block diagram of the structure of the editing engine of the media editing and playing system according to the preferred embodiment of the present invention.

FIG. 8 is a flow chart of the working process of the playing engine according to another preferred embodiment of the present invention.

FIG. 9 is a block diagram of the structure of the playing engine according to the preferred embodiment of the present invention.

FIG. 10 is a schematic diagram of the web case according to another preferred embodiment of the present invention, illustrating that the playing tool bar of the web case.

FIG. 11 is a schematic diagram of the web case according to another preferred embodiment of the present invention, illustrating that a function window shown on the playing tool bar of the web case.

FIG. 12 is a schematic diagram of the web case according to another preferred embodiment of the present invention, illustrating that another alternative mode of the playing tool bar of the web case.

FIG. 13 is a schematic diagram of the web case according to another preferred embodiment of the present invention, illustrating that another alternative mode of the playing tool bar of the web case.

FIG. 14 is a schematic diagram of the web case according to another preferred embodiment of the present invention, illustrating that another alternative mode of the playing tool bar of the web case.

FIG. 15 is a schematic diagram of the web case according to another preferred embodiment of the present invention, illustrating that another alternative mode of the playing tool bar of the web case.

FIG. 16 is a block diagram of the structure of the editing GUI of the media editing and playing system according to another preferred embodiment of the present invention.

FIG. 17 is a schematic diagram of the tool panel of the editing GUI according to another preferred embodiment of the present invention.

FIG. 18 is a schematic diagram of the property panel of the editing GUI according to another preferred embodiment of the present invention.

FIG. 19 is a schematic diagram of the history panel of the editing GUI according to another preferred embodiment of the present invention.

FIG. 20 is a schematic diagram of the image property panel of the editing GUI according to another preferred embodiment of the present invention.

FIG. 21 is a schematic diagram of the flash property panel of the editing GUI according to another preferred embodiment of the present invention.

FIG. 22 is a schematic diagram of the video property panel of the editing GUI according to another preferred embodiment of the present invention.

FIG. 23 is a schematic diagram of the audio property panel of the editing GUI according to another preferred embodiment of the present invention.

FIG. 24 is a schematic diagram of the html property panel of the editing GUI according to another preferred embodiment of the present invention.

FIG. 25 is a schematic diagram of the timer property panel of the editing GUI according to another preferred embodiment of the present invention.

FIG. 26 is a schematic diagram of the track property panel of the editing GUI according to another preferred embodiment of the present invention.

FIG. 27 is a schematic diagram of the text property panel of the editing GUI according to another preferred embodiment of the present invention.

FIG. 28 is a schematic diagram of the event property panel of the editing GUI according to another preferred embodiment of the present invention.

FIG. 29 is a block diagram of the categorization of the web objects according to another preferred embodiment of the present invention.

FIG. 30-FIG. 34 are schematic diagrams of the process of creating a web object according to another preferred embodiment of the present invention, illustrating selection of a widget in tool panel to create a web object.

FIG. 35-FIG. 37 are schematic diagrams of the process of creating a web object according to another preferred embodiment of the present invention, illustrating that the resource file of the web object being upload from a local device.

FIG. 38 is a schematic diagram of the tree data structure according to another preferred embodiment of the present invention.

FIG. 39 is a schematic diagram of the display order of web objects according to another preferred embodiment of the present invention.

FIG. 40 is a block diagram of the display order of web objects according to another preferred embodiment of the present invention.

FIG. 41 is a block diagram of an alternative display order of web objects according to another preferred embodiment of the present invention.

FIG. 42 is a schematic diagram of the object panel according to another preferred embodiment of the present invention, illustrating the object tree is displayed on the object panel.

FIG. 43 is a schematic diagram of the object tree according to another preferred embodiment of the present invention, illustrating the operation method of the object tree.

FIG. 44 is a schematic diagram of the object tree according to another preferred embodiment of the present invention, illustrating an alternative operation method of the object tree.

FIG. 45 is a schematic diagram of the object tree according to another preferred embodiment of the present invention, illustrating an icon beside a node of the object tree to provide better overview to identify the type of the web object.

FIG. 46 is a schematic diagram of the object panel according to another preferred embodiment of the present invention, illustrating a dropdown menu shown from the object panel.

FIG. 47 is a schematic diagram of the object panel according to another preferred embodiment of the present invention, illustrating an alternative dropdown menu shown from the object panel.

FIG. 48 is a flow chart of the process of creating a web object according to the preferred embodiment of the present invention.

FIG. 49 is a flow chart of the process of creating a displayable object according to the preferred embodiment of the present invention.

FIG. 50 is a flow chart of the process of creating a node in the object tree according to the preferred embodiment of the present invention.

FIG. 51 is a schematic diagram of the object tree according to the preferred embodiment of the present invention, illustrating that the object tree manages the time object.

FIG. 52 is a schematic diagram of the object tree according to another preferred embodiment of the present invention, illustrating that the object tree manages the time object.

FIG. 53 is a schematic diagram of the object tree according to another preferred embodiment of the present invention, illustrating that the object tree manages the timer logic.

FIG. 54 is a flow chart of the editing process of a time object according to the preferred embodiment of the present invention

FIG. 55 is a flow chart of a process of triggering the playing of a timer object according to a preferred embodiment of the present invention.

FIG. 56 is a flow chart of a method of setting properties of the managed objects by a timer object according to a preferred embodiment of the present invention.

FIG. 57 is a schematic diagram of a process of editing a track object according to a preferred embodiment of the present invention.

FIG. 58 is a schematic diagram of the timer according to a preferred embodiment of the present invention, illustrating the controlling of the properties of an object by the timer.

FIG. 59 is a schematic diagram of the timer according to a preferred embodiment of the present invention, illustrating that the position and size of object is changed over a time managed by a timer.

FIG. 60 is a schematic diagram of the timer according to a preferred embodiment of the present invention, illustrating the controlling of the visibility property of another object by the timer.

FIG. 61 is a schematic diagram of the timer according to a preferred embodiment of the present invention, illustrating the controlling of another object on four key points by the timer.

FIG. 62 is a schematic diagram of the changing process of an object according to the preferred embodiment of the present invention.

FIG. 63 is a flow chart of triggering a method to trigger the playing of a timer by another timer according to the preferred embodiment of the present invention.

FIG. 64 is schematic diagram of the timer according to the preferred embodiment of the present invention, illustrating a timer manages four managed objects through four tracks.

FIG. 65 is flow chart of the process of creating an event object according to the preferred embodiment of the present invention.

FIG. 66 is a schematic diagram of the object tree according to preferred embodiment of the present invention, illustrating a method of using object tree to configure event objects.

FIG. 67 is a schematic diagram of the property panel of an event object according to preferred embodiment of the present invention.

FIG. 68-FIG. 70 are schematic diagrams of a process of using the “Set Property” function of an event object on the property panel according to a preferred embodiment of the present invention.

FIG. 71 is flow chart of the working process of an event object during the playing process of a web case according to a preferred embodiment of the present invention.

FIG. 72 is schematic diagram of the working process of event objects according to the preferred embodiment of the present invention, illustrating the participation of the communication module and the RDF analysis module in the working process of the event objects.

FIG. 73 is a schematic diagram of the playing system according to the preferred embodiment of the present invention.

FIG. 74 is a schematic diagram of the playing system according to the preferred embodiment of the present invention, illustrating the interaction between web objects across the two screens through a message server.

FIG. 75 is a schematic diagram of the editing GUI according to the preferred embodiment of the present invention, illustrating setting the properties of an event object under a screen object.

FIG. 76 is a schematic diagram of the editing GUI according to the preferred embodiment of the present invention, illustrating setting the properties of a video properties.

FIG. 77 is a block diagram of the hosting platform according to the preferred embodiment of the present invention, illustrating the structure of the hosting platform.

FIG. 78 is a schematic diagram of the hosting platform according to the preferred embodiment of the present invention, illustrating the process of adding the widgets to the widget panel.

FIG. 79 is a schematic diagram of the GUI of the smart mobile device according to the preferred embodiment of the present invention.

FIG. 80 is a schematic diagram of the GUI of the smart mobile device according to the preferred embodiment of the present invention, illustrating the process of adding child applications to the mother application.

FIG. 81 is a block diagram of a media editing and playing system according to another preferred embodiment of the present invention, illustrating the media editing and playing system structure

FIG. 82 is a more detailed block diagram of the structure of the media editing and playing system according to above preferred embodiment of the present invention.

FIG. 83 is a block diagram of the media editing and playing system according to another preferred embodiment of the present invention, illustrating the editing and playing process of the VXPLO media.

FIG. 84 is a block diagram of the structure of the editing engine of the media editing and playing system according to another preferred embodiment of the present invention.

FIG. 85 is a block diagram of the structure of the playing engine of the media editing and playing system according to the preferred embodiment of the present invention.

FIG. 86 is a flow chart of the working process of the playing engine according to another preferred embodiment of the present invention.

FIG. 87 is a block diagram of the structure of the categories of the interactive media elements according to another preferred embodiment of the present invention.

FIG. 88 is flow chart of the working process of an event element during the playing process of the VXPLO media according to the preferred embodiment of the present invention.

FIG. 89 is schematic diagram of the working process of event elements according to the preferred embodiment of the present invention, illustrating the participation of the communication module and the recorder analysis module in the working process of the event elements.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

The embodiments of the present invention relates to a new type of media format, named as web case 30, as well as the editing, playing system and applications of the web case 30s. A web case 30 comprises of a set web objects, as well as various properties and the interactive relationships of the web objects. A web object is an object that can be created/obtained, read and/or manipulated by a web case 30 playing application. A web case playing application is an application capable of playing the web case 30s, which can be a specified software application installed on a local computer, or an application loaded remotely over a network like the Internet. The web case playing application will be referred to as a playing engine 20 here after. When a web case 30 is being played, the web objects contained in the web case 30 are played according to the properties and the interactive relationships of the web objects.

There are mainly two types of web objects included in a web case 30 of the present invention, the displayable objects, and the non-displayable objects.

The displayable objects are objects that carry media content. A displayable object usually can be displayed by a playing engine 20 directly, and usually corresponds to a resource file. Preferably, the resource file is media resource that carries the media information of the displayable object. While most displayable objects have resource files 31 and can be displayed directly, it is not necessary always the case, for example, a live video broadcast stream can not be displayed when the broadcasting is not started, and since the live video stream is obtained and played in real time, in the process of broadcasting, the video stream can not be saved in a media resource file. In the present invention, the media file of the displayable objects can be in various formats, such as image files (such as jpeg, jpg, PNG files), video files (such as fly, mpeg, avi, mov, wma files), animation files (such as swf, gif files), text files, html files and other existing media formats that are readable by a playing engine 20. The displayable objects provide basic media resources for the content of a web case 30, and every displayable object is a media element of a web case 30. Since the resource files 31 of the displayable objects can be in various formats as mentioned above, the editing and playing system of web case 30s of the present invention are capable of utilizing various existing media files as components of the web case 30s.

The non-displayable objects are objects that cannot be displayed directly by the playing engine 20, but participate in the controlling the playing process of the displayable objects, as well as other non-displayable objects. The non-displayable objects include the timer objects, the track objects, the event objects, the page objects, the layer objects, the screen objects and etc., and in particular embodiments, non-displayable objects can be understood as a set of commands that defines and implements the playing process of the media elements, and is encapsulated into an object. Detailed functions and usage methods of these non-displayable objects will be illustrated later in corresponding embodiments.

Both the displayable and non-displayable objects contained in a web case 30 of the present invention have properties that correspond to the specific type of web objects. For example, every displayable object has one or more display properties, which include the size, location, color, transparency, visibility, rotate angle and other properties that participate in defining the display manner and appearance of a displayable object. The display properties of a media element also include properties not as obvious, such as whether a media element is clickable by a user, whether a media element should be loaded with priority in relate to other media elements within the same web case 30, or whether a video media element is being played or stopped. Similar to the displayable objects, every non-displayable object also has properties that correspond to the specific functions the non-displayable object carries. For example, a timer object is capable of defining the display properties of displayable objects within a specific time interval, thus a timer object will have properties as the length of the specific time interval, the number of displayable objects it controls, and etc. All the properties of a web object within the period of time the web object is being played define the playing process of the web object, and all properties of all the web objects contained in a web case 30 define the playing process of the web case 30.

The interactive relationships of web objects within a web case 30 are preset relationships that define the controlling of one or more web objects by certain user operations, or by other one or more web objects within the same web case 30. In other words, when a web case 30 is being played, the playing process of web objects contained by the web case 30 are capable of being controlled by certain user operations, or by other web objects within in the same web case 30. The case of web object controlling by certain user operation means that certain user operations will result in a change in the playing process of certain web objects. The user operation refers to operations as mouse clicks on displayable objects, keyboard operations, or user touches on certain areas of a touch screen, instructions sending by remote controllers, or physical operations of mobile devices transmitted by physical sensors. For example, when a web case 30 is being played, a user clicks on an image object showing the word “start”, then immediately a video object within the same web case 30 will start playing. The case of web object controlling by other web objects within a same web case 30 has many instances. In one embodiment the change in display properties of one or more displayable objects will cause the change of the display properties of one or more other displayable objects, for example, the disappearing of an image object within a web case 30 will result in the appearing of a text object within the same web case 30. In another embodiment, the non-displayable objects control the displayable objects and possibly other non-displayable objects within the same web case 30, for example, a timer object is capable of set the display properties of one or more displayable objects within a certain period of time the web case 30 is being played, thus with a timer object, the display properties of all displayable objects within the same web case 30 can be dynamically changing over time. More detailed examples of how the interactive properties of web objects within a web case 30 are implemented will be given in corresponding embodiments later.

When a web case 30 is being played, the playing engine 20 loads both the displayable the non-displayable objects, as well as the properties and interactive relationships of the web objects as specified above. Thus, the web case 30 present a new form of media, wherein:

A web case 30 contains media elements in various existing formats, such as image, video, animation, html, text and etc. All the media elements of a web case 30 is loaded and played according to a preset playing process, and this compatibility of various types of media elements makes the web case 30 a richer media form than all these existing media formats;

A web case 30 is played within a playing time, and the length of this playing time is usually of a certain finite value, which is similar to the playing time of a video, for example, a video of an episode of a TV show has a playing time of 30 minutes. The playing time refers to a preset period of time. However, it is also possible that the length of the playing time of a web case 30 is of an indefinite value, examples include the case when the media elements contained in a web case 30 is played continuously in cycles, or when there is no timer objects contained in a web case 30 and the web case 30 is simply showed as an image or static web site. Within the playing time of a web case 30, the properties of either the displayable or non-displayable objects are capable of changing over time, for example, an image object is in the center of the screen when the web case 30 first start playing, and will end up in a corner when the playing process ends. The dynamic properties of all the web objects contained in a web case 30 provide a very flexible form of presentation of the media elements to adapt the content of the web case 30.

Out of the interactive properties of the web objects contained in a web case 30, the playing process of the web case 30 is capable of being controlled by a user or viewer of the web case 30, for example, a user can choose which media elements of the web case 30 he/she wants to watch, to change the appearance of some of the media elements, to play a simple game on the web case 30s as playing video games, or to respond to certain information presented in the web case 30 by simple steps of mouse clicks. The interactive properties of the web objects make the web case 30s of the present invention interactive to a user or viewer, in contrast to most of the exiting media formats, as images, videos, texts, and etc.

It is worth mentioning that although named as “web case 30”, a web case 30 is not necessarily to be played over the web or by a web browser, rather, a web case 30 is possible to be played by an application installed on a local computer or computing device. Preferably, the application is a playing engine 20. In the mean time, a web case 30 can exist as an independent media file, as the image files or the video files, that all necessary information needed to play the web case 30 is encapsulated into this file; It is also possible that the information needed to play a web case 30 is sent to the playing engine 20 separately, thus there is not an independent media file involved in the transmitting and playing process of a web case 30.

Another important aspect of the present invention is a web case 30 editing application that is capable of creating and editing a web case 30. Preferably, the web case 30 editing application is an editing engine 10. The editing engine 10 can run in a local computer/computing device or in a remote server. In particular embodiments of the present invention, the editing engine 10 is firstly stored in a remote server and is then downloaded to the RAM (random-access memory) of a local computer/computing device. In another embodiment, the editing engine 10 functions on the basis of another software application, such as an add-on or plug-in application of a web browser.

An editing engine 10 is capable editing a web case 30, by editing web objects to be contained in a web case 30, as well as the properties and interactive relationships of the web objects. In particular embodiments, the editing engine 10 has a GUI (graphical user interface) for users to create and edit web case 30s.

Thus, a web case 30 is first edited in the editing engine 10, and then played in a playing engine 20. The editing process of a web case 30 by an editing engine 10 will be referred to as the editing mode of a web case 30, while the playing process of a web case 30 by a playing engine 20 will be referred to as the playing mode of a web case 30.

In preferred embodiments of the present invention, it can be understood that a web case 30 is a software application that is programmed with object-oriented programming models, while both the displayable and non-displayable objects are component “objects” of the web case application. In the editing mode of a web case 30, users are capable of creating the component objects, such as displayable objects and non-displayable objects, setting the properties of the objects, as well as setting the interactive relationships in between the objects, thus creating the web case “software application” with the interacting component objects. In a preferred embodiment, users are capable of creating the web case “software application” through an editing engine 10 with a GUI. Then, in the playing mode of a web case 30, the web case “software application” is run by a playing engine 20 to realize the preset playing process. Thereby, the editing and playing process of a web case 30 can be understood as the programming and running process of a software application. The adoption of objects in the editing process of a web case 30 has all benefits brought by object-oriented programming, for example, changing one object within the web case 30 will not cause the whole application of the web case 30 to be changed, properties/attributes and behaviors might be inherited from objects to objects, and etc.

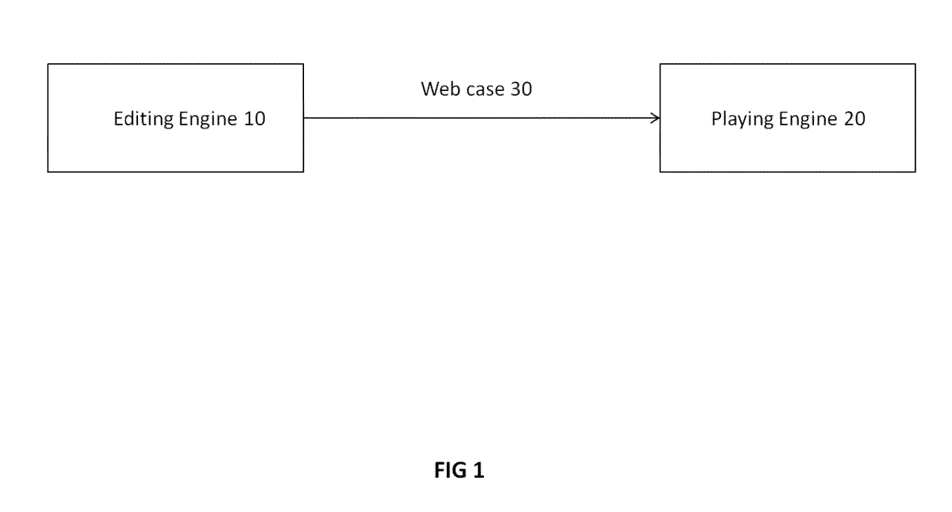

As shown in FIG. 1, the web object editing and playing system of the present invention mainly comprises an editing engine 10 and a playing engine 20.

The editing engine 10 is a locally or remotely operated software application through which a user is able to edit a web case 30, by editing web objects contained the web case 30. The editing of web objects comprises the acts of creating, obtaining, deleting web objects, as well as setting properties, controlling the movements, and defining functions/event operations of the web objects. In one embodiment, the editing engine 10 is an independently operated software application that can be installed on a local computer. In another embodiment, the editing engine 10 is an application installed and operated on the basis of other software applications, for example, a web browser 34, i.e., the editing engine 10 is an add-on or plug-in application of a web browser 34, or a set of instructions or commands directly executable by a web browser 34 to add extra functions onto the web browser 34.

The playing engine 20 is a software application to play the web objects edited by the editing engine 10. Similar to the editing engine 10, the playing engine 20 is possible to be loaded locally or remotely, to be implemented as an independent software application or an application installed and operated on the basis of other software applications. No matter what form does the editing engine 10 or the playing engine 20 take, the core functions of these two engines remain the same, which will be described in more detail in following sections of this specification.

After a web case 30 is edited by the editing engine 10, it is passed to a playing engine 20 for playing. There are various ways a web case 30 can be saved and transmitted to the playing engine 20. In one embodiment, a web case 30 is packaged as an independent media file that can be stored or transferred as the existing Word, Power Point, MPEG, or PDF files, wherein all information required to play a web case 30 is contained in this media file. With this case, the transmitting process of a web case 30 is similar to that of a traditional media file, for example, a video file, while the content of a video can be saved and transmitted within a file as .mpeg, .wma files, and be played by a video playing application such as the windows media player or quick time player.

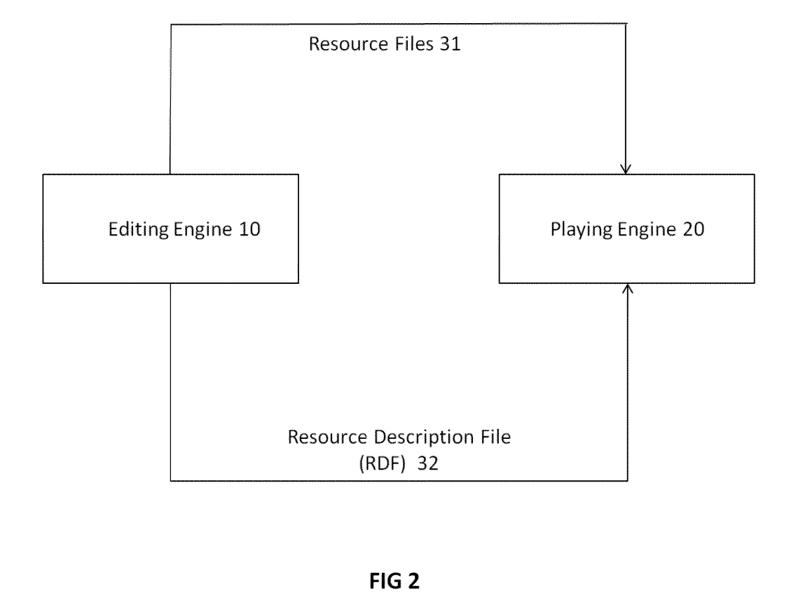

In another embodiment, there is not an explicit file involved in the transmitting process of the web case 30, instead, the information of a web case 30 is transmitted to the playing engine 20 separately. As shown in FIG. 2, the web case 30 is transmitted in two parts: a resource description file 32 (RDF 32), and resource files 31. The resource files 31 are the original media files corresponding to all the displayable objects contained in the web case 30, while the media files can be in various existing formats as image files, video files, animation files, html files and text files. In order to play a web case 30, the resource files 31 need to be sent to the playing engine 20 to provide media resources for forming the media elements of the web case 30. The RDF 32 is a file that contains the information of methods to acquire the resource files 31 of the web objects, as well as the properties and interactive relationships of the web objects set by the editing engine 10. As specified previously, the properties of web objects include display properties of the displayable objects, as the size, color, transparency, visibility, and location of any displayable objects; and functional properties of the non-displayable objects, as the number of objects controlled by a timer object. After the RDF 32 is obtained, the playing engine 20 is able to retrieve and load the resource files 31 of the web objects specified in the RDF 32 and play the web objects in accordance with the properties and interactive relationships set in the RDF 32. In one embodiment, the RDF 32 is a small file that specifies all the property parameter values and the URL of resource files 31 of every web object contained in a web case 30, while the format of the RDF 32 can be in XML, text, json, and etc.

There are many ways for the playing engine 20 to obtain the resource files 31. In one embodiment, the resource files 31 are uploaded by the editing engine 10 and saved to certain predetermined addresses, while the predetermined addresses are specified within the RDF 32 by the editing engine 10. In another embodiment, the resource files 31 are not uploaded by the editing engine 10, rather, they are downloadable from certain addresses and the certain addresses will be specified within the RDF 32 by the editing engine 10. For example, a video resource file already exist in a third-party video hosting website and can be accessed by a URL.

There are also many ways for the playing engine 20 to obtain the RDF 32. In one embodiment, the method to acquire the RDF 32 (the method is usually an address or URL in the local computing device the playing engine is installed, or over a computer network such as the Internet.) is manually input by a user, and the web object player is able to obtain the RDF 32 through a local or remote storage device. In another embodiment, the instruction of downloading the RDF 32 from a specific local or remote address is sent to the playing engine 20 when a specific operation is taken within the playing engine 20, for example, when the user clicks a certain GUI item within the playing engine 20. In yet another embodiment, the RDF 32 and the resource files 31 are packaged into one file executable by the playing engine 20, while the instruction to acquire the RDF 32 is included within the executable file.

In a preferred embodiment, the editing engine 10 is operated on the basis of a web browser 34. The web browser 34 can be any kind of the existing web browsers, as Google Chrome, Firefox, Safari or Microsoft Internet Explorer, while the editing engine 10 is an add-on or plug-in application of the web browser 34, or a set of instructions directly readable by the web browser 34 to perform the functions of web case editing. For example, the editing engine 10 is an application written in java script or html5 that is executable by a web browser 34, and the web browser 34 is able to call the editing engine 10 in order to perform certain functions that are not built in with the web browser 34. In a preferred embodiment, the editing engine 10 is downloaded and installed automatically by a web browser 34 when the web browser 34 visits a certain web address/URL (Uniform Resource Locator) on the Internet or other computer networks. An important benefit of this embodiment is that users will be able to use any existing web browsers to perform the function of an editing engine 10, without the need to download or install any additional applications. This kind of application access is becoming more and more popular with the development of cloud computing technologies, and the applications run/accessed by web browsers are usually called web applications, while the model of such application/software delivery is usually called SaaS (software as a service). The SaaS model of software delivery is advantageous over the traditional delivery method of software in many aspects, as with the SaaS model, users will not need to download, install or update any software, an application of the newest version becomes instantly available to a user once a web browser visits a certain web address, meanwhile, with the SaaS model, users are able to use web applications through various devices and from various locations, as long as the Internet is connected, at last, the software providers will be able to collect software usage information and charge users accordingly, as the access of web applications is overseen and controlled centrally by the software providers.

Similarly, in a preferred embodiment, the playing engine 20 also runs on the basis of a web browser 34, while the web browser 34 automatically downloads and installs the playing engine 20 after visiting a certain web address/URL (Uniform Resource Locator) on the Internet or other computer networks. Thus, the web case 30 edited by the editing engine 10 can be visited and played by any existing web browsers, as long as an address to download the playing engine 20 is specified with the web browser 34.

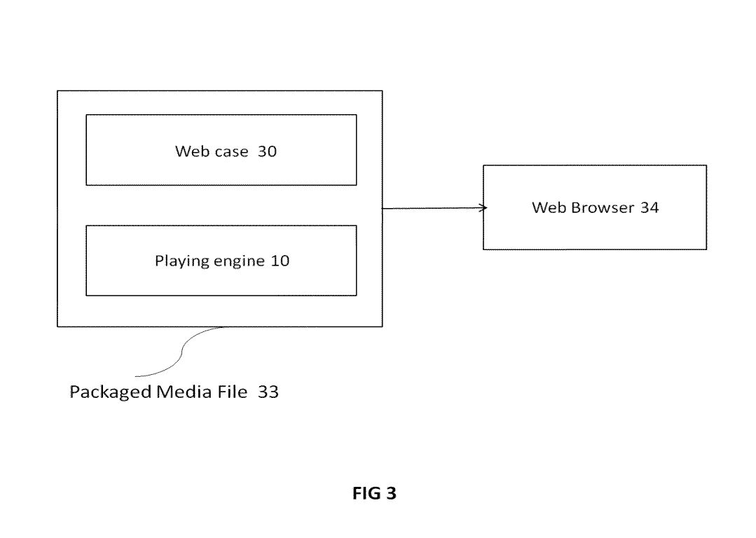

Under the condition that the playing engine 20 functions on the basis of a web browser 34 as illustrated above, it is also possible that the web case 30 and the playing engine 20 are packaged into one file to be passed to a web browser 34 for playing, as shown in FIG. 3. Thus, the web case 30 together with the playing engine 20 form a packaged media file 33 that is playable directly by a web browser 34, and when played, this Packaged Media File 33 are endowed with all characteristics of a web case 30 as specified before. It is noteworthy that the packaged media file 33 is capable of being saved and played locally by a web browser 34, while the web browser 34 does not need to connect to the Internet. Thus, the packaged media file 33 enables an off-line playing mode of a web case 30.

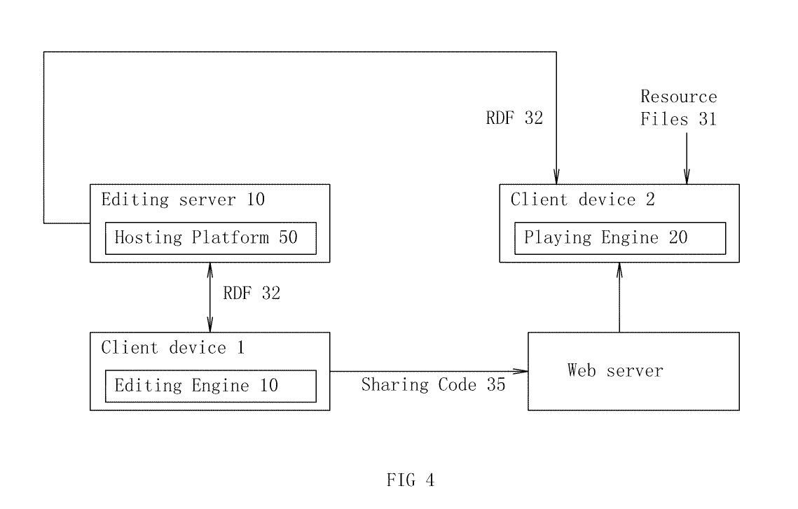

In yet another embodiment, as shown in FIG. 4, the editing and playing system of web case 30s further comprises an editing server, a client device 1, a third-party web server, and a client device 2, besides the editing engine 10 and the playing engine 20. The editing server or the third-party web server is a computer server in normal senses, which is a system that responds to requests across a computer network to provide, or help to provide a network service. The client device 1 and client device 2 are computing devices that are capable of running an editing engine 10/playing engine 20, which can be a smart device, such as a personal computer, a smart phone, a PDA, a tablet PC. In addition, the client device 1 and client device 2 are also required to have network modules to connect to the Internet or other computer networks, as well as to have a web browser 34 installed. It is noted that the client device 1 and client device 2 are named differently only to distinguish the different functions they carry in the system under discussion, the client device 1 and client device 2 can be two devices of exactly the same type, or in rare cases, they can be just one device to perform the two functions. This system works as follows:

The editing engine 10 is firstly stored in the editing server, and when a web browser 34 run on the client device 1 visits a certain web address directed to the editing engine 10, the editing engine 10 is automatically downloaded and installed onto the web browser 34 run on client device 1. The user of client device 1 then use the editing engine 10 run on the basis of the web browser 34 to edit a web case 30, and after editing, the editing engine 10 generates a RDF 32, and uploads the RDF 32 back to the editing server, or to other servers capable of receiving, saving and later answering to request for downloading the RDF 32. It is also possible that the editing server further hosts a hosting platform 60, which is a website through which the download address of the editing engine 10 can be accessed (for example, in the hosting platform 60, a button shows “start editing” is linked to the URL of downloading the editing engine 10, and when a user clicks the button, the editing engine 10 will be downloaded automatically). The hosting platform 60 usually displays webpages containing information related to the editing engine 10, and it can also perform supplemental functions to the editing engine 10, such as user information management, user payment processing and etc. However, the hosting platform 60 is not a necessary component of the system of web object editing and displaying of the present invention. It is also possible that the RDF 32 is not uploaded to any servers, but is saved or stored in the local computer/computing device where the editing browser runs on, while the local computer/computing device is capable of functioning as a server to answer file downloading requests from other computing devices through a computer network as the Internet.

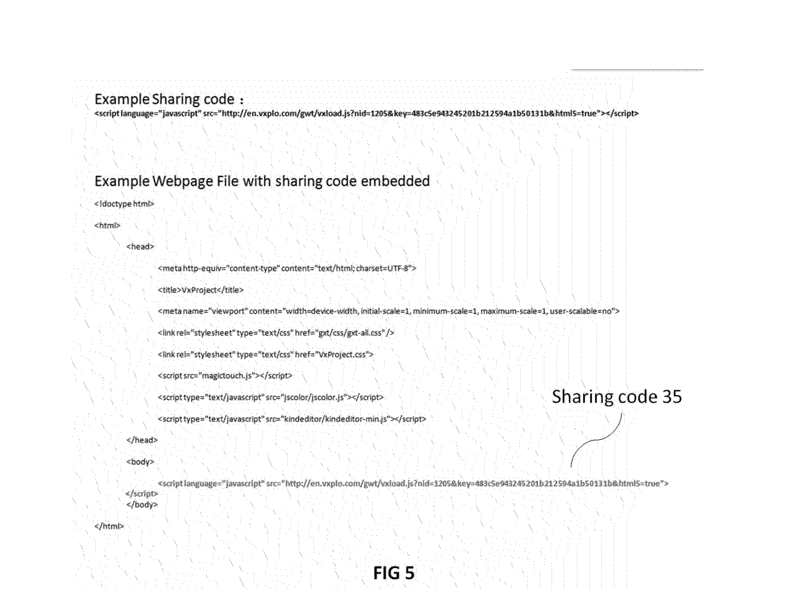

After the RDF 32 is generated and uploaded, the editing engine 10 or the hosting platform 60 further generates a line of sharing code 35, which specifies the address/addresses to acquire the RDF 32 and the playing engine 20 for a web browser 34. The sharing code 35 is then embedded into a webpage file (not shown in FIG. 4) hosted by a third-party web server, manually by a user or automatically by the editing engine 10 or the hosting platform 60. FIG. 5 shows an example of sharing code 35 and an example of a webpage file with sharing code 35 embedded. In this example, the sharing code 35 is a line of code in the language of JavaScript, and is inserted into the “body” section of the webpage file. The webpage file in which the sharing code 35 is embedded can have existing contents, or be an empty html file. If the web page file has existing contents, then after it is visited by a browser, the web case 30 corresponding to the embedded sharing code 35 will be showed together with the existing contents specified in the webpage file. Otherwise, only the web case 30 will be shown after the webpage file is visited.

In the next step, a web browser 34 run on client device 2 visits the address of the webpage file with the sharing code 35 embedded that is hosted in the third-party web server. The webpage file is then analyzed by a web browser 34, the script contained in the sharing code 35 will be run and the RDF 32 and the playing engine 20 will be downloaded automatically by the web browser 34 as instructed by the sharing code 35. The web browser 34 run on client device 2 then installs the playing engine 20, reads the RDF 32 already downloaded to acquire the resources files 34 from the specified address in the RDF 32, and finally plays the web case 30 in accordance with the RDF 32.

This embodiment of web case editing and playing system has many advantages, which is specified as follows:

1. A user is capable of editing and playing a web case 30 using any devices connected to the internet and with a web browser 34, without the need of downloading or installing any software;

2. A web case 30 edited is capable of being shared with a line of sharing code 35, onto any other websites hosted on any third-party web servers, in contrast to the traditional method of media sharing, while the whole media file need to transmitted or uploaded to a server, in order to be accessed by a user. This ease in sharing enables web cases to be spread faster and in a wider range of platforms, for example, a web case 30 can be shared by an individual user on personal blogs, social network pages, or e-commerce sites, simply by embedding a line of code into the webpage file of the corresponding websites, while with traditional media forms, the user needs to upload the whole media file and change the layout of the web page the media file is to be inserted, which are usually impossible for users without web page programming skills.

3. A web case 30 can be inserted into an existing webpage and interact with existing elements of the webpage. For example, a person in a video element within in the web case 30 can “jump out” of the video being played into the webpage the web case 30 is being played together with, then point to a line of text on the webpage to emphasize on that line of text. The reason that this type of interaction is possible is that a web case 30 is loaded and played independently to the loading of other elements contained in the webpage where the web case 30 is embedded, thus the media elements contained in the web case 30 can appear in any place in the webpage without the need to change the original layout of the webpage. This feature makes the web case 30 substantially different from a traditional media files played on the web, while the traditional media files have to be inserted within the structure of the webpage it is to be embedded, which confines the playing of the media files (whether the file is an image, video or animation) within a predetermined area independent of any other media elements contained in the webpage. Also, if any content of traditional media forms need to be changed within a webpage, for example, to delete a video in one location and add some text in another location of a webpage, a lot of work need to be done with the codes of the webpage file; in contrast, with media elements within a web case 30, nothing need to be changed with the original webpage file, rather, all changes of the media elements within a web case 30 is updated automatically with a different RDF 32.

4. When the web case 30 is being played, the web browser 34 in client device 2 only needs to download the playing engine 20 and the RDF 32, which are usually files with small sizes, in contrast to the large size of media files of the traditional forms that need to be loaded fully in order to be played. Moreover, in particular embodiments, the playing engine 20 is saved in the cache memory of the web browser 34, which does not need to be downloaded again after it is firstly downloaded, which makes the web browser 34 in client device 2 only need to fully load the RDF 32 file in order to play a web case 30. Although the resource files 31 that specified in the RDF 32 are usually larger in size, but the resource files 31 can be loaded progressively according to the playing process of a web case 30, which minimizes the time a user/viewer needs to wait before a web case 30 starts playing.

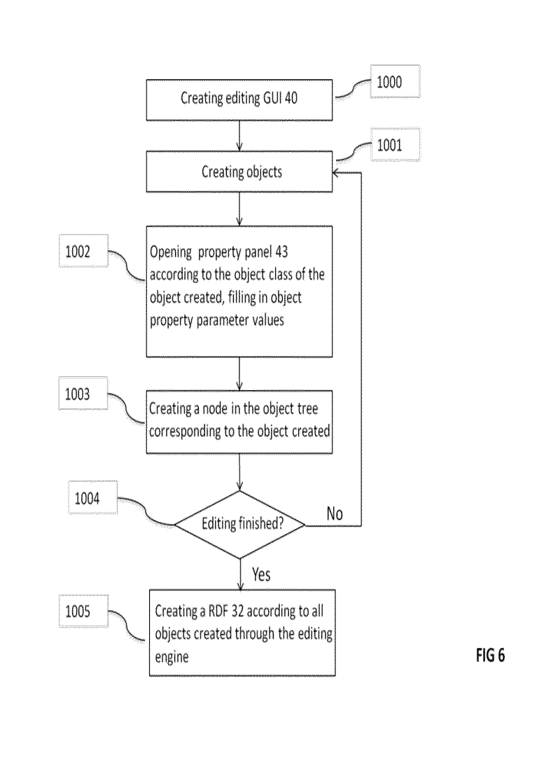

FIG. 6 shows one embodiment of the working process of the editing engine 10. When an editing engine 10 is loaded, it first creates a graphical user interface (GUI) for user editing (step 1000), which will be referred to as the editing GUI 40 here after. The details about the editing GUI 40 will be illustrated later in this specification. In general, the editing GUI 40 provides various tools for users to create, obtain, delete web objects to be contained in a web case 30, as well as to set properties, control the movements, and define functions/event operations of the web objects. The editing GUI 40 usually comprises sub-areas or functional areas that correspond to different functions the editing engine 10 performs. With the editing GUI 40, users do not need to write codes in order to create and edit a web case 30, although modules to accept coding instructions might also be available in the editing engine 10.

After the editing GUI 40 is created, the editing engine 10 detects user input through the editing GUI 40 to create a web object in a certain type, which can be displayable or non-displayable objects, while the exact type of web objects to be created is also inputted by the user and is detected and received by the editing engine 10. After an input to create a certain type of web objects is detected, the editing engine 10 creates the corresponding web object (step 1001). Although not necessary, it is preferred that the created web object will be displayed within the editing GUI 40, if the web object is a displayable object and the resource file 31 of the displayable object is accessible by the editing engine 10. It is also possible that the web objected created is not displayed within the editing GUI 40, especially when the web object is a non-displayable object and do not have any resource files 31. However, in order to make the editing process more intuitive to users, it is preferred that all displayable objects are displayed within the editing GUI 40 after created.

After a web object is created, a property panel 43 according to the type of web object is shown for users to input property parameter values of the web object (step 1002). The property panel 43 is a GUI item or “functional area” within the editing GUI 40 through which users can edit the properties of web objects created. The property panel 43 can be shown as a “panel”, or other forms with the same functions. In a preferred embodiment, there is an object class pool in the editing engine 10 that contains information of all classes of the web objects that can be created and supported by the editing engine 10. A “class” of a web object is a construct that defines a web object type, which at least contains the attributes of web object type, as well as methods/functions associated with the web object type. The attributes of web object type are aspects of properties the web object type have, as the position, the size of an image object type. The attributes vary according to different web object types, for example, the video object type has an attribute of “playing time”, while this attribute does not exist for the image object type. The methods/functions associated with a web object type is the operations that can be performed on the web object type, for example, the “create ( )”, “draw ( )” and “delete ( )” functions. Similarly, the functions/methods vary according to different web objects. The object class pool contains the classes of all web objects the editing engine 10 supports, and when a web object is created, the editing engine 10 retrieve the class information of the type of the web object, and shows corresponding attributes of the web object. The attributes of a certain web object type pass onto each web object of this certain web object type, which means that each web object has the same aspects of properties as the web object type it belongs to. When being applied to a single web object, the attributes will be referred to as property parameters 431 of the web object, which will be shown in the property panel 43 of the web object, and each property parameter 431 has a property parameter value or parameter value to indicate the detailed property of the web object. In a preferred embodiment, after a web object is created, the editing engine 10 automatically fills part of the property parameter values of the web case 30, as default parameter values, while users are capable of change the parameter values later on. It is also possible that a property panel 43 is not shown automatically after a web object is created, rather, users are able to access the property panel 43 or other equivalent GUI items by manually taking certain operations, for example, striking certain keys on the keyboard.

After a web object is created, it is also possible that the editing engine 10 further creates a node corresponding to the web object in an object tree (step 1003). Although this step is not necessary in the process of web object editing, it is preferred to have such a step in order to help users organize and manage different web objects within a web case 30. The web object tree is a GUI item within the editing GUI 40 comprising nodes organized in a tree-like structure, while every node within the object tree is a representation of a web object within the web case 30. The arrangement of the nodes in the object tree shows certain relationships in between the web objects the nodes represented. Also, certain operations on the nodes might be equivalent to certain operations on the represented web objects. Detailed description of the usage of the object tree will be provided later in this disclosure. In general, the object tree is a tool for users to more conveniently manage web objects within a web case 30. A node within the object tree is usually created immediately after the web object it represented is created.

The editing process of web objects as illustrated in step 1002 to step 1004 will be repeated as new web objects are created and edited, until the editing engine 10 detects a user input indicating the end of the editing session (step 1004). For example, when a “save” button within the editing GUI 40 is clicked. Then, the editing engine 10 will create an RDF 32 (Resource Description File) describing the types and properties of all web objects already created, as well as the method (usually a URL) to obtain resource files 31 corresponding to the displayable objects (step 1005). It is noted that in the present invention, the interactive relationships are also defined by properties of objects, especially the non-displayable objects as the event objects, timer objects and etc. Thus, the RDF 32 contains necessary information to define the properties and interactive relationships of all web objects within a web case 30, thus when the RDF 32 is acquired by the playing engine 20, the playing engine 20 will have enough information to play the whole web case 30 corresponding to the RDF 32.

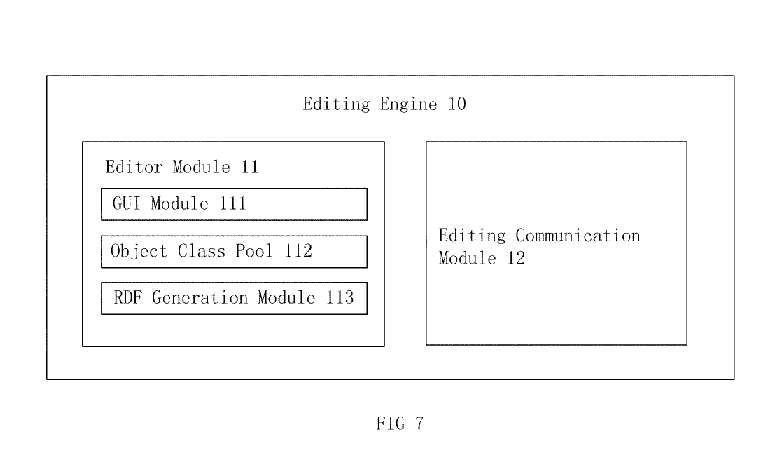

FIG. 7 shows an embodiment of the structure of the editing engine 10 in order to perform the above editing process. Firstly, the editing engine 10 comprises an editor module 11, which further comprises a GUI module 111, an object class pool 112, as well as a RDF generation module 113. The GUI module is responsible for creating the editing GUI 40, which comprises different functional areas for users to edit a web case 30, as well as detecting user operations through the editing GUI 40. The object class pool 112 is a module that contains information of all object classes corresponding to the types of web objects the editing engine 10 supports. The RDF generation module 113 is activated when the editing engine 10 detects a user input to end an editing session, it then obtains the information of all web objects already created as well as the properties of the web objects and record the above information into a RDF file. More specifically, the GUI module 111 detects a user input to end an editing session, it then obtains the information of all web objects already created as well as the properties of the web objects and record the above information into a RDF file. It is possible that the editor module further comprises other functional modules that are not shown in FIG. 7.

The editing engine 10 is also possible to further comprise an editing communication module 12, which is capable of completing communication in between web objects to realize the interactive relationships of the web objects during in the editing mode of a web case 30, to give users a better preview of the web case 30. The editing communication module 12 is not a necessary component of the editing engine 10.

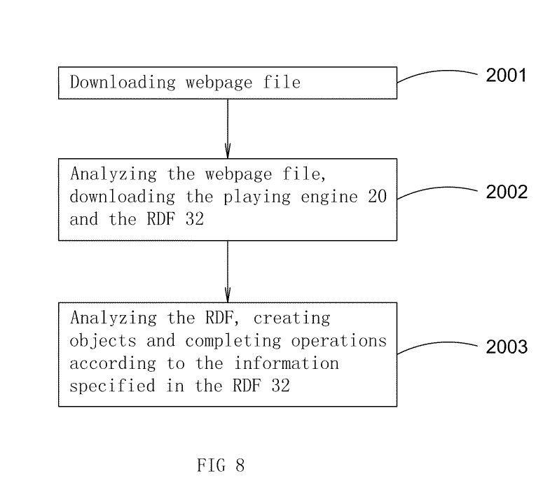

FIG. 8 shows one embodiment of the working process of the playing engine 20 when playing a web case 30. First, when a web browser 34 visits a certain address/URL on a computer network, it downloads a webpage file with a sharing code 35 embedded (step 2001). A web browser 34 is only a representation of software applications that a playing engine 20 operates on. In general, a playing engine 20 can operate on many kinds of software applications that are commonly installed, for example, an online media player, as long as the interface of the playing engine 20 and the software application the playing engine operates on is preconfigured to make sure a smooth functioning of the playing engine. The webpage file is usually stored in a third-party web server as specified earlier.

The web browser 34 then analyzes the webpage file, and downloads the playing engine 20 and the RDF 32 as instructed in the sharing code 35 embedded in the webpage file (the playing engine 20 and the RDF 32 are usually stored in the cache memory of the web browser 34 after downloaded) (step 2002). The playing engine 20 and the RDF 32 are usually stored in the cache memory of the web browser 34 after downloaded. As illustrated earlier, the sharing code 35 is usually a line of script executable by the browser, which specifies the instruction as well as the address to download the playing engine 20 and the resource description file 32 (RDF 32). The playing engine 20 is a set of instructions that is executable directly by the web browser 34, or a plug-in or add-on application of the web browser 34, in either case, the playing engine 20 is automatically installed on the web browser 34 after downloaded.

After the playing engine 20 is installed, it analyzes the RDF 32 already downloaded, and creates web objects according to the information recorded in the RDF 32 (step 2003). The displayable objects usually have resource files 31, for example, an image file, a video file and etc., and these resource files 31 of the displayable objects are usually obtained by the playing engine 20 after the RDF 32 is analyzed. For example, a URL of a resource file is specified in the RDF 32, and the playing engine 20 downloads the resource file from the URL after the RDF 32 is analyzed. The non-displayable objects are usually functional objects that involve in the controlling of the playing process of a web case 30. There are many ways the playing engine 20 can create a non-displayable object, in one embodiment, all the non-displayable object supported by a playing engine 20 is defined in the playing engine 20 itself, for example in the module of object class pool of the playing engine 20, similar to that of an editing engine 10, while the methods/functions and attributes of all non-displayable objects are defined. In another embodiment, the class information regarding the non-displayable objects is also downloaded from a remote server, for example, the editing server. In both of the embodiments, the class information of all non-displayable objects involved in the web case 30 that is to be played is obtained by the playing engine 20, while the property parameter values of the non-displayable objects are specified in the RDF 32. Thus the playing engine 20 is able to create the non-displayable objects according to the class information as well as the property parameter values of the non-displayable objects.

When both the displayable and non-displayable objects are created, the playing engine 20 then plays the web case 30 according to the properties of all web objects created. Usually, the displayable objects are responsible for providing media elements or media resources for a web case 30, while the non-displayable objects are responsible for controlling the playing process of displayable objects, and the information of the manner of controlling is carried by the properties of the non-displayable objects.

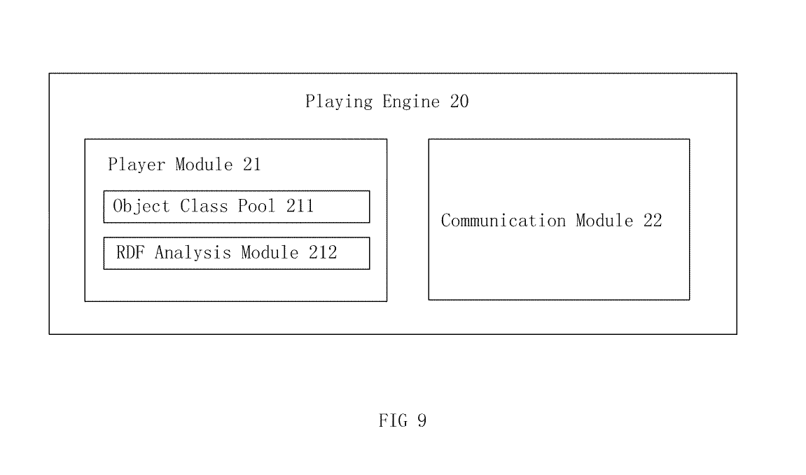

FIG. 9 shows one embodiment of the structure of the playing engine 20. Similar to the editing engine 10, the playing engine 20 also comprises two main modules, the player module 21, and the communication module 22. The player module further comprises a module of object class pool 211 and a RDF analysis module 212.

The player module is responsible for creating, initiating, and playing all web objects. The object class pool stores the information of all classes of the web objects that need to be played. In one embodiment, the object class pool stores all classes of web objects that are supported by the editing engine 10, thus all classes of web objects that are possible to be loaded by the playing engine 20; In another embodiment, the object class pool of the playing engine 20 only includes the classes of web objects that are going to be played by the playing engine 20, while the specific classes that need to be included are indicated in the sharing code 35. The RDF 32 analysis module reads the RDF 32 and translates the information in the RDF 32 into instructions for playing the web objects.

The communication module is responsible for communications in between different web objects during the playing process of a web case 30, which are needed when the interactive relationships between web objects need to be implemented. As illustrated earlier, the interactive relationships in between web objects allow the controlling of one web object by another web object, thus communications are needed for sending messages or instructions in between web objects.

It is worth mentioning that the playing engine 20 is structurally similar to the editing engine 10, except that the playing engine 20 does not have the GUI module 111 and has a RDF analysis module 212 instead of a RDF generation module 113. With these “symmetric” structures, the editing engine 10 and the playing engine 20 act as the “coder” and “decoder” of web cases.

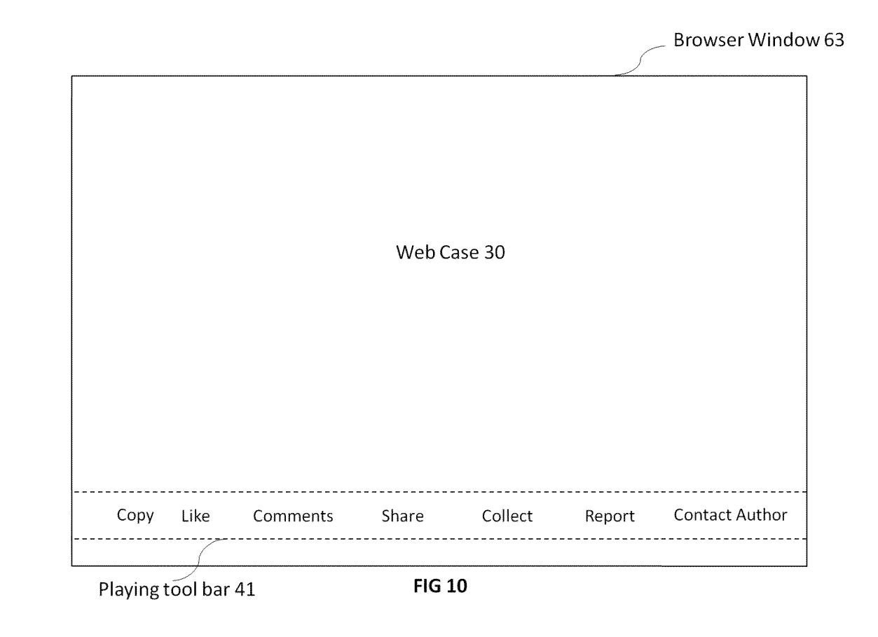

During the playing process of a web case 30, or in the “playing mode” of a web case 30, an additional playing tool bar 41 might be added onto the web case 30. As shown in FIG. 10, the playing tool bar 41 comprises a set of tools, shown as buttons, texts, links or other types of GUI items, which are displayed in the same time the web case 30 is being played. With the playing tool bar 41, viewers or users of the web case 30 are able to operate on the web case 30 being played in various ways, for example, add comments to the playing web case 30 and look at previous comments added by other users. Other possible functions provided though the buttons on the playing tool bar 41 is listed as follows:

| Tool | Function |
|---|---|
| Copy | Copy the web case 30 for further editing. |
| Like | Like the web case 30 and ask the platform hosting the |
| | web case 30 to show more web cases of the same kind |
| Comments | Add comments to the web case 30 and look at previous |
| | comments added by other viewers |
| Share | Share the web case 30 on other playing platforms |
| Collect | Save the web case 30 or the URL of the web case 30 |
| | into an on-line web case 30 gallery, or to the local |
| | computer |
| Report | Report playing problems or improper content of the |
| | web case 30 |
| Contact Author | Leave a message to the author of the web case 30 |

The playing tool bar 41 can be shown as an opaque bar or a semi-transparent bar. It is also possible that the playing tool bar 41 is hidden by default, and only shows when it is called by certain user operations, for example, when the cursor moves onto the area of a web case 30 that is supposed to show the playing tool bar 41, or when a button (not shown) on the web case 30 is clicked.

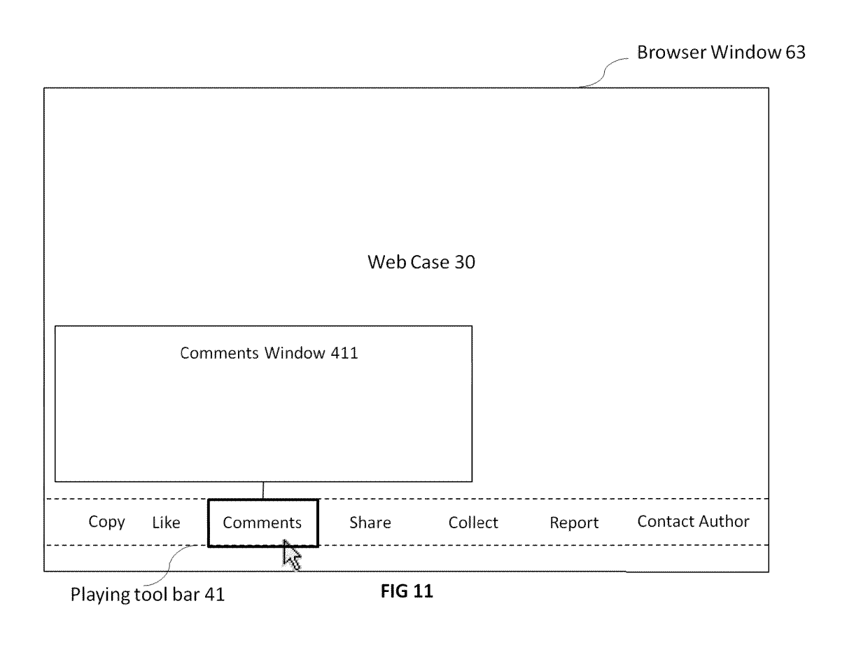

After a tool button in the playing tool bar 41 is selected, either the function corresponding to the selected tool bar is performed, or an additional function window is shown for further operations. For example, when the “copy” tool is selected, the web case 30 being played is immediately copied to a preset address, and when the “comments” tool is selected, as shown in FIG. 11, a function window 411 corresponding to the “comments” tool is shown for users to input comments and view previously added comments of the same web case 30. The function windows usually vary according to different tools the function windows corresponded to, while they can be shown in various ways, for example, as an independent window in addition to the tool bar, or as an extension of the tool bar area, but since the web case 30 being played usually takes up all areas within the browser window 63, the showing of the function window inevitably blocks part of the web case 30 that is being played.

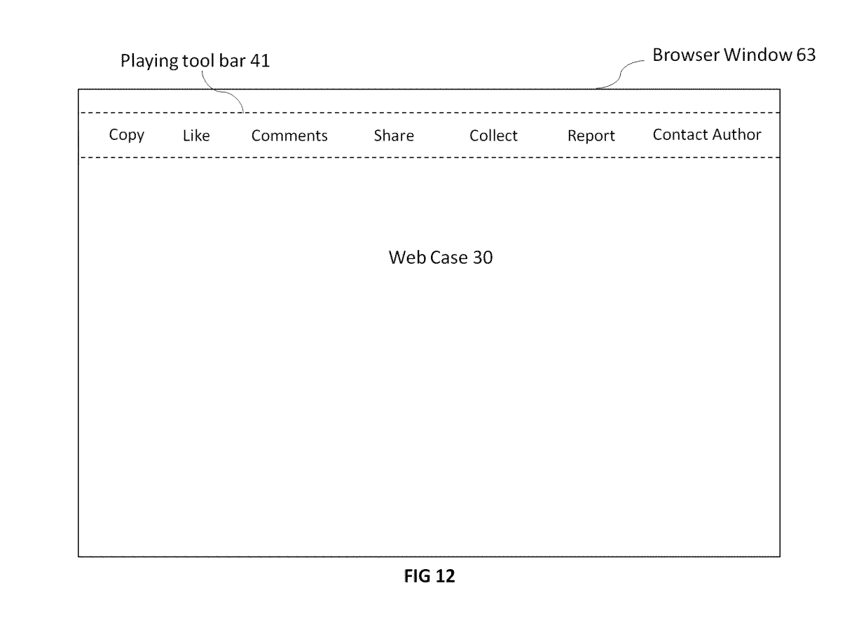

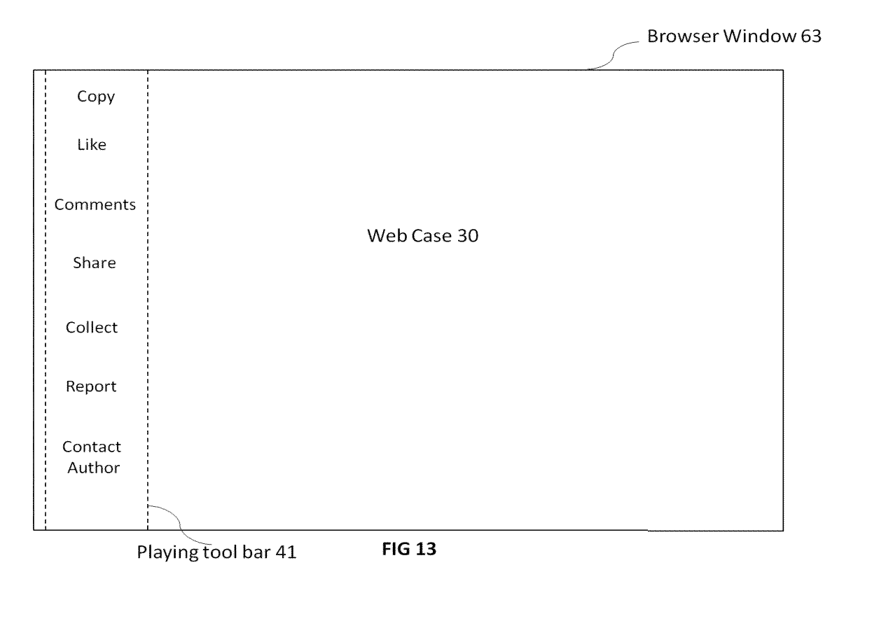

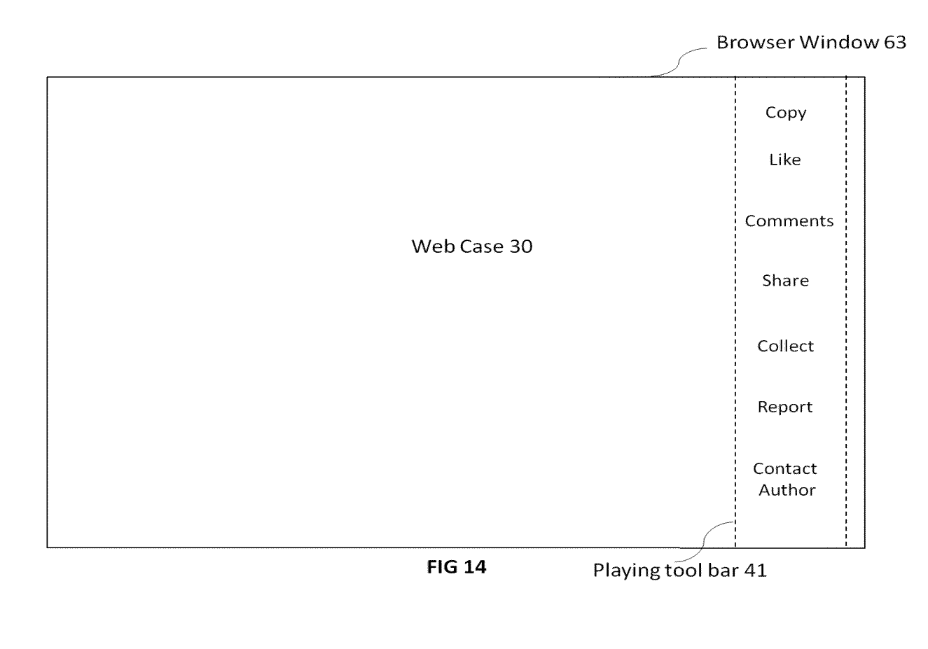

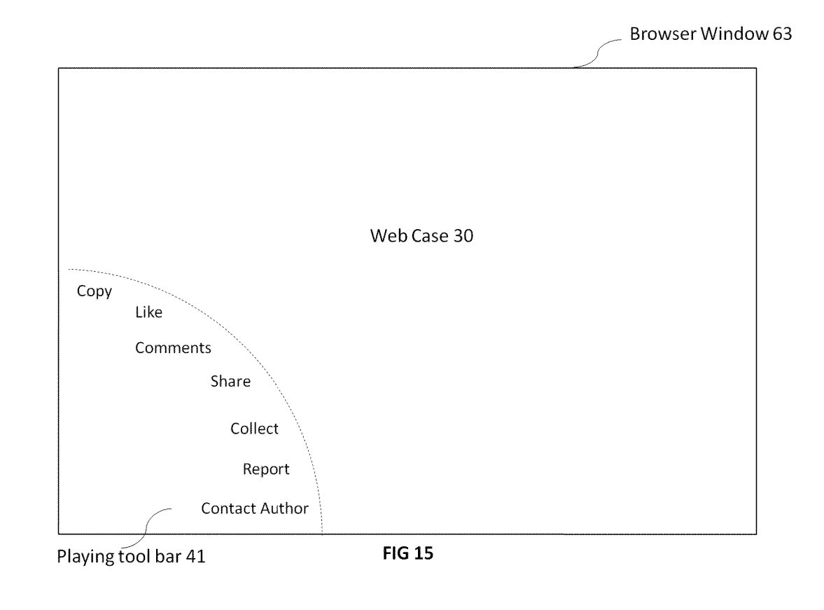

The playing tool bar 41 can be shown in a web case 30 in many forms, for example, as bars displayed close to the upper edge (as shown in FIG. 12), the left edge (as shown in FIG. 13), the right edge (as shown in FIG. 14) of browser window 63, or in other forms such as lining up in a curve close to the corners of the browser window 63 (the example of the bottom left corner is shown is FIG. 15).

The benefit of a showing a playing tool bar 41 during the playing process of a web case 30 is that it enables the viewer or user of the web case 30 to instantly interact with the web case 30 without interrupting the playing process of the web case 30, i.e. quitting the playing of the web case 30 and jumping to another webpage in order to leave a comment.

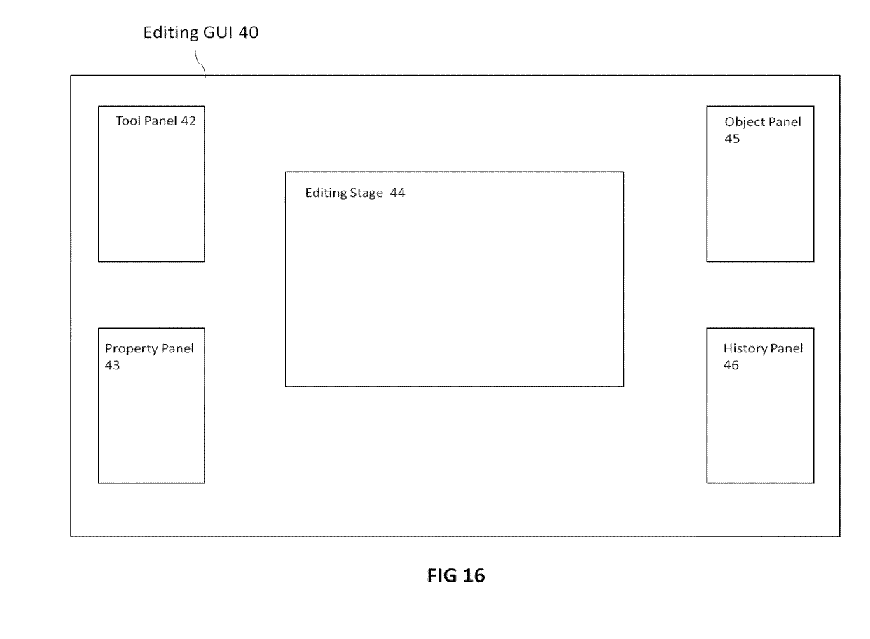

Referring to FIG. 16, an editing GUI 40 is created through the GUI module 211 according to a preferred embodiment of the present invention is illustrated. The GUI module 212 creates an editing GUI 40 for users to create a plurality web objects as well as edit the properties and the interactive relationships of the created objects. Users interact with the editing GUI 40 through “user inputs” to instruct the editing engine 10 to perform certain function. Depending on the client device the editing engine 10 is installed, user inputs can be given through mouse operations, keyboard operations, touch operations, remote controls, and etc.

The editing GUI 40 further comprises an editing window 41, an editing stage 44, a tool panel 42, a property panel 43, and an object panel 45. The editing window 41 usually defines the display boundary of the editing GUI 40, and when the editing engine 10 is loaded on the basis of a web browser 34 (not shown) as illustrated earlier, the editing window 41 usually covers all content display area within the web browser 34; The editing stage 44 is a default editing area, it provides references for the positioning of web objects during the editing process. It can be set with the playing engine 20 that during the playing process of a web case 30, all the web objects contained will be displayed according to their relative positions with the editing stage 44, while the position of the editing stage 44 can be configured during the editing process of the web case 30. The editing stage 44 is not a necessary component of the editing GUI 40 of the present invention. The tool panel 42, the property panel 43, and the object panel 45 are functional areas that perform certain functions during the editing process. Although they are called “panels”, the three functional areas are not necessarily shown in “panels” or other rectangular shapes, rather, they can be have various forms of display, for example, all elements within a tool panel 42 can be listed in a circle. The “panels” are only a representation of the various forms the three functional areas can be shown.

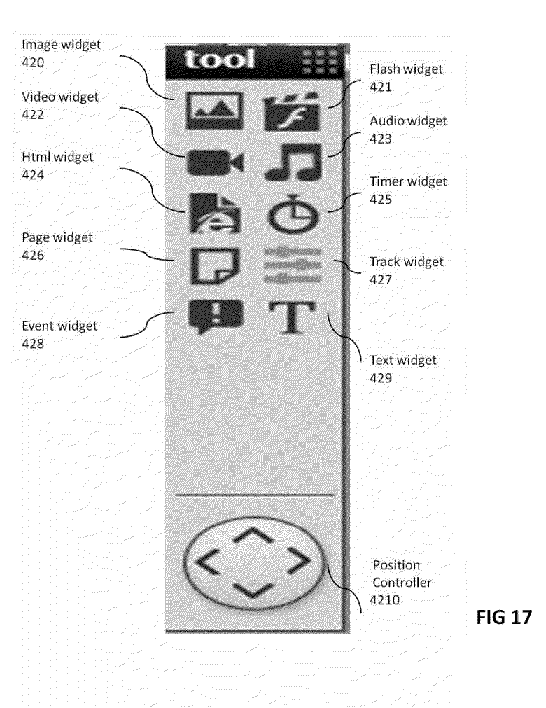

The tool panel 42 shown in FIG. 16 provides a plurality of widgets to create a plurality of objects and edit the properties and the interactive relationships of the created objects. Referring then to FIG. 17, in one embodiment of the present invention, the tool panel 42 comprises an image widget 420, a flash widget 421, a video widget 422, an audio widget 423, an html widget 424, a timer widget 425, a page widget 426, a track 472 widget 427, an event widget 428 and a text widget 429. Each of the widgets in the tool panel 42 is capable of creating a corresponding web object when triggered by user inputs; for example, the image widget 420 creates an image object when a user clicks on the image widget through a mouse.

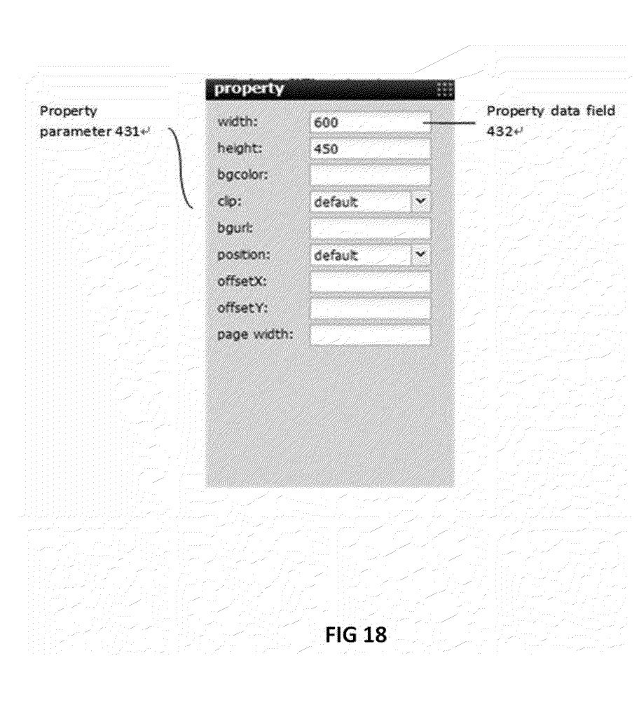

The property panel 43 comprises a list of property parameters 431 and a plurality of property data fields 432. Referring then to FIG. 18, each property parameter 431 describes one aspect of the property of a web object, while the property data fields 432 are data fields that are to be filled with the property parameter values corresponding to the property parameters 431. When a web object is created, the property parameters 431 are retrieved from the object class pool 212, or more specifically, from the attributes of the object class the web object belongs. The property parameters 431 are then displayed in a list on the property panel 43, and each property parameter 431 corresponds to one property data field 432. The values to be filled in the property data fields 432 are the “property parameter values” or “parameter values”, which are then obtained by the editing engine 10, either through user inputs or through retrieving predetermined default values. The editing engine 10 then fills the property parameter values into the property data fields 432, while users can change the values anytime during the editing process through the property panel 43. It is noteworthy that each kind of web objects has its own property parameters 431 according to the corresponding object class. What shown in FIG. 18 is the property window corresponding to the editing stage 44, and the meaning of the each of the property parameters 431 is shown as follows according to a preferred embodiment of the present invention:

| | |
|---|---|
| Width | Width of the editing stage 44 |
| Height | Height of the editing stage 44 |
| bgcolor | Background color of the editing stage 44 |
| Clip | Whether to clip/trim the part of the web objects displayed beyond |
| | the range of the editing stage 44, the value “true” stands for |
| | clipping/trimming and “false” stands for otherwise. Default value |
| | can be set as “false”. |
| bgurl | The URL of the background webpage that is going to be shown |
| | together with the web case 30 |
| position | The position of the editing stage 44 during the playing mode of a |
| | web case 30, the position can be chosen from a list of “upper |
| | right”, “upper middle”, “upper left”, “center right”, “center |
| | middle”, “center left”, “bottom right”, “bottom middle” and |
| | “bottom left”, which are 9 preset positions on the browser |
| | window 63 when a web case 30 is being played. |
| offsetX | Horizontal distance of the editing stage 44 in relate to the |
| | chosen preset position. |
| offsetY | Vertical distance of the editing stage 44 in relate to the |
| | chosen preset position |
| Page | The width of the background webpage when displayed |
| width | together with the web case 30. |

As shown in FIG. 16, the object panel 45 is a functional area for users to manage the web objects created. The object panel 45 displays a set of GUI items that represent all the web objects already created within the editing engine 10, while each GUI item corresponds to one web object. Under certain conditions, users can operate on the GUI items in the object panel 45 to operate on the web objects the GUI items corresponded to, for example, deleting a GUI item in the object panel 45 will result in the delete of the web object the GUI item corresponded to. The GUI items will be defined as “object representation items” here after, and the object representation items provide an overview of the web objects created, as well as shortcuts to manage the web objects. In one embodiment that will be specified later, the object representation items are organized in a tree structure, which constitute an “object tree”.

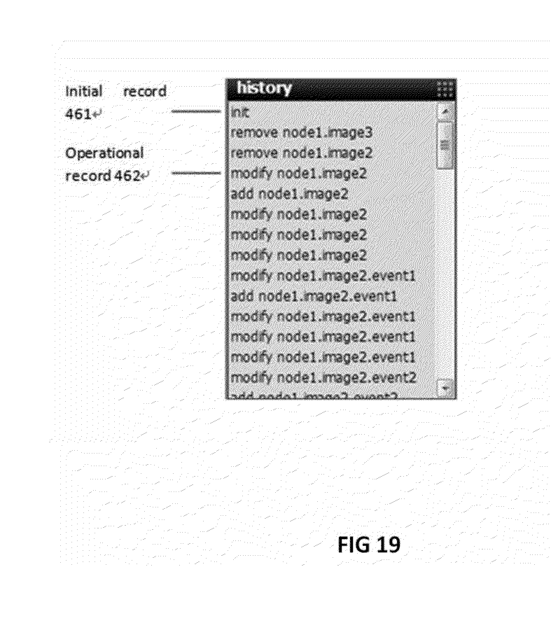

As shown in FIG. 16, it is also possible that in one embodiment, the editing GUI 40 provides a history panel 46 for recording each step of the operation of editing process, which is capable of displaying an initial record 461 and a plurality of operational records 462. As shown in FIG. 19, after the editing stage 44 is created, an initial record 461 is created in the history panel 46. After a step of the operation of the editing process is implemented, an operational record 462 is created in the history panel 46. The operational records 462 are capable of being used to recovering previous operations.

The image widget 420 is capable of editing image files, which can be uploaded to the editing engine 10 for further editing. The image files uploaded become a type of media elements of the present invention, and are regarded as image objects. The formats of the image files supported in the editing engine 10 include JPG, JPEG, JPE, PSD, PDD, BMP, GIF, EPS, FXG, IFF, TDI, PCX, PDF, PDP, RAW, PICT, PCT, PXR, PNG, SCT, TGA, VDA, ICB, VST, TIFF, TIF, PBM, PGM, PPM, PNM, PFM, PAM and PSB etc. After an image object is created or selected, the property parameters 431 of the created image object are retrieved from the object class pool 212 and displayed in the property panel 43. Each property parameter value is then collected and filled into each corresponding property data filed 432.

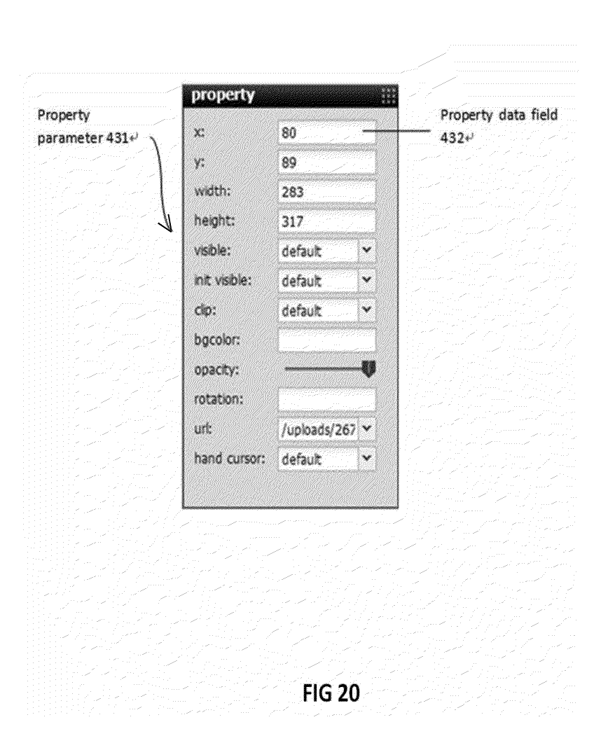

An example of image object property panel 43 is shown in FIG. 20. In this example, the image object property parameters 431 comprise X, Y, width, height, visible, init visible, clip, bgcolor, opacity, rotation, url, and Hand cursor. The meaning of each image property parameter 431 is shown in the following sheet:

| | |
|---|---|
| X: | Horizontal coordinate of an image object. The value “0” |
| | usually corresponds to the position of the left edge of the |
| | editing stage 44. The horizontal coordinate can be adjusted |
| | by various user operations, for example, by dragging the |
| | image object through a mouse. |
| Y: | Vertical coordinate of an image object. The value “0” usually |
| | corresponds to the position of the upper edge of the editing |
| | stage 44. The vertical coordinate can be adjusted by various |
| | user operations, for example, by dragging the image object |
| | through a mouse. |
| Width | Width of the image object that can be adjusted by dragging |
| | operations on the outer frame of the image object. |
| Height | Height of the image object that can be adjusted by dragging |
| | operations on the outer frame of the image object. |
| Visible | Image display status. The value “true” stands for visible |
| | and “false” stands for invisible. Default value can be set as “true”. |
| Init | Initial image display status under the control of timer objects. |
| visible | The value “true” stands for visible and “false” stands |
| | for invisible. Default value can be set as “true”. |
| Clip | Set the property of clipping of the image object on the |
| | editing stage 44. The value “true” stands for clipping/ |
| | trimming the part of the image object beyond the editing |
| | stage 44 and “false” stands for not clipping. Default value |
| | can be set as “false”. |
| Bgcolor | Set the background color of the image object |
| Opacity | Set the level of opacity of the image object. |
| Rotation | Set the rotation angle of an image object with values in |
| | between 1-360, to have the image object to rotate to the |
| | corresponding angle (in clockwise or counterclockwise |
| | direction). |
| url | Address of the resource file of the image object |
| Hand | Whether the cursor changes into the “hand” shape when |
| Cursor | moved onto the image object. The value “true” stands for |
| | the cursor changing into the “hand” shape and “false” |
| | stands for otherwise. Default value can be set as “false”. |

The flash widget 421 is capable of editing adobe flash files (such as .swf files), which can be uploaded to the editing engine 10 for further editing. The flash files uploaded become a type of media elements of the present invention, and are regarded as flash objects. After a flash object is created or selected, the property parameters 431 of the created flash object are retrieved from the object class pool 212 and displayed in the property panel 43. Each property parameter value is then collected and filled into each corresponding property data filed 432.

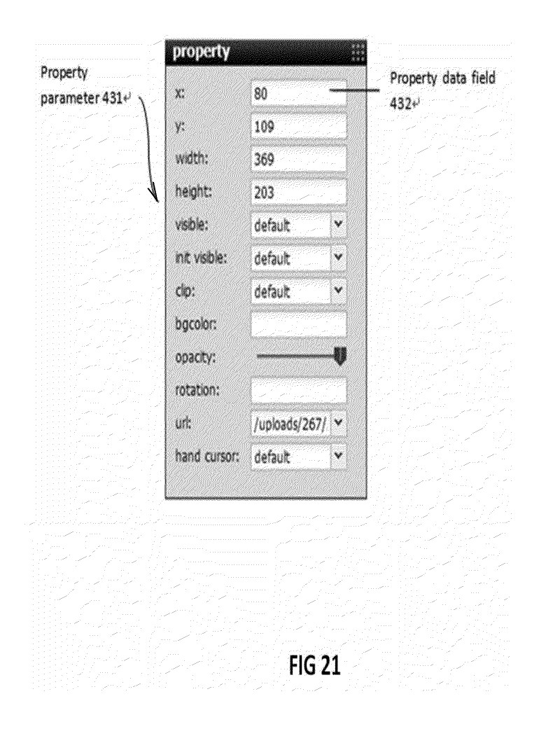

An example of flash object property panel 43 is shown in FIG. 21. In this example, the image object property parameters 431 comprise X, Y, width, height, visible, init visible, clip, bgcolor, opacity, rotation, url, and Hand cursor. The meaning of each flash property parameter 431 is shown in the following sheet:

| | |
|---|---|
| X: | Horizontal coordinate of a flash object. The value “0” usually |
| | corresponds to the position of the left edge of the editing |
| | stage 44. The horizontal coordinate can be adjusted by |
| | various user operations, for example, by dragging the flash |
| | object through a mouse. |
| Y: | Vertical coordinate of a flash object. The value “0” usually |
| | corresponds to the position of the upper edge of the editing |
| | stage 44. The vertical coordinate can be adjusted by |
| | various user operations, for example, by dragging the flash |
| | object through a mouse. |
| Width | Width of the flash object that can be adjusted by dragging |
| | operations on the outer frame of the flash object. |
| Height | Height of the flash object that can be adjusted by dragging |
| | operations on the outer frame of the flash object. |
| Visible | Flash object display status. The value “true” stands for |
| | visible and “false” stands for invisible. Default value |
| | can be set as “true”. |
| Init | Initial flash object display status under the control of timer |
| visible | objects. The value “true” stands for visible and “false” |
| | stands for invisible. Default value can be set as “true”. |
| Clip | Set the property of clipping of the flash object on the editing |
| | stage 44. The value “true” stands for clipping/trimming the part |
| | of the flash object beyond the editing stage 44 and “false” |
| | stands for not clipping. Default value can be set as “false”. |
| Bgcolor | Set the background color of the flash object |
| Opacity | Set the level of opacity of the flash object. |
| Rotation | Set the rotation angle of a flash object with values in between |
| | 1-360, to have the flash object to rotate to the corresponding |
| | angle in clockwise or counterclockwise direction. |
| url | Address of the resource file of the flash object |
| Hand | Whether the cursor changes into the “hand” shape when |
| Cursor | moved onto the flash object. The value “true” stands for the |
| | cursor changing into the “hand” shape and “false” stands |
| | for otherwise. Default value can be set as “false”. |

It is noted that the present invention also supports other animation objects, as other formats of motion pictures, and the creation and property of the other animation objects are the same as the flash objects.

The video widget 422 is capable of editing video files, which can be uploaded to the editing engine 10 for further editing. The video files uploaded become a type of media elements of the present invention, and are regarded as video objects.

The formats of the video files supported in the editing engine 10 include fly, f4v, mp4, avi, mpeg, DivX, MOV, ASF, WMV, RM, RMVB and etc. After a video object is created or selected, the property parameters 431 of the created video object are retrieved from the object class pool 212 and displayed in the property panel 43. Each property parameter value is then collected and filled into each corresponding property data filed 432.

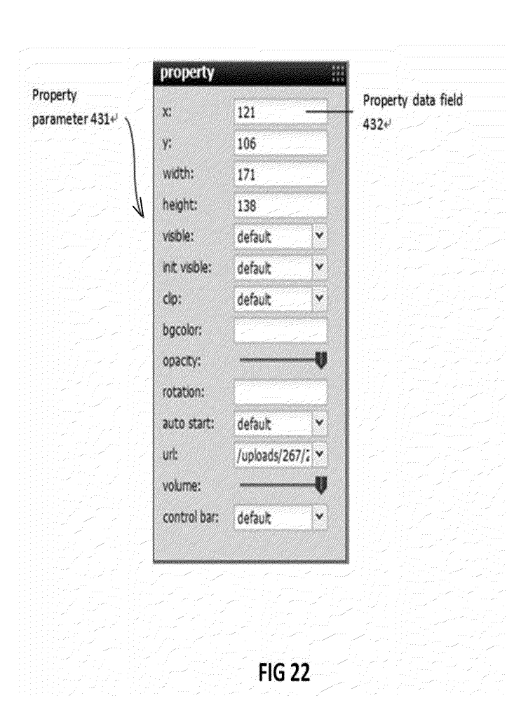

An example of video object property panel 43 is shown in FIG. 22. In this example, the video object property parameters 431 comprise X, Y, width, height, visible, init visible, clip, bgcolor, opacity, rotation, auto start, url, volume, and control bar. The meaning of each video property parameter 431 is shown in the following sheet:

| | |
|---|---|
| X: | Horizontal coordinate of a video object. The value “0” |
| | usually corresponds to the position of the left edge of the |
| | editing stage 44. The horizontal coordinate can be adjusted |
| | by various user operations, for example, by dragging the |
| | video object through a mouse. |
| Y: | Vertical coordinate of a video object. The value “0” |
| | usually corresponds to the position of the upper edge |
| | of the editing stage 44. The vertical coordinate can be |
| | adjusted by various user operations, for example, by |
| | dragging the video object through a mouse. |
| Width | Width of the video object that can be adjusted by |
| | dragging operations on the outer frame of the video object. |
| Height | Height of the video object that can be adjusted by |
| | dragging operations on the outer frame of the video object. |
| Visible | Video object display status. The value “true” stands for |
| | visible and “false” stands for invisible. Default value |
| | can be set as “true”. |
| Init | Initial video object display status under the timer objects. |
| visible | The value “true” stands for visible and “false” stands for |
| | invisible. Default value can be set as “true”. |
| Clip | Set the property of clipping of the video object on the |
| | editing stage 44. The value “true” stands for clipping/ |
| | trimming the part of the video object beyond the editing |
| | stage 44 and “false” stands for not clipping. Default |
| | value can be set as “false”. |
| Bgcolor | Set the background color of the video object |
| Opacity | Set the level of opacity of the video object. |
| Rotation | Set the rotation angle of a video object with values in |
| | between 1-360, to have the video object to rotate to the |
| | corresponding angle in clockwise or counterclockwise |
| | direction. |
| Auto start | Set the video playing status. The value “true” stands for |
| | automatically start playing the video when a web case |
| | 30 is being played, and “false” stands for otherwise. |
| | Default value can be set as “false”. |
| url | Address of the resource file of the video object. |
| Volume | Volume level of the video object when being played. |
| Control bar | Whether there is a control bar when a video object is |
| | being played. The control bar is the bar that is usually |
| | displayed on the bottom side of a video to control the |
| | play/pause status, the volume and the playing progress |
| | of a video. The value “true” stands for there is a |
| | control bar of the video object when it is being played, |
| | and “false” stands for otherwise. Default value can be |
| | set as “false”. |

The audio widget 423 is capable of editing audio files, which can be uploaded to the editing engine 10 for further editing. The audio files uploaded become a type of media elements of the present invention, and are regarded as audio objects. The formats of the audio files supported in the editing engine 10 include MP3, ogg, MIDI, WMA, RealAudio, way, VQF, APE and etc. After an audio object is created or selected, the property parameters 431 of the created audio object are retrieved from the object class pool 212 and displayed in the property panel 43. Each property parameter value is then collected and filled into each corresponding property data filed 432.

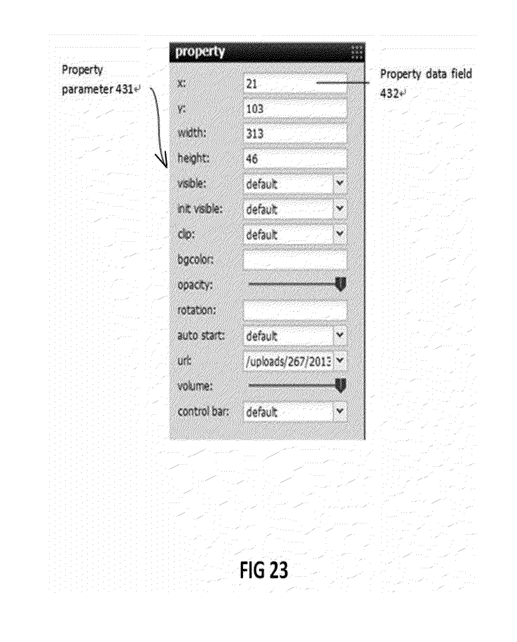

An example of audio object property panel 43 is shown in FIG. 23. In this example, the audio object property parameters 431 comprise X, Y, width, height, visible, init visible, clip, bgcolor, opacity, rotation, auto start, url, volume, and control bar. The meaning of each audio property parameter 431 is shown in the following sheet:

| | |
|---|---|
| X: | Horizontal coordinate of an audio object. The value “0” |
| | usually corresponds to the position of the left edge of the |
| | editing stage 44. The horizontal coordinate can be adjusted |
| | by various user operations, for example, by dragging the |
| | audio object through a mouse. |
| Y: | Vertical coordinate of an audio object. The value “0” |
| | usually corresponds to the position of the upper edge of |
| | the editing stage 44. The vertical coordinate can be |
| | adjusted by various user operations, for example, by |
| | dragging the audio object through a mouse. |
| Width | Width of the audio object that can be adjusted by |
| | dragging operations on the outer frame of the audio object. |
| Height | Height of the audio object that can be adjusted by |
| | dragging operations on the outer frame of the audio object. |
| Visible | Audio object display status. The value “true” stands for |
| | visible and “false” stands for invisible. Default value |
| | can be set as “true”. |
| Init | Initial audio object display status under the timer objects. |
| visible | The value “true” stands for visible and “false” stands for |
| | invisible. Default value can be set as “true”. |
| Clip | Set the property of clipping of the audio object on the |
| | editing stage 44. The value “true” stands for clipping/ |
| | trimming the part of the audio object beyond the editing |
| | stage 44 and “false” stands for not clipping. Default |
| | value can be set as “false”. |
| Bgcolor | Set the background color of the audio object |
| Opacity | Set the level of opacity of the audio object. |
| Rotation | Set the rotation angle of an audio object with values in |
| | between 1-360, to have the audio object to rotate to the |
| | corresponding angle in clockwise or counterclockwise |
| | direction. |
| Auto start | Set the audio playing status. The value “true” stands for |
| | automatically start playing the audio when a web case |
| | 30 is being played, and “false” stands for otherwise. |
| | Default value can be set as “false”. |
| url | Address of the resource file of the audio object. |
| Volume | Volume level of the audio object when being played. |
| Control | Whether there is a control bar when an audio object is |
| bar | being played. The control bar is the bar that is |
| | usually displayed on the bottom side of an audio to |
| | control the play/pause status, the volume and the |
| | playing progress of an audio. The value “true” |
| | stands for there is a control bar of the audio object |
| | when it is being played, and “false” stands for |
| | otherwise. Default value can be set as “false”. |

The html widget 424 is capable of editing html files, which can be uploaded to the editing engine 10 for further editing. The html files uploaded become a type of media elements of the present invention, and are regarded as html objects. After an html object is created or selected, the property parameters 431 of the created html object are retrieved from the object class pool 212 and displayed in the property panel 43. Each property parameter value is then collected and filled into each corresponding property data filed 432.

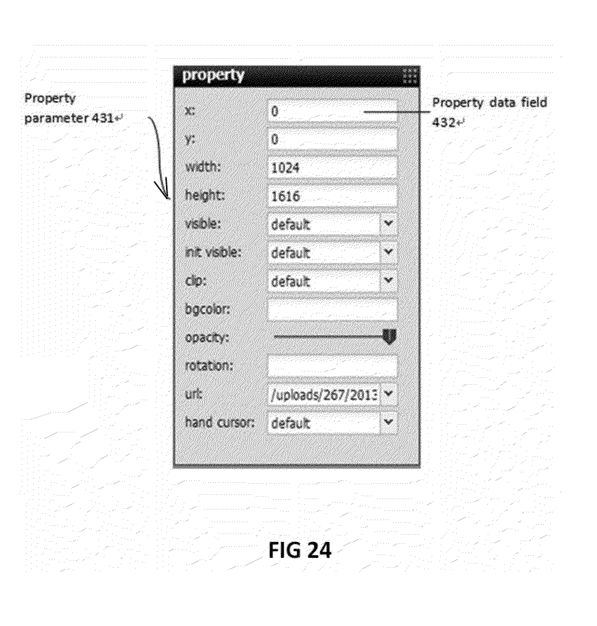

An example of html object property panel 43 is shown in FIG. 24. In this example, the html object property parameters 431 comprise X, Y, width, height, visible, init visible, clip, bgcolor, opacity, rotation, url, and Hand cursor. The meaning of each html property parameter 431 is shown in the following sheet:

| | |
|---|---|
| X: | Horizontal coordinate of an html object. The value “0” |
| | usually corresponds to the position of the left edge of the |
| | editing stage 44. The horizontal coordinate can be adjusted |
| | by various user operations, for example, by dragging the |
| | html object through a mouse. |
| Y: | Vertical coordinate of an html object. The value “0” usually |
| | corresponds to the position of the upper edge of the editing |
| | stage 44. The vertical coordinate can be adjusted by various |
| | user operations, for example, by dragging the html object |
| | through a mouse. |
| Width | Width of the html object that can be adjusted by dragging |
| | operations on the outer frame of the html object. |
| Height | Height of the html object that can be adjusted by dragging |
| | operations on the outer frame of the html object. |
| Visible | Html object display status. The value “true” stands for |
| | visible and “false” stands for invisible. Default value can |
| | be set as “true”. |
| Init | Initial html object display status under the control of timer |
| visible | objects. The value “true” stands for visible and “false” |
| | stands for invisible. Default value can be set as “true”. |
| Clip | Set the property of clipping of the html object on the editing |
| | stage 44. The value “true” stands for clipping/trimming the |
| | part of the html object beyond the editing stage 44 and |
| | “false” stands for not clipping. Default value can be set |
| | as “false”. |
| Bgcolor | Set the background color of the html object |
| Opacity | Set the level of opacity of the html object. |
| | RotationSet the rotation angle of an html object with values |
| | in between 1-360, to have the html object to rotate to the |
| | corresponding angle (in clockwise or counterclockwise |
| | direction). |
| url | Address of the resource file of the html object |
| Hand | Whether the cursor changes into the “hand” shape when |
| Cursor | moved onto the html object. The value “true” stands for |
| | the cursor changing into the “hand” shape and “false” |
| | stands for otherwise. Default value can be set as “false”. |

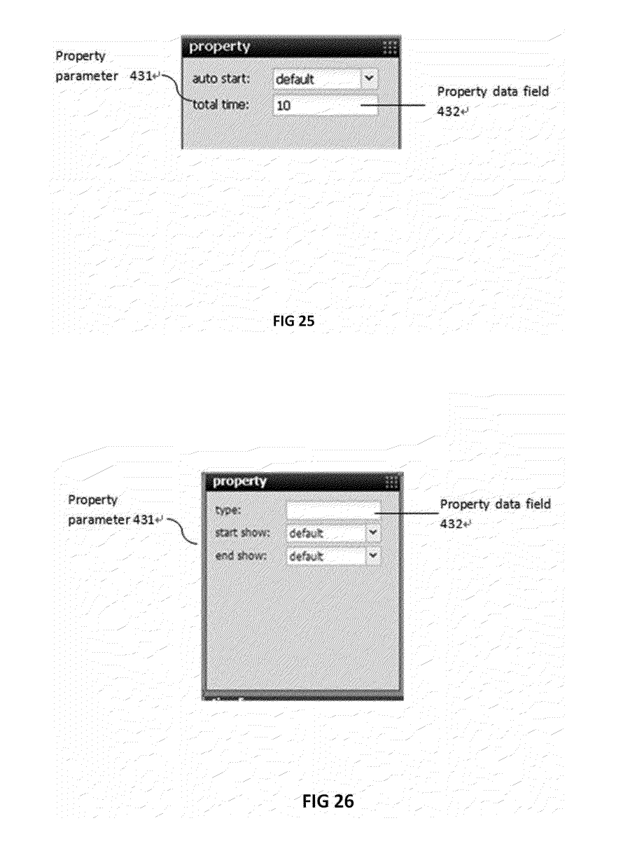

The timer widget 425 generates a timer object when the timer widget is triggered, such as triggered by mouse clicks on the widget. The timer object is one of the non-displayable objects, and is capable of controlling the movement of other web objects within the same web case 30, or triggering the web objects to change properties within a certain time interval. When a timer object is selected, the property parameters 431 of the timer objects are retrieved from the object class pool 212 displayed in the property panel 43. The user is capable of adjusting each property parameter value in the property data fields 432. One example of the timer object property panel 43 is shown in FIG. 25, and the meaning of each timer object property parameter 431 is shown in the following sheet:

| | |
|---|---|
| Auto start | Whether a timer object automatically starts |
| | playing when the parent object of the timer object |
| | starts playing during the playing process of the |
| | web case 30 containing the timer object. The value |
| | “true” stands for the timer object automatically |
| | starts, and “false” stands for otherwise. Default |
| | value can be set as “false”. |
| Total time | It sets the duration of time a timer object manages, |
| | preferably in the unit of second (s). |

The track widget 427 generates a track object, which usually works with a timer object. In general, each track object holds property markers of a web object that is controlled by a timer object. And in the example shown in FIG. 26, the property parameters 431 of the track object comprise “type”, “start show” and “end show”.

Much more details on the timer object and the track object will be given later in the section dedicated to timer objects.

The page widget 426 creates page objects, which are another kind of non-displayable objects that act as “containers” of web objects. During the playing process of a web case 30, when a page object start playing, only web objects contained in the page object are going to be played. Usually, no two page objects are played together, thus, the page objects provide the effect of switching scenes during the playing process of web case 30s. Also, in the editing process, the web objects can be shown according to the page objects they belong, and in one embodiment, the selecting of a different page object will result in the displaying of a different group of web objects, as well as a new editing stage 44.

Although the web objects within a web case 30 are displayed in groups according to page objects they belong to, both in the playing and editing process of the web case 30, there are still interactive relationships in between web objects that belong to different page objects. For example, a click on an image object in one page will result in the appearing of a video object in another page.

When a page object is selected, the property parameters 431 of the page object are retrieved from the object class pool and displayed in the property panel 43. Each parameter value is collected and filled in each property data fields 432. One example of the property parameters 431 of the page object is shown in FIG. 18, which is the same as the property panel 43 of the editing stage 44.

There are other web objects supported by the present invention similar to the page object: the layer object and the screen object (not shown). The screen object and the layer object also act as containers of other web objects.

The layer object operates in the same way as the page object, except that two layers can be displayed in the same time or overlapped, while one layer is displayed on top of another. A property parameter 432 of “display priority” needs to be specified with the layer object in order for the playing engine 20 to decide the order to stack different layers.

The screen object can be understood as the page object associated with an independent browser window 63. When there are multiple screen objects exist in a web case 30, the web case 30 is played over several different browser window 63s, within one client device, or with multiple client devices. For example, when a web case 30 with two screen objects is being played, different web objects are loaded in two web browser 34s in two client devices, and a web object in one web browser 34 is capable of controlling a web object in another web browser 34. Details of the screen objects will be given in a dedicated session later.

The text widget 429 is capable of editing text files, which can be uploaded to the editing engine 10 for further editing. The text files uploaded become a type of media elements of the present invention, and are regarded as text objects. Except for uploading text files, the text widget 429 also supports direct input of texts, and the texts inputted in one session (for example, in one text box) is regarded as a text object. After a text object is created or selected, the property parameters 431 of the created text object are retrieved from the object class pool 212 and displayed in the property panel 43. Each property parameter value is then collected and filled into each corresponding property data filed 432.

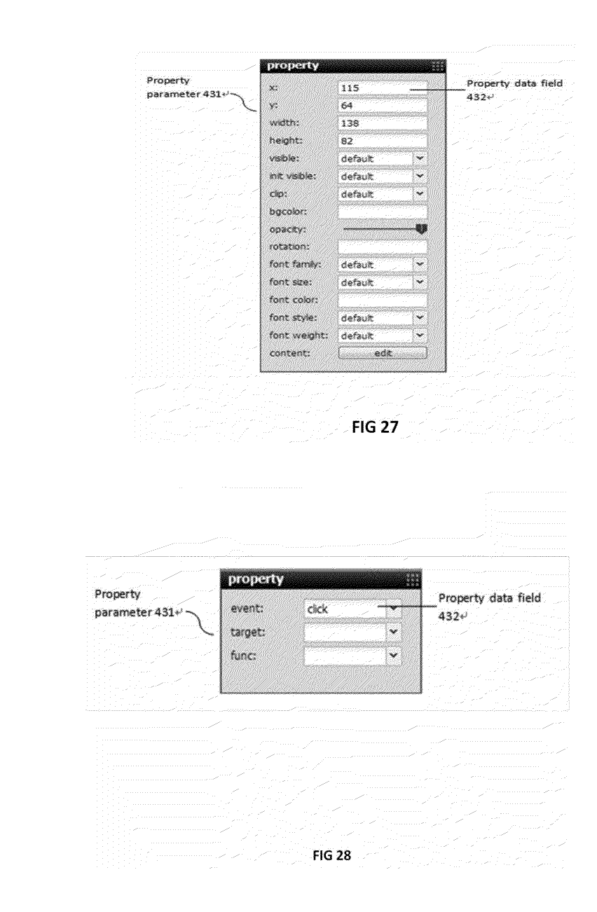

An example of text object property panel 43 is shown in FIG. 27. In this example, the text object property parameters 431 comprise X, Y, width, height, visible, init visible, clip, bgcolor, opacity, rotation, url, and Hand cursor. The meaning of each text property parameter 431 is shown in the following sheet:

| | |
|---|---|
| X: | Horizontal coordinate of a video object. The value “0” |
| | usually corresponds to the position of the left edge |
| | of the editing stage 44. The horizontal coordinate can |
| | be adjusted by various user operations, for example, |
| | by dragging the video object through a mouse. |
| Y: | Vertical coordinate of a video object. The value “0” |
| | usually corresponds to the position of the upper edge |
| | of the editing stage 44. The vertical coordinate can be |
| | adjusted by various user operations, for example, by |
| | dragging the video object through a mouse. |
| Width | Width of the video object that can be adjusted by |
| | dragging operations on the outer frame of the video object. |
| Height | Height of the video object that can be adjusted by |
| | dragging operations on the outer frame of the video object. |
| Visible | Video object display status. The value “true” stands for |
| | visible and “false” stands for invisible. Default value can |
| | be set as “true”. |
| Initvisible | Initial video object display status under the timer objects. |
| | The value “true” stands for visible and “false” stands for |
| | invisible. Default value can be set as “true”. |
| Clip | Set the property of clipping of the video object on the |
| | editing stage 44. The value “true” stands for clipping/ |
| | trimming the part of the video object beyond the editing |
| | stage 44 and “false” stands for not clipping. Default |
| | value can be set as “false”. |
| Bgcolor | Set the background color of the video object |
| Opacity | Set the level of opacity of the video object. |
| Rotation | Set the rotation angle of a video object with values in |
| | between 1-360, to have the video object to rotate to the |
| | corresponding angle in clockwise or counterclockwise |
| | direction. |
| Font | Choose font of text |
| family | |
| Font size | Set size of text |
| Font style | Set italic font and default status is not italic |
| Font | Set thickened text and default status is not thickened |
| weight | |
| content | Click edit to pop up the rich-text edit box |

The event widget 428 is a critical object for editing the interactive relationships in between web objects within a web case 30 of the present invention. The event widget 428 is capable of creating an event object. After an event object is created or selected, the property parameters 431 of the created event object are retrieved from the object class pool 212 and displayed in the property panel 43. Each parameter value is collected and filled in each property data fields 432. Through modifying the values of the property parameters 431, users are able to edit the interactive relationships between web objects. More details about the event objects will be given later in a dedicated session of this disclosure.

One example of the property parameters 431 of the event object 428 is show in FIG. 28. The meaning of each event property parameter 431 is shown in following sheet:

| | |
|---|---|
| event | The triggering condition of the event object during the |
| | playing process of a web case 30, for example, mouse |
| | click, mouse over (when the cursor is moved onto a certain |
| | object), mouse out (when the cursor is moved away from a |
| | certain object), show (when an object appears), hide (when |
| | an object disappears). There are additional start and stop |
| | event for video and audio objects, which are the event of |
| | the starting and stopping playing of the objects. |
| target | Set the target object of the triggering event, i.e. the object |
| | controlled by the event object, or the object that is going to |
| | react onto the triggering event |
| function | Set the corresponding functions of the target object, which |
| | are the actions the target object are to take when the event |
| | is triggered, including delete, Set properties, close, stop, |
| | next Page, prey Page, gotoPage (jump to the appointed |
| | page), openurl (set to open the appointed URL) and shake. |

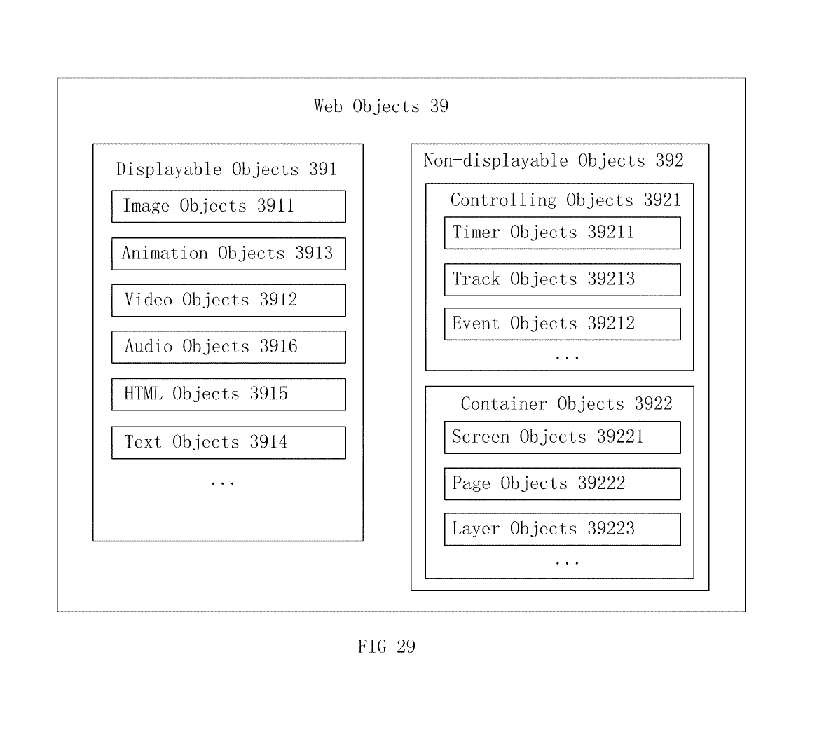

It's noticed that the event object is only effective when parameter values are given for all three of the property parameters 431, i.e. event, target, function. A brief summary of the web objects supported by the editing engine 10 and playing engine 20 of the present invention is given in FIG. 29. As explained earlier, there are mainly two types of web objects in a web case 30, the displayable objects, and the non-displayable objects. The displayable objects are media elements of a web case 30, and the non-displayable objects perform certain controlling functions, which further comprise the controlling objects , and the container objects.

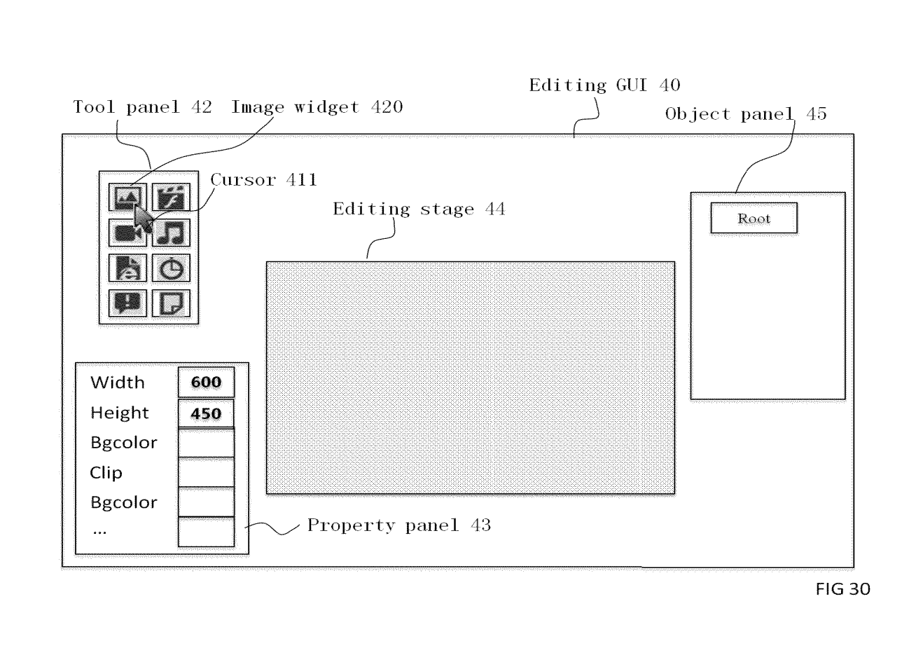

An embodiment of the process of creating a web object is shown in FIG. 30, wherein the editor GUI 40 is initialized through the GUI module 211. The tool panel 42 provides a plurality of widgets for user to create objects and the interaction of the objects, such as an image widget 420, a flash widget 421, a video widget 422, an audio widget 423, a html widget 424, a timer widget 425, a page widget 426, an event widget 428. When the editing GUI 40 is initialized, a root node is automatically created in the object panel 45 of the object tree 451. The root node represents the editing stage 44 and is regarded as the current node under operation. The property panel 43 thus displays the property parameters 431 and the parameter values of the editing stage 44 represented by the root node.

The GUI module 211 then detects whether there are operations on the tool panel 42 to create a web object, if yes, it further obtains the information about the type of web object to be created. In this embodiment, the image widget 420 within the tool panel 42 is selected by a mouse click, to create an image object.

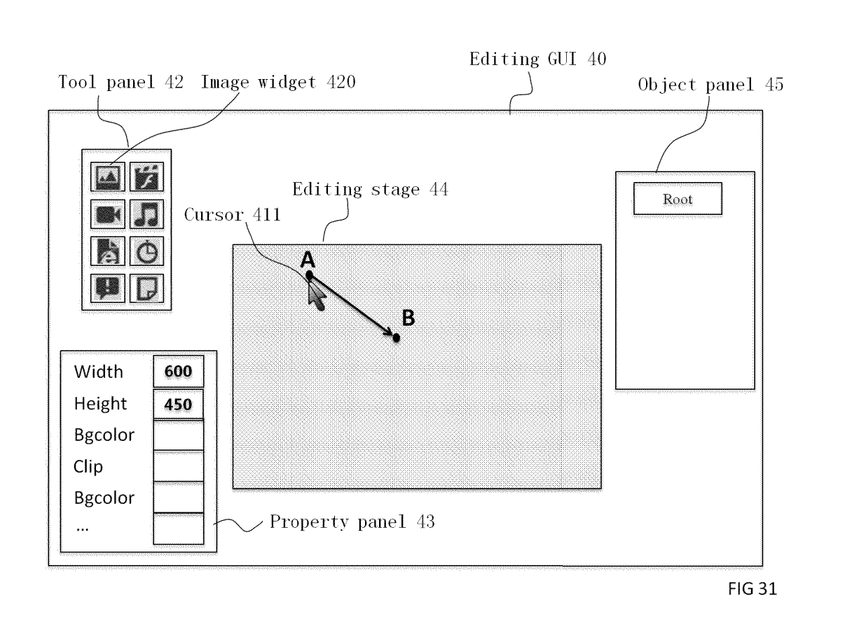

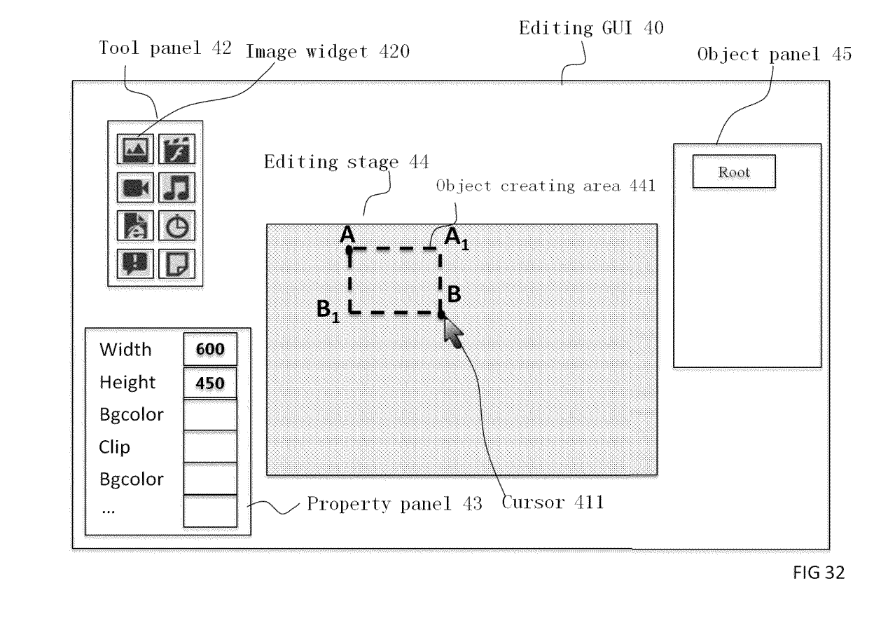

After the image widget 420 is selected, it is preferred that an object creating area 441 that predefines the size and position of the image object is further specified before the image object is created. Since most image objects are shown in rectangular shapes, the object creating area 441 is preferably defined through the coordinates of two diagonal vertices of the rectangle that defines the object creating area 441. The two diagonal vertices refer to the top left and the bottom right vertices, or the top right and bottom left vertices. In the present embodiment, as shown in FIG. 31, the top left vertex A and the bottom right vertex B is specified by the following user operations: clicking the mouse at the position of point A, dragging the cursor to the position of point B, and releasing the mouse button. The editing engine 10 then record the coordinates of the two vertices to determine the position of all four vertices of the image object to be created, as shown in FIG. 32. It is noteworthy that the step of specifying the object creating area 441 is only applicable to displayable web objects such as image objects or video objects, it does not exist for the creating process of non-displayable objects, as the non-displayable objects can not be displayed directly thus do not have positions or sizes to be specified. Also, for displayable web objects, although it is preferred to have the step of specifying the object creating area 441 before the web object is created, this step is not necessary in order to complete the creating process of displayable objects. It is possible that the information of the size and position of the displayable object is specified after the object is created, for example, through the property panel 43 of the created displayable object, and before the position and size information is specified, the newly created object will be displayed with a default position and default size preset with the editing engine 10. At last, there are also various ways for users to define the object creating area 441 within the editing GUI 40, for example, through other types of mouse operations, or through directly inputting the coordinates values of the vertices via the keyboard.

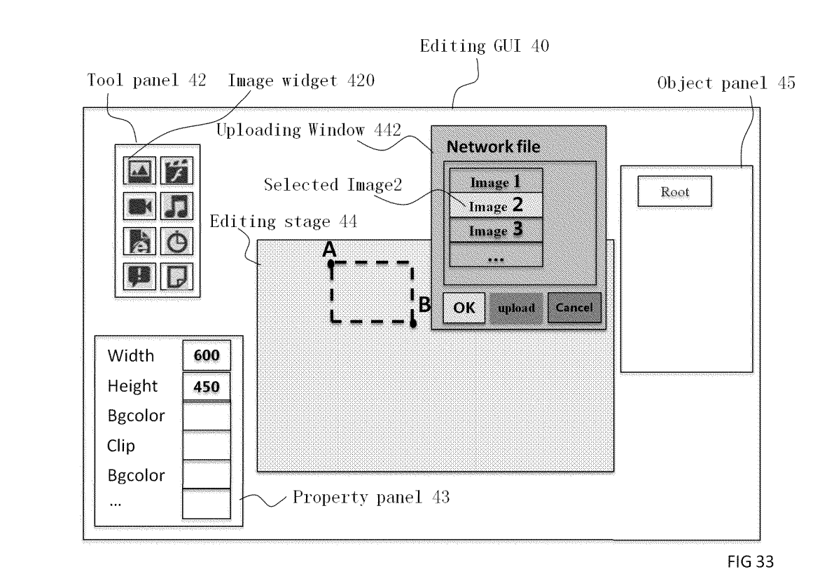

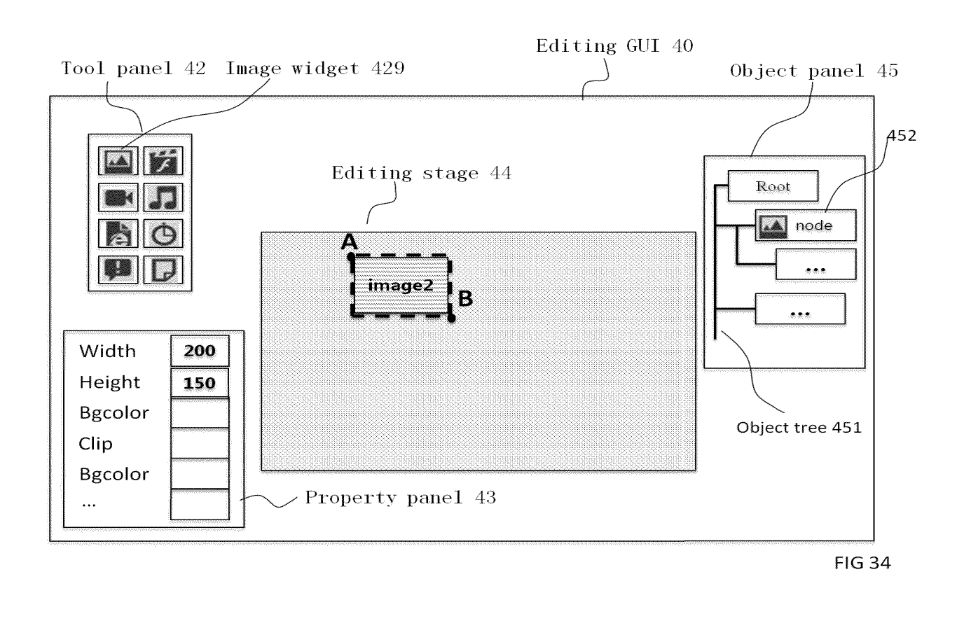

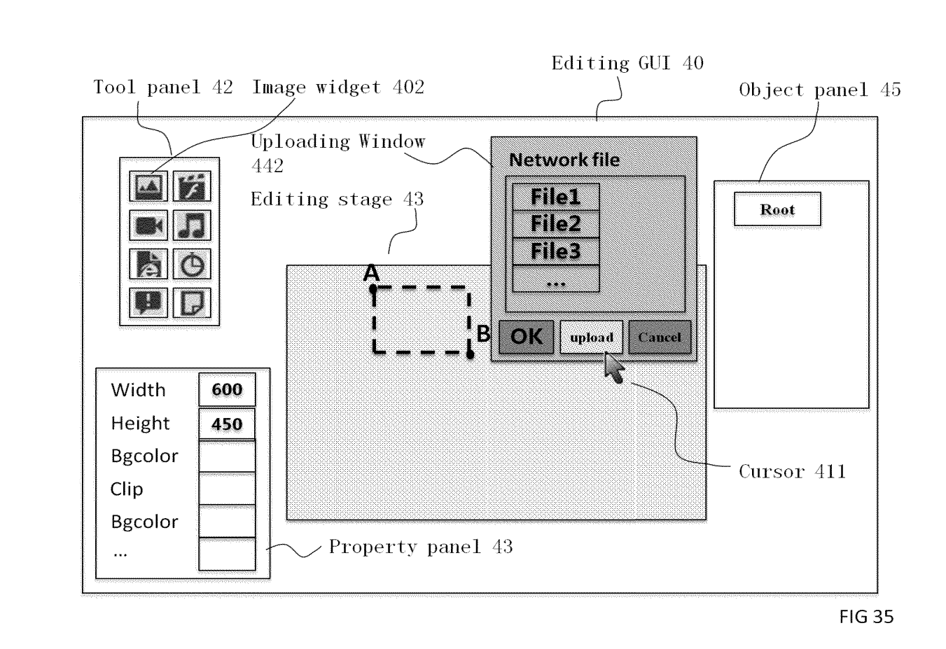

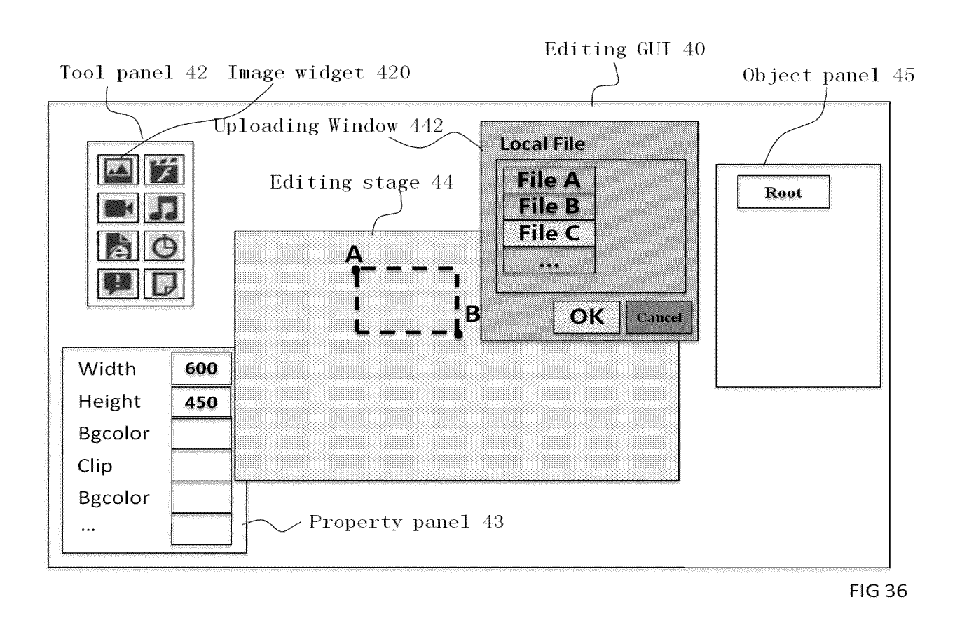

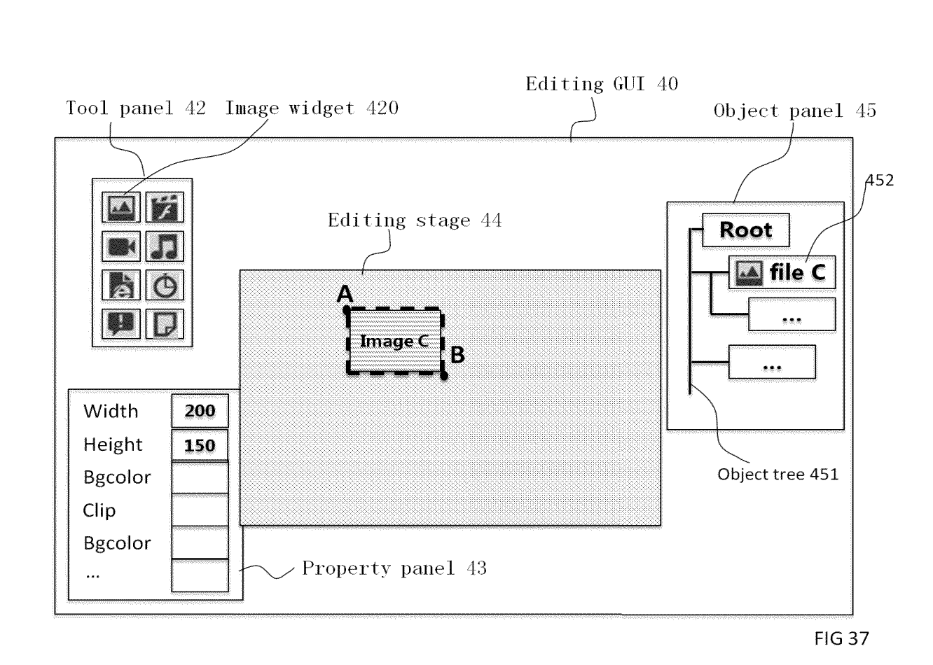

After the object creating area 441 is specified, a media-selecting window 442 is shown for the users to select the resource file of the image object, as shown in FIG. 33. Firstly, a list of image resource files 31 already uploaded on the editing server are shown in the media-selecting window 442, and then one of the image resource files 31 (in this example, image 2) is selected by the user, and after the “OK” button is pressed, the selected image file will be shown within the previously defined object creating area 441, and the image object is created and displayed, as shown in FIG. 34. It is also possible that the resource file of the image object is uploaded from the local computer the editing engine 10 currently operates on, thus, with the media-selecting window 442, the “upload” button is pressed as shown in FIG. 35, after which a list of local image resource files 31 are displayed as shown in FIG. 36, one of the image resource files 31 (File C in this example) is then selected, and after the “OK” button is pressed, the selected image file will be displayed within the previously defined object creating area 441, and the image object is created, as shown in FIG. 37.

In the meantime the image object is created, it is preferred that a new node 452 representing the newly created image object is added in the object tree 451 as the child node of the current node (which is the root node in this example), as shown both in FIG. 34 and FIG. 37.

As shown in FIG. 34 and FIG. 37, it is also preferred that immediately after the image object is created, a property panel 43 showing all property parameters 431 of the image object is automatically shown within the editing GUI 40, for users to further fill in or modify the parameter values of the newly created object. In the example of FIG. 34 and FIG. 37, the width and height of the newly created image object as defined by the object creating area 441 is filled in the corresponding property data fields 432 of the property panel 43.

All web objects within a web case 30 of the present invention are organized in a tree data structure, wherein every web object is a node of the tree data structure or “tree”. The tree data structure is a commonly used data structure that comprises a group of nodes organized in the structure as a “tree”. The first or topmost node in the tree is the root node, and the root node is usually the editing stage 44 in the present invention. Other nodes are then “grown” out of the root node, based on “parent-child” relationships. Each given node in a tree has zero or more child nodes, which are nodes “derived” from the given node, or nodes directly connected to the given node that located on the “downstream” of the tree. A node has a child node is then the parent node of the child node, and each child node has at most one parent node. The child nodes of one parent node are brother nodes under the parent node. Each given node also has a subtree rooted at it, which is a tree comprises the given node itself and all descendent nodes of the given node. A descendent node of a given node is a node directly or indirectly connected to the given node and located on the “downstream” in the tree of the given node, for example, the child node of one child node of the given node is one descent node of the given node.

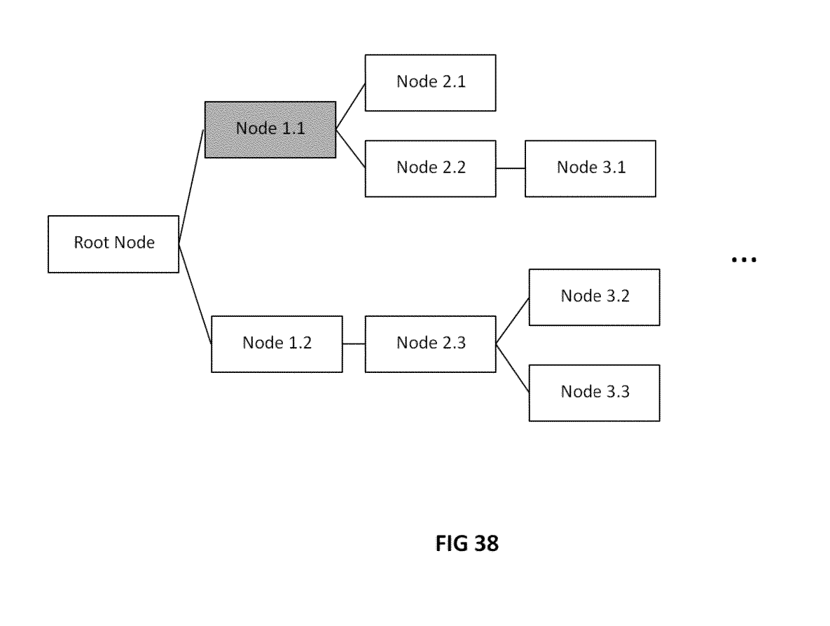

FIG. 38 is a demonstration of the tree data structure. Firstly, there is a root node, from which the object tree “grows” out. The root node first derives node 1.1 and node 1.2; “node 1.1” and “node 1.2” further derives “node 2.1”, “node 2.2” and “node 2.3”, then “node 3.1”, “node 3.2” and “node 3.3” are derived , and so on. Take “node 1.1” as an example, the root node is the parent node of “node 1.1”, “node 1.2” is the brother node of “node 1.1”, “node 2.1” and “node 2.2” are child nodes of “node 1.1”, and the descendent nodes of “node 1.1” include “node 2.1”, “node 2.2” and “node 3.1”.

With the web objects in the present invention, since all objects are organized in the tree data structure, the concept of parent node, child node, descendent node also apply with the web objects of the present invention, thus, any web objects within a web case 30 may have parent object, child objects, brother objects, and descendent objects. In order to facilitate the editing process of web case 30s, the editing engine 10 can be configured to utilize these above relationships in various ways by the editing engine 10, for example:

When a web object is selected, only the descendent objects of the selected web object are going to be displayed and available for editing. The benefit of this configuration is especially obvious when a large number of web objects are being edited in one web case 30.

Certain properties of a web object are passed onto all of its descendent objects. For example, the properties of position, opacity, rotation angle, visibility of a given displayable web object can be passed onto all its descendent objects, i.e. when the given displayable web object is set to be invisible, all its descendent objects are automatically set to be invisible, when the given displayable web object is set to rotating 180 degrees clockwise, all its descendent objects are automatically rotated with 180 degrees clockwise, and etc. The manner a property is passed from a web object onto its descendent objects can be configured according to different needs. For example, when a given object is set to be invisible, all its descendent objects are also set to be invisible, but when the given object is set to be visible, it is not necessary that all its descendent objects are automatically visible, rather, the visibility property of the descendent objects remain unchanged. This configuration makes sure the properties of the descendent objects can be collectively managed by the properties of the parent object, while still remain certain level of independency. Thus the manner of property “passing” from a parent object to a child object can be configured according to different conditions, and the “passing” of properties from parent objects onto child objects does not necessarily means the copy of property parameter values.

The descendent objects of the given container object is automatically set to be contained within the given container object. For example, the descendent objects of a page object are automatically set to be contained/belonged to within the page object, and will be played in one page when the web case 30 they belonged to is being played. Thus, during the editing process of a web case 30, setting the parent-child relationships of the web objects automatically provides the function to set the containing web objects of a container object.

The child objects of a given timer object is automatically set to be managed by the given timer object. When a web case 30 of the present invention is being played, the timer objects manage the properties of certain web objects within the same web case 30 over a specified period of time. Through the parent-child relationships in between web objects, users are capable easily of choosing which web objects to be managed by a timer object.

The parent object of a given event object is automatically set to be the triggering object of the given event object. As briefly illustrated earlier, when a web case 30 of the present invention is being played, the event objects define interactive relationships in between web objects within the same web case 30, more specifically, a certain playing status of a triggering object will result in certain functions to be taken on a target object. Thus the triggering object of an event object can be set through the parent-child relationships.

As mentioned earlier, an object tree is a GUI item displayed on the object panel 45, according to a preferred embodiment of the present invention. The object tree visualizes the data structure of the web objects, which comprises a set of object representation items, while each object representation item corresponds with one web object edited in the editing engine 10. Within the object tree, the object representation items are organized in the same tree structure as the web object they represent, and are shown as “nodes” within the object tree, while the nodes of the object tree copy the parent-child relationships of all the web objects the nodes represent, i.e., two nodes representing a pair of parent object and child object will be shown as a parent node and a child node. The object tree is useful in many ways during the editing process of a web case 30, which will be illustrated in the following embodiments:

In one embodiment, the parent-child relationships in between web objects within a web case 30 is capable of being edited though the editing the parent-child relationships of the object representation items or the nodes within the object tree, for example, by dragging operations of a mouse, the parent-child relationships of the nodes within a object tree is easily changed, and it can be set with the editing engine 10 that the parent-child relationships of web objects changes according to the parent-child relationships of the nodes representing them in the object tree.

In another embodiment of the present invention, the object tree is also capable of managing the display order of web objects. When web objects of the present invention are being displayed on the editing stage 44 as well as in the playing mode of a web case, overlaps might happen depending on the positions of the web objects. The editing engine 10 then needs to decide the display order of the web objects, i.e. when overlaps happen for different web objects, an object with higher display order will be displayed on top of an object with lower display order. The display order of web objects is also preferred to be applied in the playing process of a web case 30, thus what seen by a user in the editing GUI 40 is also going to be shown when the web case 30 is being played.

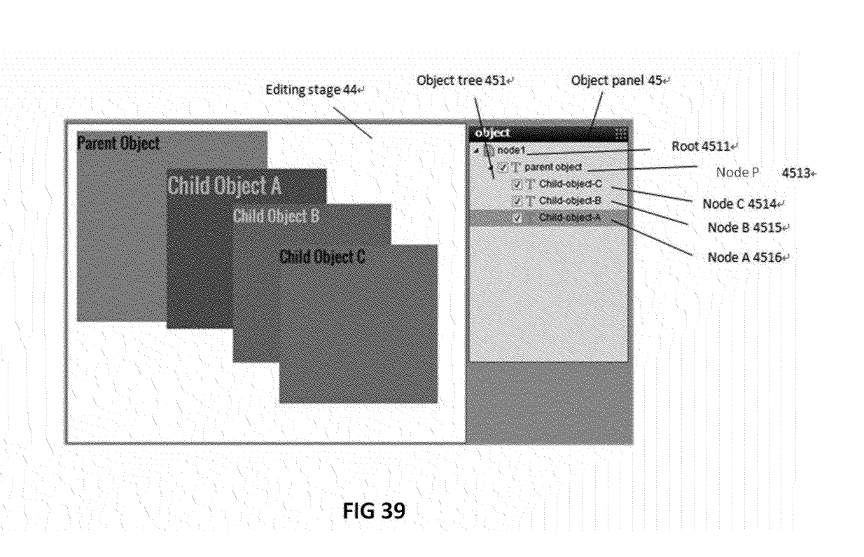

The display order of web objects can be easily managed through the object tree. Different sets of rules can be pre-set with the editing engine 10, to define the different controlling relationships of the display order of web objects by the object tree. In one embodiment, child objects are set to be displayed on top of parent objects, and the display order of brother objects are decided by the manner of arrangement of the nodes within the object tree the brother objects corresponding to. An example is shown in FIG. 39, an object tree 451 is displayed in the object panel 45 of the editing GUI 40. The object tree 451 comprises a root node 4511, a node P 4513, a node C 4514, a node B 4515 and a node A 4516. The node P 4513 is directly derived from the root node 4511 and is thus the child node of the root node 4511. The node A 4516, node B 4515 and node C 4514 are the child nodes of the node P 4513, and the node A 4516, node B 4515 and node C 4514 are brother nodes. The root node 4511 is set to represent the editing stage 44 (not shown in FIG. 39) in this example, and the node P 4513, node A 4516, node B 4515 and node C 4514 respectively correspond to the parent object, child-object A, child-object B, and child-object C, which are all text objects. In this embodiment, the parent-child relationships in between nodes of the object tree are copied from the parent-son relationships of the web objects the nodes represent. Thus, the parent object in FIG. 39 is the child object of the editing stage 44, and is parent object of the child-object A, child-object B, and child-object C.

Since the text objects have background fillings, they are overlapped when being displayed on the editing stage 44. According to the rules of this embodiment, the parent object is displayed on the bottom, under all its child objects. The child object C is displayed on top of child object B, and the child object B is displayed on top of child object A. This display order in between the brother objects is set to be determined by the display manner of the nodes they corresponding to, and in this example, the web object corresponding to a node that is displayed closer to the parent node will have a higher display order, the display matter of the nodes can be easily managed and changed by user operations such as mouse dragging operations—clicking on a node, dragging the node onto a desired position, and release the mouse key, i.e. node C is displayed closer to node P than node B, thus the web object corresponding to node C (which is child-object C) is displayed on top of the web object corresponding to node B (which is child-object B).

Other kind of rules can also be set for the controlling relationships of the display order of web objects by the object tree. For example, parent objects are set to be have higher display order than child objects, and within a set of brother objects, an object corresponding to a node displayed further away from the farther node has a higher display order than an object corresponding to a node displayed closer to the parent node; it is also possible that the brother nodes are displayed with same distances of the parent node, then the display order of the web objects corresponding to the brother nodes are determined by other aspects of the display manner of the brother nodes, for example, the angle of the position of the brother nodes in relate to the parent node. The management of the display orders the web objects through nodes representing them in the object tree makes the editing process much easier for users.

In another embodiment, the arrangement of the nodes within the object tree is partly associated with the creation order of the nodes, or, since it is preferred that a node in the object tree is created in the same time as the creation of the web object the node represent, thus the arrangement of the nodes in the object tree is associated with the creation order of the web objects the nodes corresponding to.

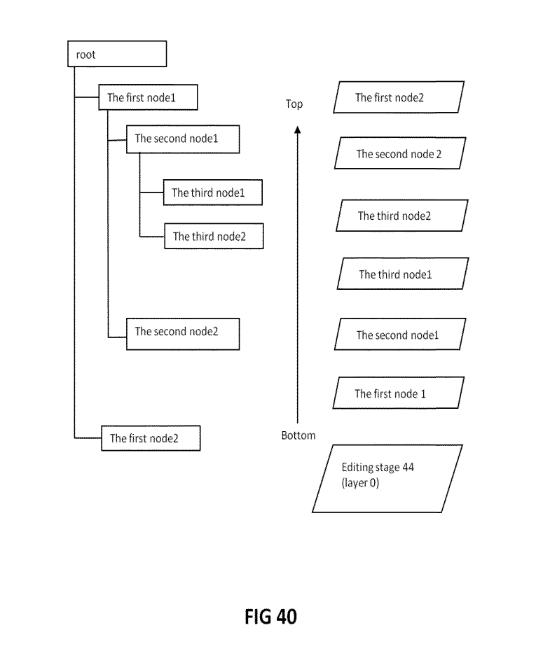

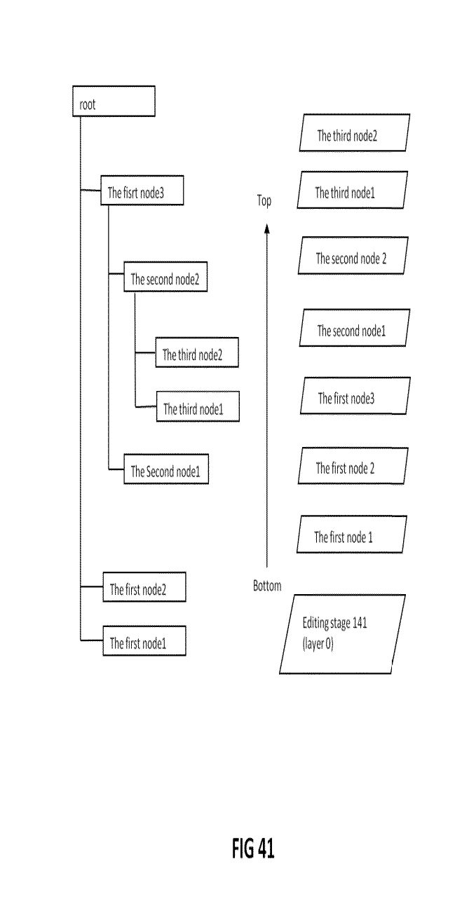

Two examples are shown in FIG. 40 and FIG. 41. In FIG. 40, the creation order of the nodes are indicated by the numbering of the nodes, i.e. the first node 1 is created earlier than the first node 2, and the second node 2 is created earlier than the third node 1, and etc. As shown in FIG. 40, a parent node is always created earlier than a child node, and within brother nodes, a node created earlier will be arranged further away from the parent node of the brother nodes. This example object tree further controls the display order of the web objects the nodes represent, and in this example, a web object represented by a child node has a higher display order than a web object represented by a parent node; within web objects represented by a set of brother nodes, the display order is set as follows: if a node X (not shown) and a node Y (not shown) are brother nodes with the same parent node Z (not shown), and X is arranged further away from Z than Y, then the web object represented by X will have a higher display order than the web object represented by Y, and the objects represented by the all descendent nodes of Y. Thus, with the two rules specified above, the creation order of web objects influences the arrangement of the nodes representing the web objects in the object tree, and further influences the display of the web objects.

In the example shown in FIG. 40, the display order of the web objects represented by the nodes within the object tree is arranged as: the first node 2 object, the second node 2 object, the third node 2 object, the third node 1 object, the second node 1 object, the first node 1 object, the editing stage 44. It can be seen that in general, a web object created later will tend to have a higher display order, the reason for this design is that a web object newly created always require editing operations before another new web object is created. It is worth mentioning that from top to bottom, the web object represented by the nodes will be named after the nodes.

FIG. 41 shows another example similar as FIG. 40 with the same numbering the nodes according to the creation order. However, the arrangement manner of the nodes is different. In the example of FIG. 41, within a set brother nodes, a node created earlier will be arranged further away from the parent node of the set of brother nodes than a node created later. As for the display order of web objects, a web object represented by a child node still has a higher display order than a web object represented by a parent node, and within a set of brother nodes, the rule to determine the display order is exactly reversed compared to the example shown in FIG. 40. Take the example node X, Y, Z in the example of FIG. 40, in the example of FIG. 41, the web object represented by Y will have a higher display order than the web object represented by X, and the web objects represented by all the descendent nodes of X. Thus, the display order of the web objects represented by the nodes in the object tree shown in FIG. 41 is arranged as:: the third node 2 object, the third node 1 object, the second node 2 object, the second node 1 object, the first node 3 object, the first node 2 object, the first node 1 object, the editing stage 44. It is worth mentioning that from top to bottom, the web object represented by the nodes will be named after the nodes.

Some other features of the object tree according to the preferred embodiment of the present invention are illustrated as follows.

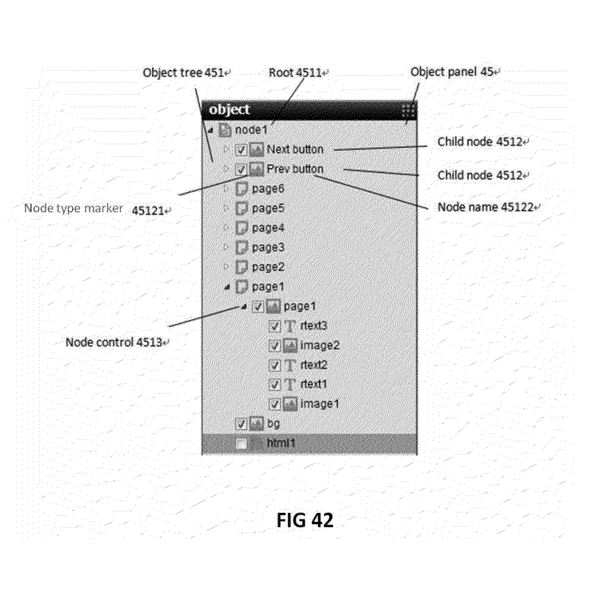

Referring to the FIG. 42, the object tree 451 is displayed on the object panel 45 for managing the objects which editing on the editing stage 44. The object tree 451 has a root node 4511 and a plurality of other nodes. The object tree 451 is capable of managing different type of objects created from the editing stage 44. The user is capable of selecting the created object from the tool panel 42. It is noteworthy that in the object tree shown in FIG. 42, there are not “links” or “edges” connecting the parent nodes and child nodes, rather, the parent-child relationship in this object tree is illustrated by indentation of the nodes, i.e. if two nodes displayed next to each other have the same indentation, then they are brother nodes; if a node has an indentation larger than a node displayed right above it, then the node with the larger indentation is the child node of the other node. Preferably, each node within the object tree has a node type marker 45121 and node name 45122. The node type marker 45121 and the node name 45122 help users to easily recognize different nodes. The node type 45121 is capable of utilizing the symbol or image to identify the type of node. For example, a node representing a text object can be indicated by the symbol “T”. The object tree 451 further has a node control 4513 for controlling the closing or extending of a node. The node control 4513 provides the function of showing or not showing the child nodes of any given node, which helps users to organize the object tree better. In this example, when the node control 4513 is shown as a white triangle, the node control can be clicked to extend (or show the child nodes of) the corresponding node; and when the node control 4513 is shown as a black triangle, then the corresponding node is already extended, and by clicking the black triangle, the corresponding node is closed (or the child nodes of the corresponding node is hidden); If there is no node control shown beside a node, then the node has no child nodes to be shown.

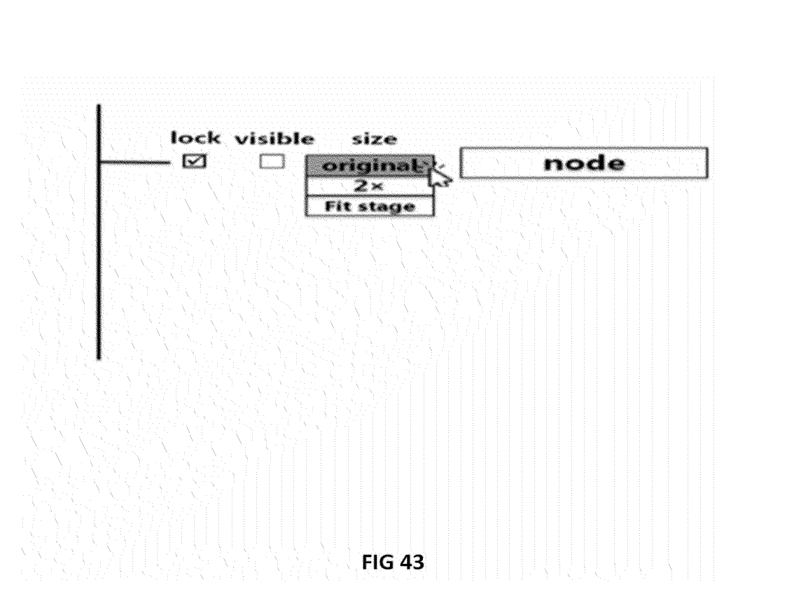

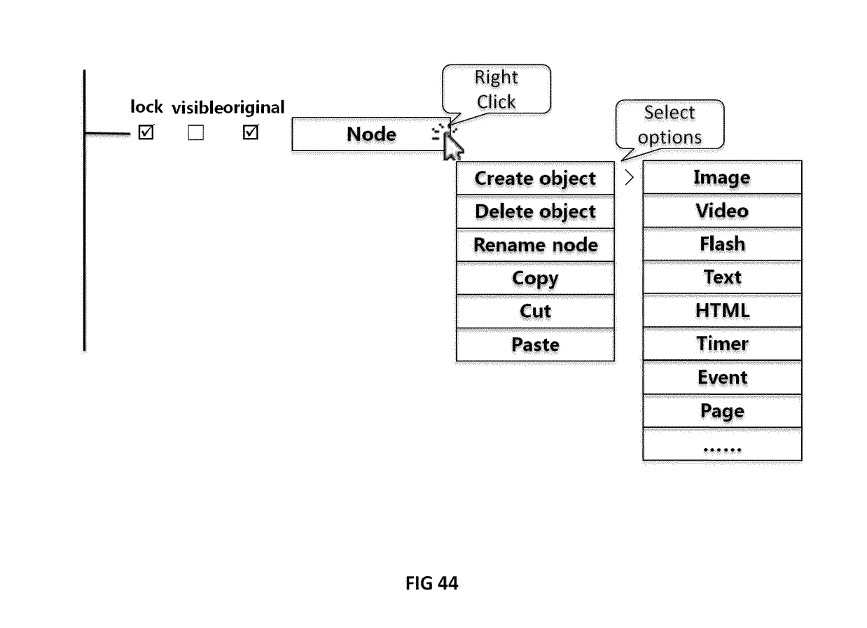

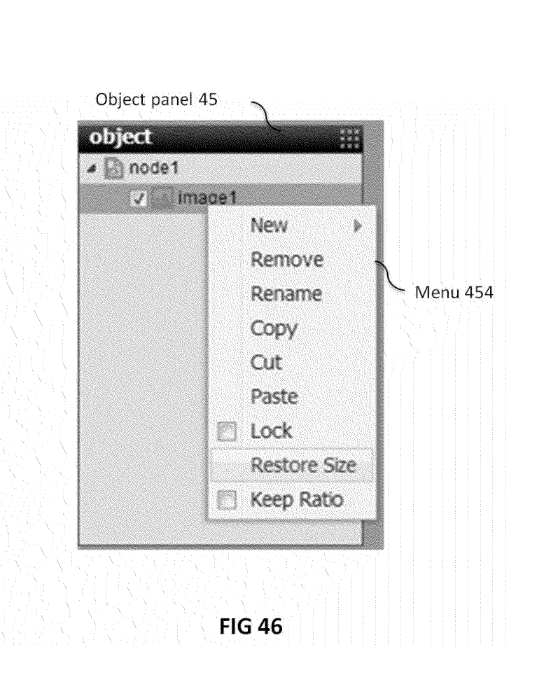

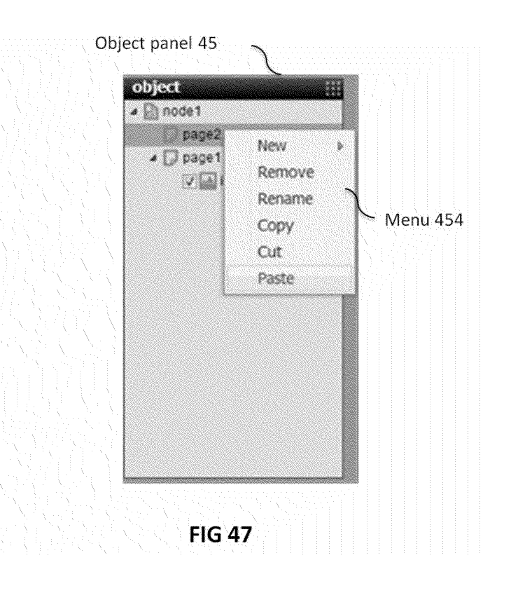

During the editing process of a web case, the object tree might provide various shortcuts for users to manage the web objects easily. FIG. 43 shows an example that check boxes and dropdown menus might be added beside a node in the object tree, for uses to set certain properties of the web object the node represent. In the example shown in FIG. 43, users might check the check box of “visible” to set the web object the node represents as visible, or choose the option “original” in the dropdown menu to display the web object the node represent in the original size of the media resource. FIG. 44 shows an example that users might right click a node in the object tree to bring out a menu with operation options for the web object the node represent. In this example, the user might right click on the node, and choose the option “create object” in the menu to create a new web object as the child object of the web object represented by the node, then further choose which kind of web object to create. In preferred embodiments, different types of nodes might show different menus when being right clicked, as shown in FIG. 46 and FIG. 47.

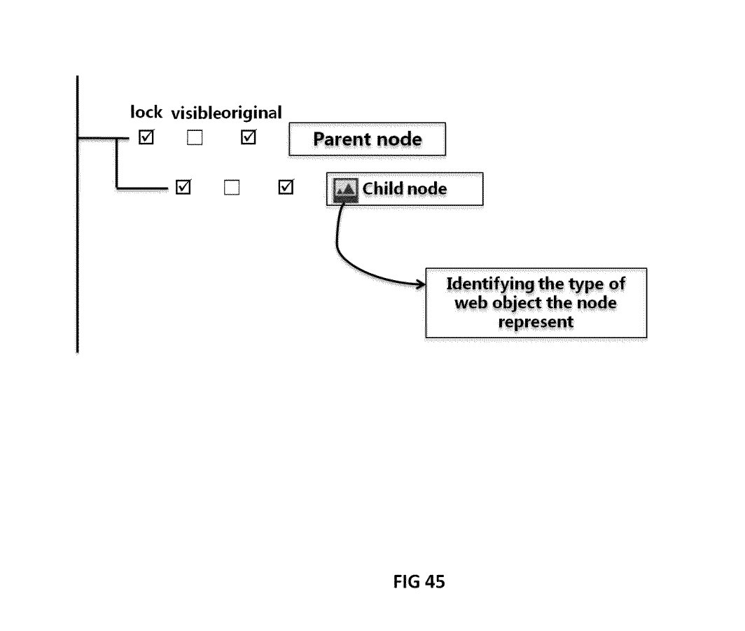

As show in FIG. 45, the node type marker is capable of marking the type of the web object a node in the object tree representing, to provide a better overview of the web objects created in a web case.

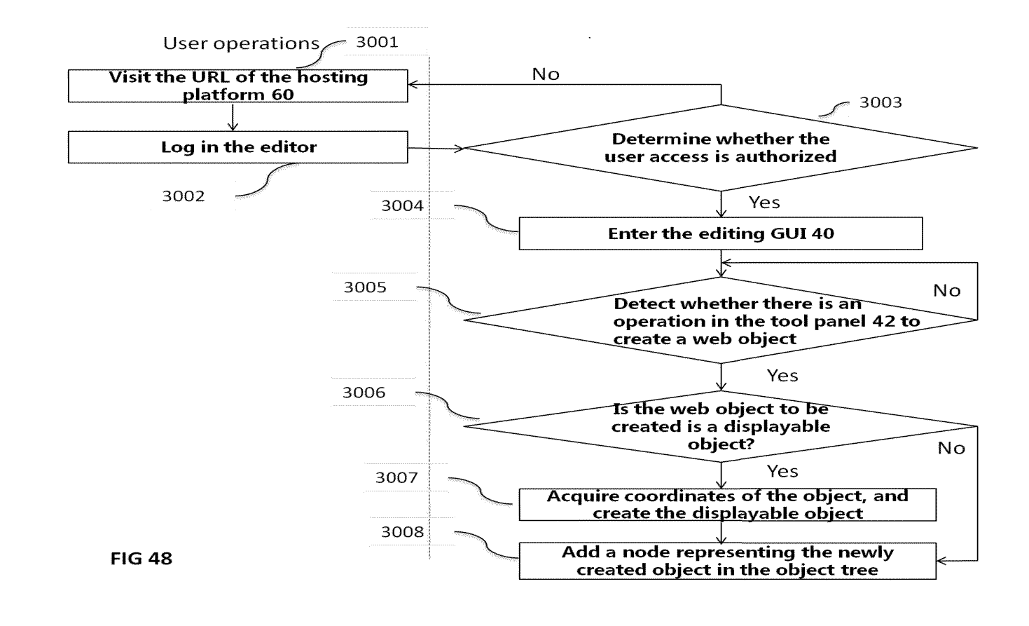

As show in FIG. 48, a process of creating web objects according to the preferred embodiment of the present invention is illustrated. The editing engine 10 functions on the basis of a web browser 34, and when the web browser 34 visits a certain URL (step 3001), the editing engine 10 is automatically downloaded, installed, and loaded. The user is able to visit a hosting platform 60 to further access the editing engine 10. The user first log into the hosting platform 60 (step 3002), the hosting platform 60 verifies the account and the password of the user, and decides whether access to the editing engine 10 is authorized (step 3003). If access is authorized, the user is then allowed to access the editing engine 10 and the editing GUI 40 is shown in the web browser 34; if access is not authorized, the user is routed back to the log in page of the hosting platform 60. After the editing GUI 40 is loaded, the editing engine 10 detects whether there is an operation in the tool panel 42 for creating a web object, if yes, the editing engine 10 goes on to the next step 3005 to detect the type of object to be created; if no, the editing engine 10 continuous to wait for operation to create a web object. In the next step 3006, the editing engine 10 detects whether the web object to be created is a displayable object, if yes, the coordinates values of the object is acquired and the object is created and displayed within the editing GUI 40 (step 3007), and in the mean time, a node corresponding to the newly created object is added in the object tree (step 3008); if not, no displayable object will be created and displayed, but a node corresponding to the newly created non-displayable object is also added in the object tree. In either case, the new node corresponding to the newly created object is created as a child node of the current node. The current node is an important concept in the operations of the object tree of the present invention. Within an object tree and at a given point of time, there is only one node that is set as the current node, which is the node under operation at the given point of time. The current node can be set to be any node that is most recently created, or to be indicated by user through user inputs as clicking a node shown on the object tree with a mouse. The object represented by the current node is the “current object”, which is the web object currently under operation, and in a preferred embodiment, the property panel 43 always shows the property parameters of the current object. The hosting platform 60 provides services like user verification, payment services in addition to the editing engine 10.

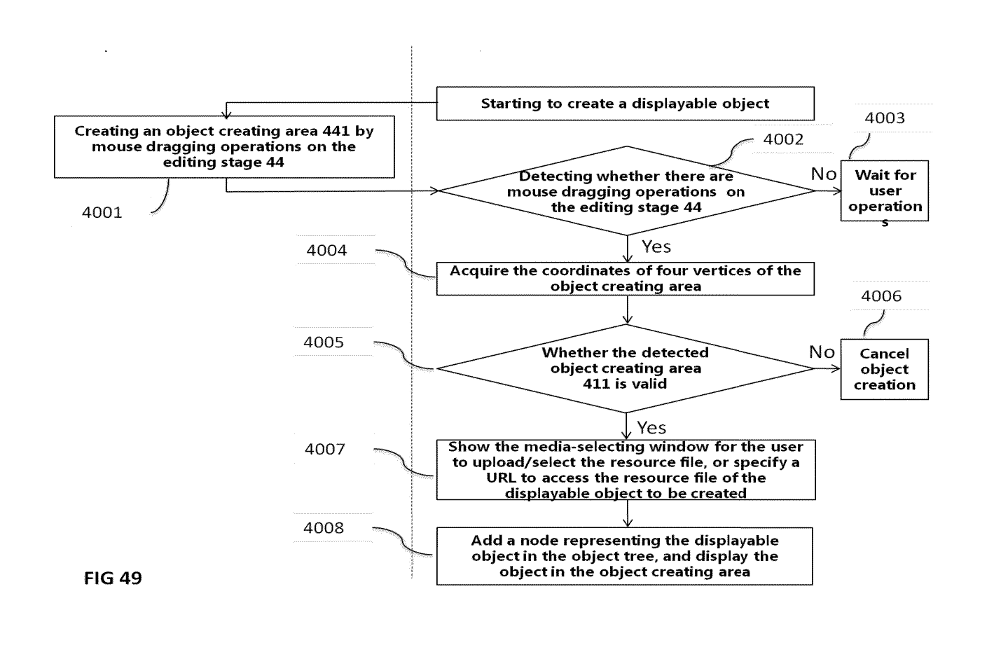

As show in FIG. 49, a process of creating a displayable object according the preferred embodiment of the present invention is illustrated. First, the editing engine receives an instruction to create a displayable object and starts to create the displayable object (step 4001). Then, it waits for an object creating area 411 to be specified by the user, and preferably by the mouse dragging operations on the editing stage (step 4002). When there are mouse dragging operations on the editing stage being detected, the editing engine acquires the coordinates values of the four vertices of the object creating area (step 4004), and further determines whether the object creating area 411 just specified by the user is a valid area (step 4005), if yes, then the step 4007 is taken, and if not, the object creating process is canceled (step 4006). In the next step 4007, the media-selecting window is shown for the user to select or upload the resource file of the displayable object to be created, or to enter a URL to locate and download the resource file for the editing engine. At last the step 4008, a node within the object tree representing the displayable object will be created, preferably as the child node of the current node, and in the mean time, the displayable object is displayed in the object creating area 411 specified by the user.

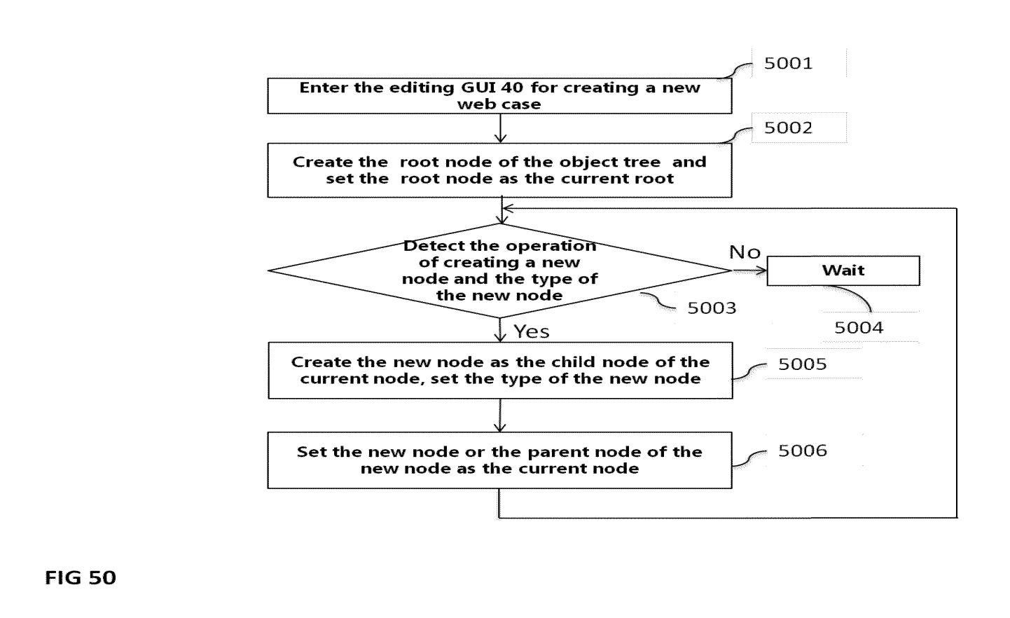

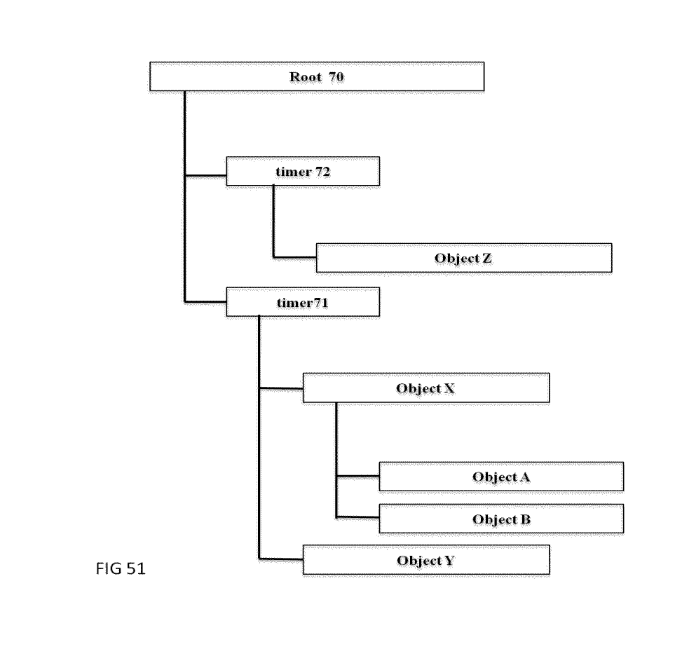

As shown in FIG. 50, a process of creating a new node according the preferred embodiment of the present invention is illustrated. After the editing GUI 40 is loaded for creating a new web case as shown in step 5001, the editing engine immediately create the root node in the object tree, and set the root node as the current node (step 5002). Then the editing engine detects whether there is an operation indicating a new node in the object tree to be created, as well as the type of the new node to be created (step 5003), if yes, the next step 5005 will be taken, if not, the editing engine continues to wait (step 5004) for further instructions. In the next step (step 5005), a new node is created as the child node of the current node, and the type of the new node created will be set. For example, if the new node represents an image object, then an node type marker corresponding to an image object will shown beside the new node. At last, in step 5006, the new node created or the parent node of the new node created will be set as the current node, and the editing engine will go back to step 5003 to wait for instructions to further create other nodes within the object tree. In step 5006, if the new node created is set to be the current node, then a second new node created after the new node will be the child node of the new node (according to step 5005); if the parent node of the new node is set to be the current node, then a second new node created after the new node will be the brother node of the new node. The editing engine can be configured to either set the new node or the parent node of the new node as the current node according to different needs.

It is noted that the object tree is only one embodiment of the structure the object representation items are organized. According to different needs of the editing engine 10 and different data structure of the web objects, the object representation items displayed in the object panel 45 might be organized in a different way, for example, a network structure, or a centralized structure. The functions illustrated earlier independent of the tree structure also apply to other possible structures. For example, the object controlling features shown in FIG. 43 to FIG. 47

The timer object or timer is one of the non-displayable objects contained in the web case 30 of the present invention. In general, a timer object is used to control the properties of certain other web objects including other timer objects over a certain period of time when a web case 30 is being played. The web objects whose properties are controlled by a timer are “managed” by the timer and will be referred to as the managed objects of the timer, while the period of the time during which a timer controls the properties of its managed objects will be referred to as the managed time period of the timer. A timer might have one or multiple managed objects, but usually, a web object can only be managed by one timer object. During the playing process of a web case 30, if a timer object contained in the web case 30 is started or “triggered”, then the managed objects of the timer will start playing according to the properties set by the timer over the managed time period of the timer. During the playing process of a web case 30, the managed objects of a timer might also be shown or displayed beyond the managed time period of the timer, and the manner of this kind of object display can be set in the properties of the timer object. Thus, in the playing process of a web case 30, a timer might be understood as a set of playing logics predefined for the managed objects of the timer, and this set of playing logics will be referred to as the timer logic here after. A playing logic of a timer defines of the playing status of each of its managed objects on every point of time within its managed time period, wherein the playing status of each managed object on a certain point of time comprises all properties set for the managed object on the point of time.

With the editing engine 10, users are able to set which web objects are to be managed by a timer, and further set the properties of the web objects over the period of time the timer manages. In a preferred embodiment, users might set the managed objects of a timer through the parent-child relationships within web objects. For example, a timer object is capable of having a plurality of child objects, and these child objects are set to be the managed objects of the timer. FIG. 51 shows an example of this case, while timer 71 manages object X and object Y, and timer 72 manages object Z. In the mean time, X further has two child objects, object A and object B, while object A and object B are not directly managed by timer 71. However, since object X is the parent object of object A and object B, and thus acts as a container of object A and object B, many properties of object X can be passed onto object A and object B, thus timer 71 indirectly manages object A and object B as well.

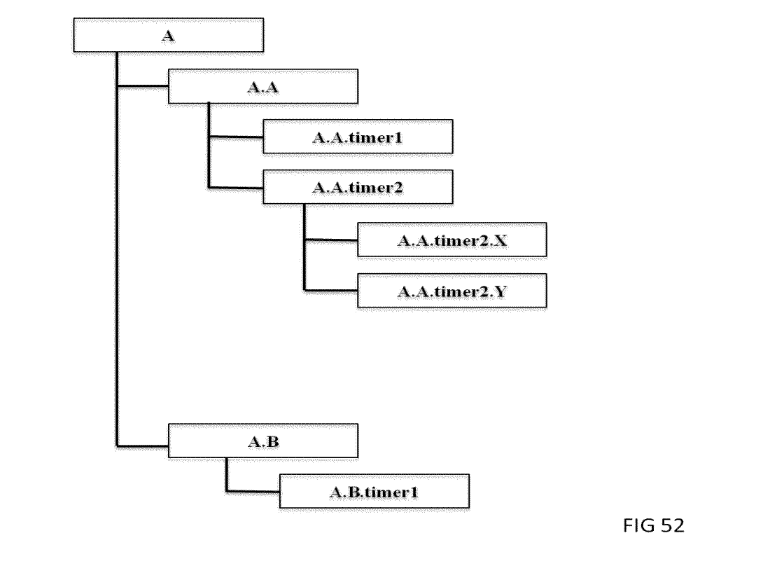

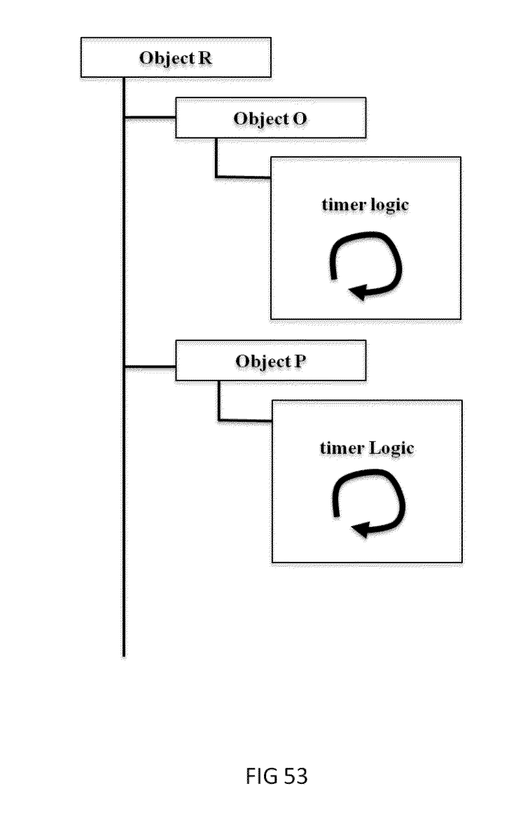

FIG. 52 illustrates the case when timer objects are child objects of other web objects. In a preferred embodiment, during the playing process of a web case 30, a timer object can be set to be triggered by certain playing status of its parent object. For example, when the parent object of a timer starts playing, the timer object is automatically triggered. It can be set in the properties of a timer object that whether it is automatically triggered by a certain playing status of its parent object, and further, what is the playing status of the parent object that will trigger the timer. For example, the displaying, the disappearing of the parent object. With this feature, the timer object or the playing logic controlled by the timer object is capable of being “encapsulated” under another object, (such as the parent object of the timer), as shown in FIG. 53, thus greatly helps users to edit the playing logic of a web case 30 with a large number of web objects.

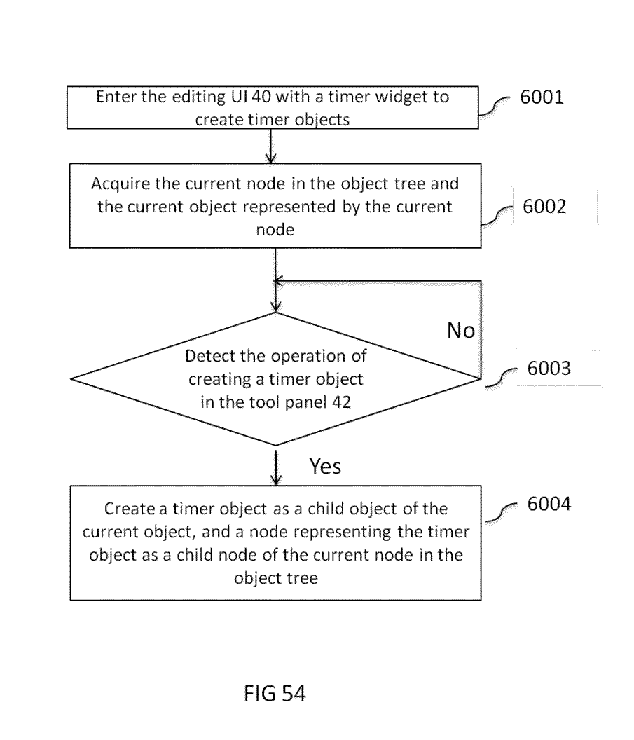

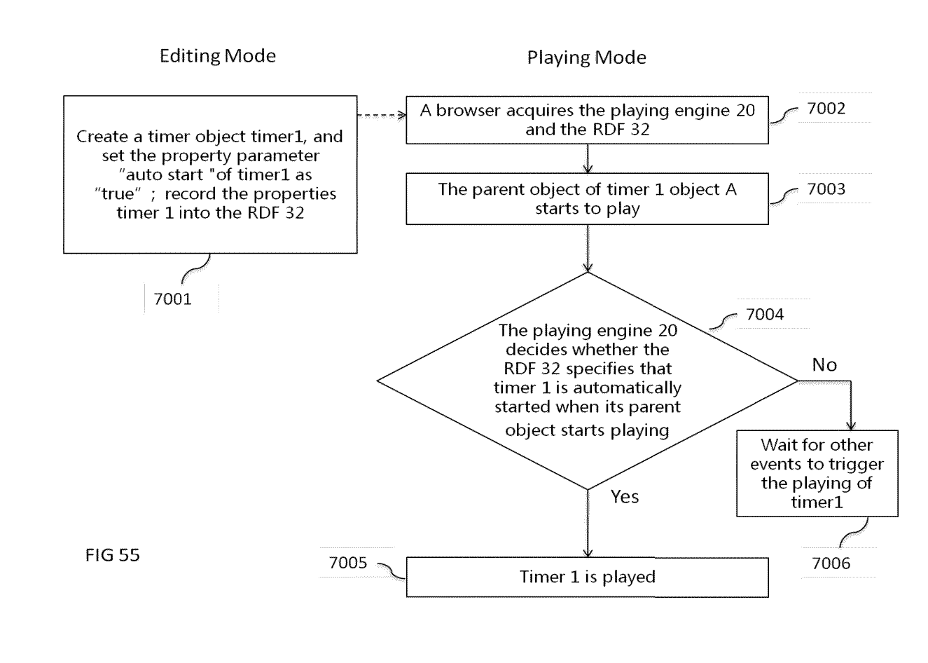

One embodiment of the editing process of a timer object is shown in FIG. 54, which comprises the following steps:

6001 The editing engine 10 loads the editing GUI 40, wherein a timer widget for creating a timer object is included within the tool panel 42

6002 The editing engine acquires the current object and the current node representing the current object in the object tree. In a preferred embodiment, the current object is set to be the parent object of any newly created web objects.

6003 The editing engine detects whether there is an operation on the tool panel to create a timer object. If there is an operation to create a timer object, the next step is taken, if not, the editing engine continues to wait for further instructions.

6004 A timer object is created as the child object of the current object, and in the mean time, a node representing the newly created timer object is created as the child node of the current node in the object tree.

FIG. 55 illustrates a process of triggering the playing of a timer according to a preferred embodiment of the present invention. First, in the editing mode of a web case as shown in step 7001, a timer object timer 1 is created, and the property parameter “auto start” of timer1 is set to have the value of “true”, which means during the playing process of the web case containing timer1, timer 1 will be automatically started/triggered when the parent object of timer 1 starts playing. In step 7002, a web browser visits the URL/web address of the web case 30 containing timer 1, acquires the playing engine 20 and the RDF 32, and starts to play the web case 30. In step 7003, object A, which is the parent object of timer 1 starts to play, then, the playing engine 20 decides whether it is specified in the RDF 32 that timer 1 has a parameter value of “true” for the property parameter “auto start” (step 7004), if yes, timer 1 is started to play (step 7005) since the parent object of timer 1 (object A) has started to play in step 7003; if not, the playing engine continues to wait for other events to trigger to playing of timer 1 (step 7006).

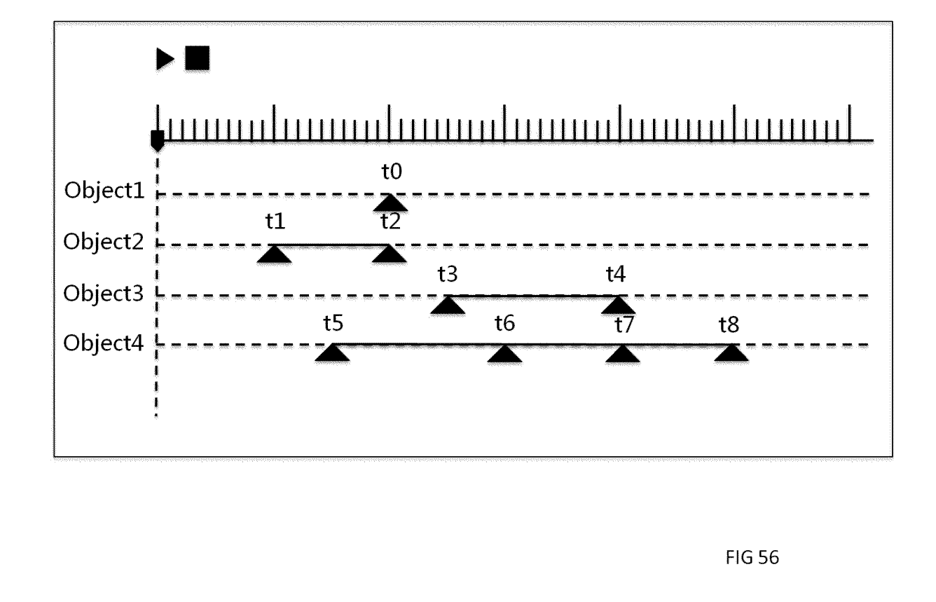

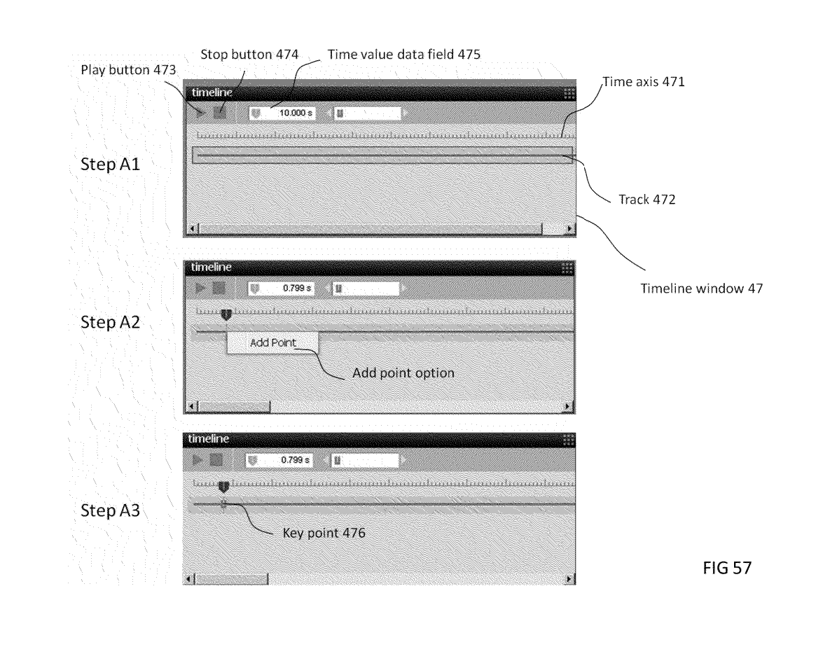

FIG. 56 illustrates a method of setting properties of the managed objects by a timer object according to preferred embodiment of the present invention. Firstly, the web objects to be managed by a timer object are determined, either through the object tree or other methods. For example, through setting certain property parameter values on property panel 43 of the timer. As shown in FIG. 56, the timer manages four objects, i.e. object 1, object 2, object 3 and object 4. The properties of the above four objects managed by the timer might be set through key points. A key point is a point of time within the managed time period of a timer, and on each key point, the playing status of one of the managed objects of the timer can be defined. In other words, a key point is a marked point of time on which the playing status of a managed object of a timer can be specified. It is noteworthy that each key point only corresponds to one managed object of a timer, which will be referred as the marked object of the key point, while each managed object of a timer is capable of having multiple key points. In FIG. 56, t0 is a key point corresponding to object 1, t1 and t2 are key points of corresponding to object 2, and etc. On each key point, the properties of the web object corresponding to the key point might be set by user, and when the timer is triggered, the web object will be played according to properties set on each key points it corresponds to. Since properties of a web object in between its key points are not specified, they will usually be calculated through certain preset rules, for example, one of the interpolation algorithms. An interpolation algorithm is a mathematical algorithm to construct new data points within the range of a discrete set of known data points, commonly used interpolation algorithm include polynomial interpolation (as Lagrange polynomial, Newton polynomial), rational interpolation, trigonometric interpolation, spline interpolation, Bezier interpolation and etc. Thus, the properties of a managed object of a timer can be determined on each point of time on the managed time period of the timer.

It is worth mentioning that if there is not a key point corresponding to the starting point of time of the managed time period of a timer (i.e. the first key point set on a managed time period of a timer has a time value larger than zero), then it might be set whether the web object corresponding to the key point is displayed during the period of time before the first key point. If the web object is set to be displayed, then it will be displayed with the properties set on the first key point, otherwise, the web object will not be displayed until the first key point starts. Similar case also applies to the last key point on the managed time period of a timer.

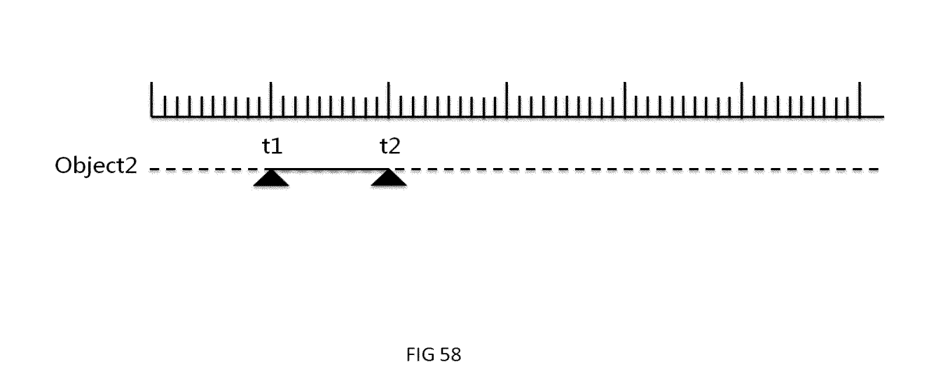

Within the editing GUI 40, there are various ways that users might define key points for a certain managed object of a timer, and further set the properties of the managed object on the key points. For example, through the property panel 43 of a timer, users might specify the time value and corresponding web object of a key point. In a preferred embodiment, the key points are defined through tracks 472. A track 472 or a track object 472 is another kind of non-displayable web object that might be associated with a managed object of a timer. A track object 472 is capable of “carrying” key points of the web object it is associated with, which will be referred to as the “marked” object of the track 472. A track object 472 might be added through a corresponding widget on the tool panel 42, or directly through the object tree under the node representing the web object the track 472 is to mark. In a preferred embodiment, the parent object of a track object 472 is automatically set to be the marked object of the track object 472. FIG. 57 shows an example of a track object 472 being edited, and in this example, a track object 472 is displayed in a timeline window 47 on the editing engine 10 once the track object 472 is activated. In step A1, the timeline window 47 first shows a time axis 471 with a length of time equals the length of the managed time period of the timer that manages the marked object of the track 472, and the track 472 is shown as a “line” or a “bar” under the time axis 471 with the same length. The timeline window 47 also has a time value data field 475 to show the time value of a specific position/key point on the track 472 object, and when no position on the track 472 object is specified, the time value data field 475 shows the length of the managed time period, which is 10 second in this example, and when a specific position /key point on a track 472 is chosen, the time value data field 475 then shows the time value of the chosen position/key point. There is also a play button 473 and a stop button 474 in the timeline window 47, which are used to start and stop a preview playing of the web objects managed by the track/tracks in the timeline window 47. When a specific position on a track 472 is right clicked, as illustrated in step A2, a menu with an option “add point” will be shown, and the time value of this position is shown in the time value data field 475, which is 0.799 second in this example. Then, if the “add point option” is chosen, a key point will be added on the position previously being right clicked, as shown in step A3. Then, when the created key point is clicked, a property panel 43 corresponding to the web object will be shown, and all property parameters 431 can be set with the web object on the specific key point. It is noteworthy that a web object might have multiple tracks 472, as long as there are not conflicting property settings on two key points that mark the same point of time. In the meantime, tracks 472 corresponding to the web objects managed by a same timer can be displayed all together one after another within a same timeline window 47, to provide an overview of the managed objects of the timer.

As one of the web objects contained in the web case 30 of the present invention, a track object 472 also has a corresponding property window, and one embodiment of the property window of a track object 472 is shown back in FIG. 26. The “type” parameter indicates the type of interpolation algorithm used to calculate the properties of the marked web object of the track 472 in between key points. The “start show” parameter decides whether the marked object of the track 472 is displayed before the time point indicated by the first key point on the track 472, the value “true” means the marked object is displayed, while the value “false” means otherwise, and the default value is “false”. Similarly, the “end show” parameter decides whether the marked object of the track 472 is displayed after the time point indicated by the last key point on the track 472, the value “true” means the marked object is displayed, while the value “false” means otherwise, and the default value is “false”.

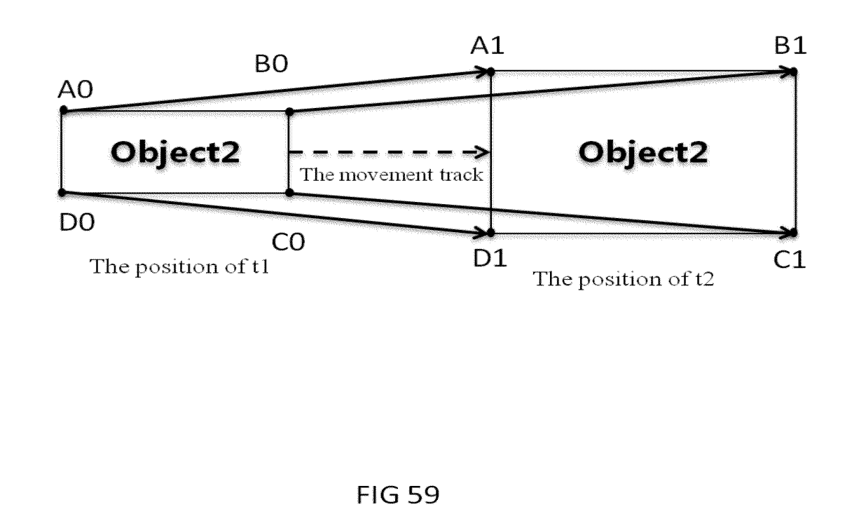

FIG. 58 illustrates the controlling of object2 by the timer, wherein object2 has two key points t1 and t2. At each of the two points, properties of object 2 can be set. For example, if object 2 is an image object, and on both t1 and t2, the properties such as position, size, transparency, rotation angle of object 2 can be respectively set, while object 2 is set to be non-displayed both before key point t1 and after key point t2. When the timer is triggered, object will start to be displayed at key point t1, with the properties specified at t1. Then, the properties of object 2 will start to change towards the properties set in t2 over the time period in between t1 and t2. Since there are only two key points set for object 2 over the managed time period of the timer, the interpolation algorithms will usually give a linear function for calculating the values of property parameters 431 of object 2 in between the two key points, thus, properties will change linearly from key points t1 to t2 according to the parameter values set on both key points. For example, FIG. 59 shows the situation when the position and size of object 2 is changed over the time period in between t1 and t2. When the timer is being played at the key point t1, with four vertices of object 2 will be at the position of A0, B0, C0, D0, then the four vertices will move with a constant rate to A1, B1, C1, D1 respectively, during the time period in between t1 and t2.

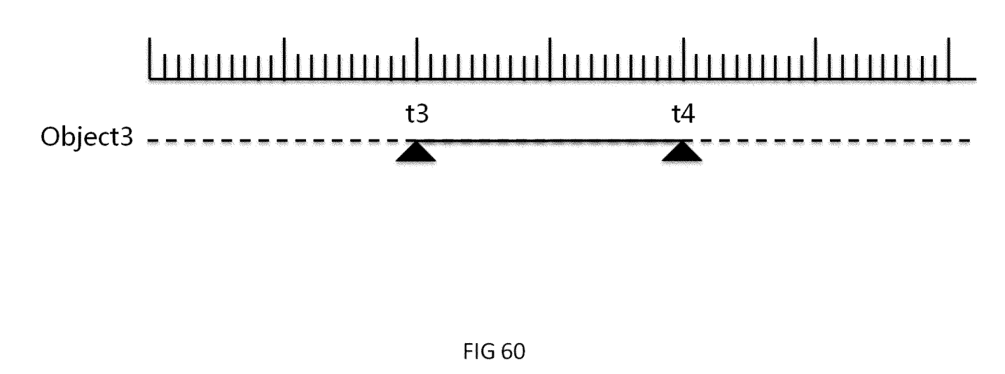

FIG. 60 shows the situation when the timer controls the visibility property of object 3. The object 3 is set to be visible both at the key point t3 and t4, while all other properties of object 3 are set to be the same at t3 and t4. Also, it is set that during the time before t3 and after t4 of the managed time period of the timer, object 3 is not displayed. Thus, when the timer is triggered, object 3 is not going to be shown until the key point t3, then, object 3 will be displayed during the time period in between t3 and t4, and after t4, it will disappear.

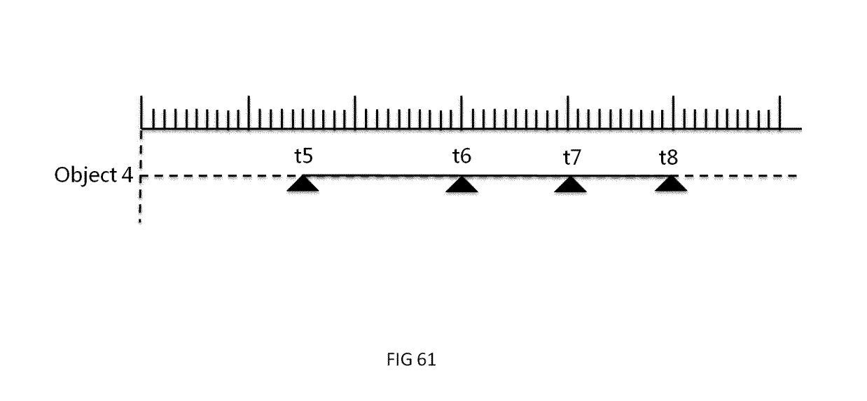

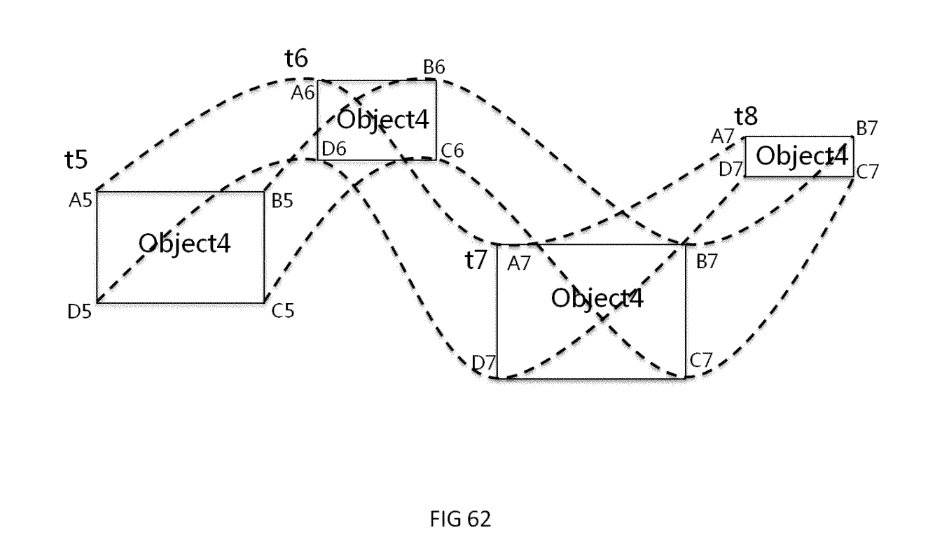

FIG. 61 and FIG. 62 together show a more complicated case when the position and size of object 4 are controlled on four key points, t5, t6, t7, and t8. Similar to the case illustrated in FIG. 58 and FIG. 59, the object 4 is an image object, and on four key points within the managed time period of the timer, the properties of position and size of object 4 are specified. Thus, when the timer is triggered, at key point t5, object 4 will have the four vertices at the position of A5, B5, C5 and D5, which will then move to A6, B6, C6, D6 on time point t6, and to A7, B7, C7, D7 on time point t7 and at last to A8, B8, C8, D8 on time point t8. Similarly, the property parameters 431 of position and size of object 4 or the position of the four vertices of object 4 in between the four key points will be calculated by interpolation algorithms, and with a preferred interpolation algorithm, the four vertices will move through a smooth track. Since there are four key points in this example, the interpolation function adopted for calculating the position values of each of the four vertices in between key points is not going to be a linear function, thus the rate with which each of the four vertices move in between the key points are not constant.

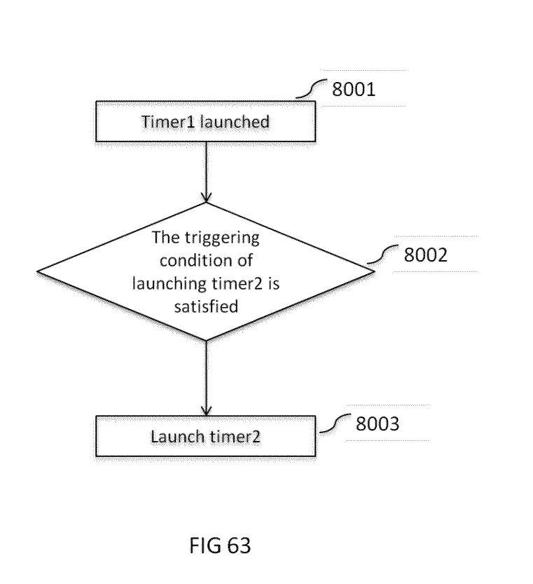

All properties of a managed object of a timer can be set on key points, besides what is illustrated before with the property of position and size. For example, the property of rotating angle, background color, or opacity can also be defined on key points, and be calculated by interpolation algorithms in time period between the key points. In the meantime, the managed object of a timer can also non-displayable objects such as another timer, and with this case, a timer can trigger the playing of another timer. An example is shown in FIG. 63, wherein a timer 1 controls the playing of a timer 2. As shown in FIG. 63, during the playing process of a web case, a timer 1 is first launched (step 8001), and when a certain key points on the timer1 is reached (step 8002), a timer 2 will be automatically launched. The triggering of timer 2 by time 1 can be set through an event object, i.e., the triggering object is set to be timer 1, the triggering condition is set to be the reaching of a certain key point on timer 1, while the target object is set to be timer 2, and the target function is “launch” (step 8003). More details about the event objects will be given later in this disclosure.

There is an alternative way that a timer might be used during the playing process of a web case 30, other than playing the managed objects with previously set properties over the managed time period. In the alternative way, a seek function of a timer can be called, which is able to “seek to” any key points of the managed objects of the timer. When a key point is “sought to” by the seek function, the key point is first located, and then the marked object of the key point is played according to the playing status specified on the key point. A seek function is usually called by preset events during the playing process of a web case 30, thus with the seek function, the managed objects of a timer is played according to the preset events instead of the playing time of a web case 30.

In one embodiment of the seek function, only the playing statuses of the managed objects that are marked on key points will be played/realized. For example, a timer has only one managed object, which is an image object, and the image object has three key points on which the its playing statuses are specified, as status 1, status 2, and status 3. Then, during the playing process of the web case 30 the timer is contained within, if a seek function is called when the timer is triggered, then the image object will only be shown as a static image with a playing status either of status 1, status 2, or status 3, while the switching in between these three statuses is controlled by certain events associated with the seek function of the timer. For example, when the timer is being played, users can click another two image objects within the same web case 30 that is shown as a “next” button and a “back” button to switch in between the three playing statuses, when the “next” button is clicked, the image object will switch to the next playing status, such as from status 1 to status 2, and when the “back” button is clicked, the image object will switch to the previous playing status, such as from status 2 to status 1. It is also possible that when the timer is triggered, the number keys “1”,“2” and “3” on the keyboard can be pressed to bring out corresponding playing statuses, i.e. pressing the number key “1” will result in the playing of the image object at status 1. In another embodiment of the seek function, not only the playing status of the managed objects on key points will be realized, but the playing status of the managed objects on all time points in between certain key points are also played. It can be set during the editing process of a web case 30 that whether the playing status for one managed object of a timer should be played in between all time points between two specified key points, if yes, when the first key point is sought to, the managed object will be played during the time period in between the two key points, while the playing statuses in between the two key points are calculated by interpolation algorithms as previously mentioned. The first key point refers to the key point with smaller value between the two key points.

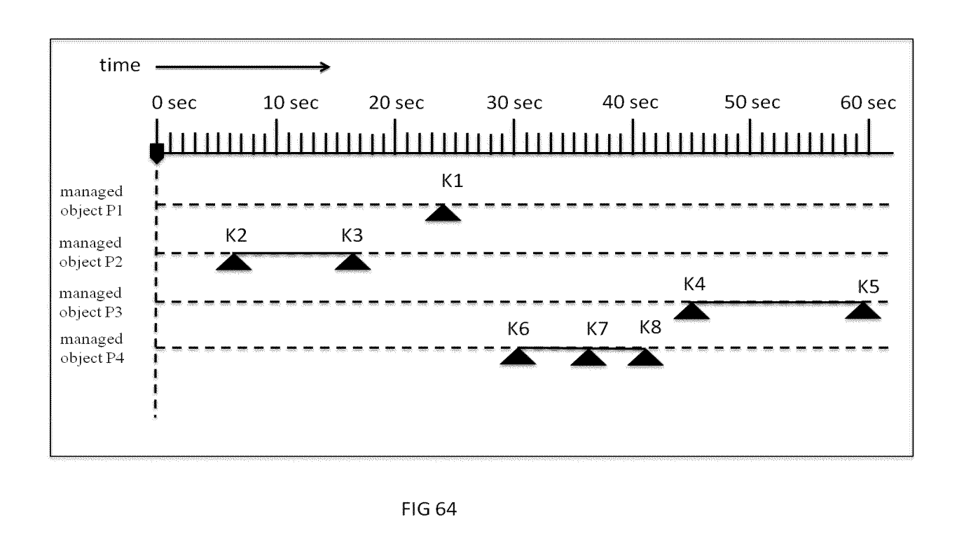

The seek functions can be defined in various ways according to the manner it “seeks to” key points. Two commonly used seek functions according to a preferred embodiment of the present invention are the SeekToNextPoint function and the SeekToNextObject function. When called, both functions are able to locate a current key point and seek to the “next” key point of the managed objects of a timer, but the definitions of the “next” key point are different for the two functions when the timer has multiple managed objects. It is firstly noted that since the key points are marked points of time within the managed period of a timer, every key point has a time value t, while 0≦t≦T. T refers to the length of the managed period of the timer. If there are a set of key points, they can be arranged into a sequence according to the time value of each of these key points, with the key point of the smallest time value as the first key point. When a current key point is given among the set of key points, the “next” key point of the current key point would be the key point following the current key point on the sequence. During the playing process of a web case 30, the SeekToNextPoint function of a timer will seek to the next key point of a given current key point among all key points of the managed objects of the timer, while the SeekToNextObject function will seek to the next key point of the given current key point among all key points of the marked managed object of the current key point. For both of the functions, the current key point is the key point that is currently sought to, and since the SeekToNextPoint and SeekToNextObject functions are usually called repeatedly to navigate through different key points, thus the current key point changes every time the seek function is called. It is also possible that a default current key point is given before any seek functions are called, for example, the first key point among all key points of the managed objects of a timer is set to be the default current key point. An example of the two seek functions is shown in FIG. 64. In this example, four tracks marking four managed objects of one timer are shown, and the four managed objects are P1, P2, P3 and P4. The key points of each of the four managed objects are marked on the corresponding tracks. K1 for the managed object P1, K2 and K3 for the managed object P2, K4 and K5 for the managed object P3, and K6, K7 and K8 for the managed object P4. When the timer is triggered in the playing mode of the web case, it will play from “0 second” on, as illustrated in FIG. 64. In the playing process of the web case, every time when the SeekToNextPoint function is triggered, the playing order of the key points of the four managed objects will be K2, K3, K1, K6, K7, K8, K4, K5; and every time when the SeekToNextObject function is triggered, the playing order of key points of the four managed objects will be K1, K2, K3, K4, K5, K6, K7, K8.

Except for the seek functions, the timer object also has a delete function, a SetProperties function, a play function, a replay function, a pause function, a SeekToNextTrack function, and a SeekToPrevTrack function. The usage of these functions are specified as follows:

| Function Name | Usage |
|---|---|
| delete | Delete the timer object |
| Set properties | Set the properties of the timer object |
| play | Start to play the managed objects of the timer according |
| | to the preset timer logic |
| replay | Replay the managed objects of the timer |
| pause | Pause the playing of the managed objects of the timer at |
| | the point of time the pause function is called |
| SeekToNextTrack | Seek to the first key point on the next track and start |
| | playing the object the key point marks |
| SeekToPrevTrack | Seek to the first key point on the previous track and start |
| | playing the object the key point marks |

The event objects or events are another kind of non-displayable objects supported in the web case 30 of the present invention. During the playing process of a web case 30, the event objects are responsible for realizing the interactive relationships in between web objects contained in the web case 30. In general, an event comprises four elements: the triggering object, the triggering condition, the target object, and the target function, and when a web case 30 is being played, the satisfying of the triggering condition of the triggering object will result in the target object to perform the target function. In other words, an event is triggered when the triggering condition of the triggering object corresponding to the event is satisfied, and when an event is triggered, the target function of the target object corresponding to the event will be performed.

The triggering object and the target object can be displayable or non displayable within a web case 30, while they can also be the same web object. For example, the clicking of one image object will result in the disappearing of the same image object.

The triggering condition is the event that happens to the triggering object during the playing process of a web case 30, and the happening or satisfying of the triggering condition will cause the target object to perform the target function, or “trigger” the target function of the target object. For example, a triggering condition might be the clicking on the triggering object by the mouse, or striking of certain keys on the keyboard. There might be multiple triggering conditions that can be set for one type of web objects, and different type of web objects usually have different sets of triggering conditions. A Detailed example of the triggering conditions for different type of web objects will be given in the attached user handbook.

The target function is the function or behavior the target object will perform during the playing process of a web case 30 when the triggering condition of triggering object is satisfied. The target function can be any kind of functions defined for the target object, and different types of target objects might have different types of target functions. It is noteworthy that for some of the triggering functions, parameter values need to be specified by users, for example, with the “set properties” function, certain properties will be realized with the target object when the target function is triggered, thus the parameter values of the properties need to be specified with the target function.

In a web case 30, it is possible that one triggering object of an event has multiple triggering conditions to correspond with one or multiple target functions of one or multiple target objects. For example, during the playing process of a web case 30, either the clicking or double clicking on an image object will result in an audio object to stop playing, and in the same time, result in a video object to become visible, and start playing.

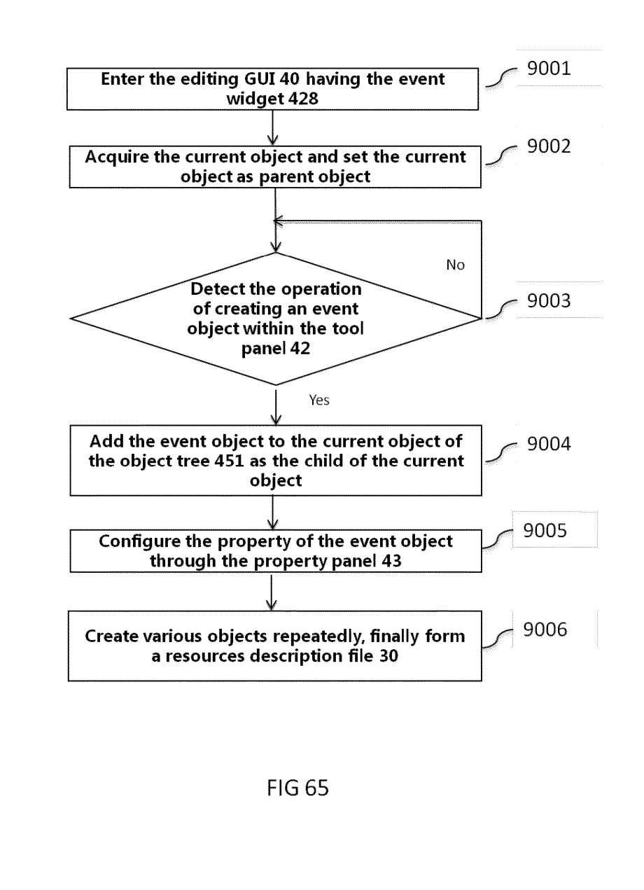

In order to introduce an event in a web case 30, an event object needs to be first created through the editing engine 10. The process of creating an event object is shown in FIG. 65, according to a preferred embodiment of the present invention. In step 9001, an editing engine 10 is loaded and an editing GUI 40 is displayed, wherein there is a widget to create an event object in the tool panel 42 of the editing GUI 40. In the step 9002 editing engine 10 acquires the current object among all web objects within the web case 30 currently edited by the editing engine 10, which will be set as the parent object of any newly created web objects. (The current object was explained in more detail in the section dedicated to the object tree) In the step 9003, the GUI module of the editing engine 10 detects whether there are user operations on the event widget on the tool panel 42 to create an event object, if yes, the next step 9004 will be taken, if not, the editing engine 10 continues to wait for operations on the event widget. In the next step 9004, the event object is added into the web case 30 as a child object of the current object, while it is preferred that within in the object tree 451, a node representing the newly created event object will be added as a child node of the node corresponding to the current node. In the step 9005, the properties of the event object created are configured through the property panel 43 corresponding to the event object (Details about configurations of the properties of an event object will be illustrated soon in this disclosure). After various web objects are created and configured within the web case 30 (step 9006), a RDF 32 (resource description file) will then be generated, preferably through the RDF 32 generation module of the editing engine 10.

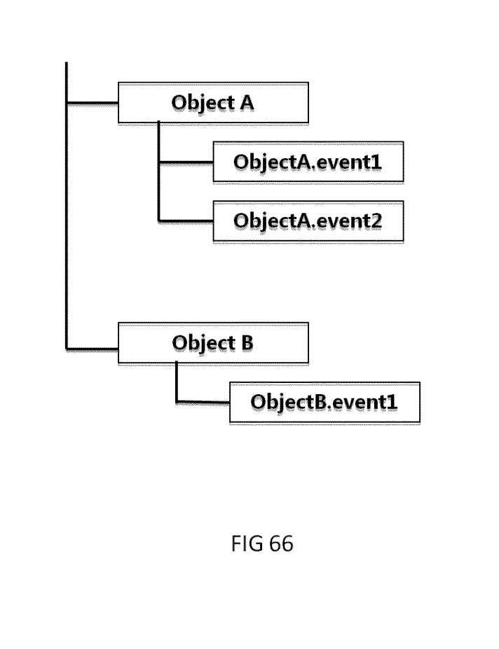

For each event object, the triggering object, the triggering condition, the target object, and the target function need to be specified by the editing engine 10 in order for the event object to function in the playing process of a web case 30. With the editing engine 10, there are various ways that users might set the four elements of an event object, after the event object is created, and in preferred embodiments of the present invention, users are capable of setting the four elements through the editing GUI 40. In one embodiment, the triggering object is set through the parent-child relationships of the web objects within a web case 30, while the parent object of an event object is automatically set to be the triggering object of the event. As shown in FIG. 66, the parent-child relationships of the web objects are illustrated in an object tree, while there are three event objects, Object A.event1, Object A.event2 and Object B.event1. The event objects Object A.event1 and Object A.event2 both have object A as the parent object, thus, object A is the triggering object of both Object A.event1 and Object A.event2, in other words, object A has two events “attached” to it. Similarly, object B is the triggering object of the event Object B. event1.

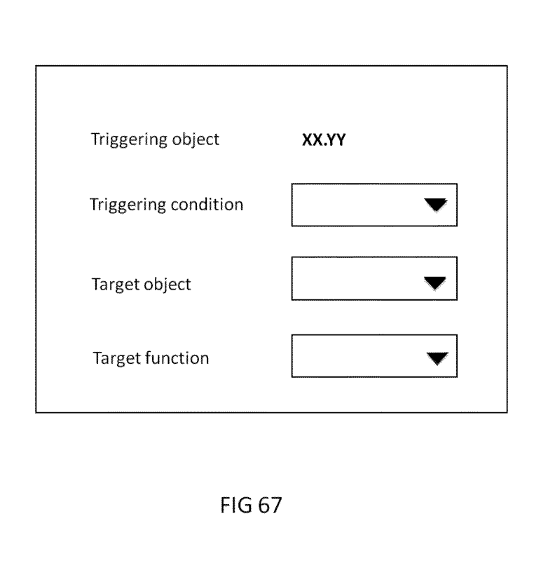

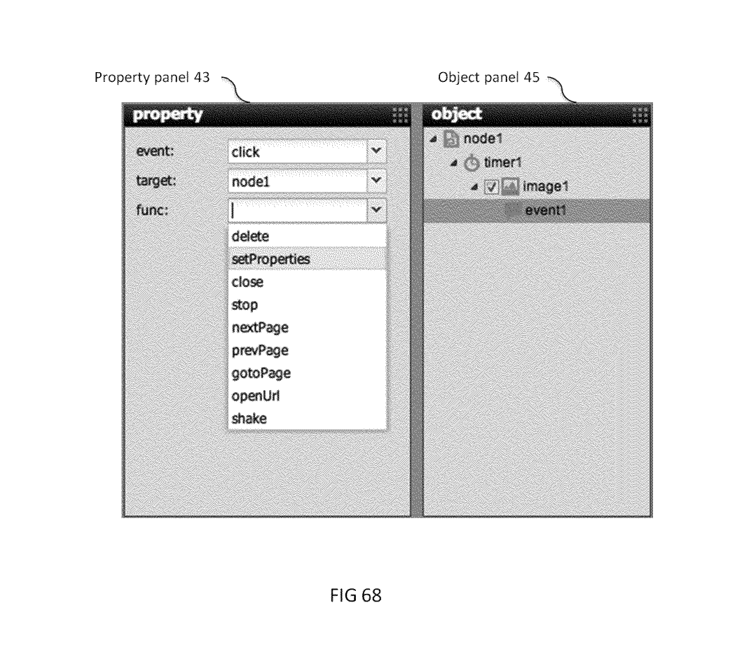

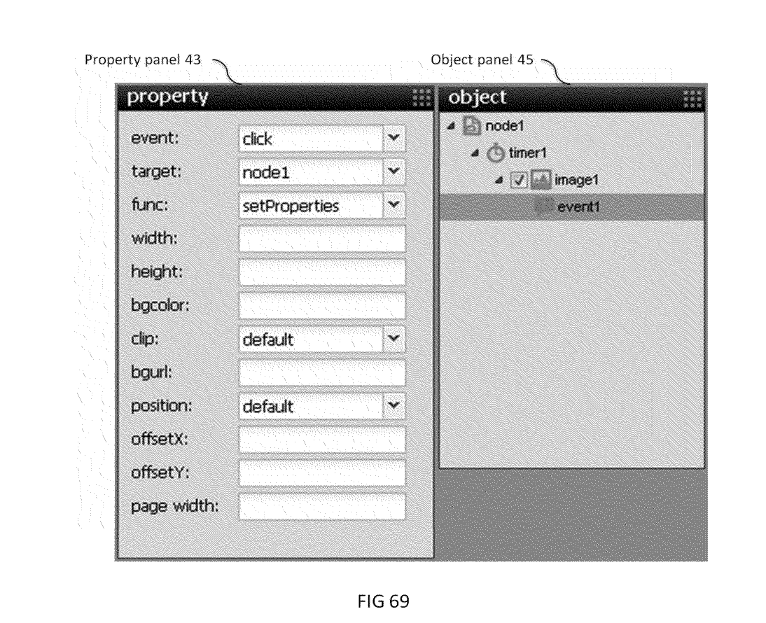

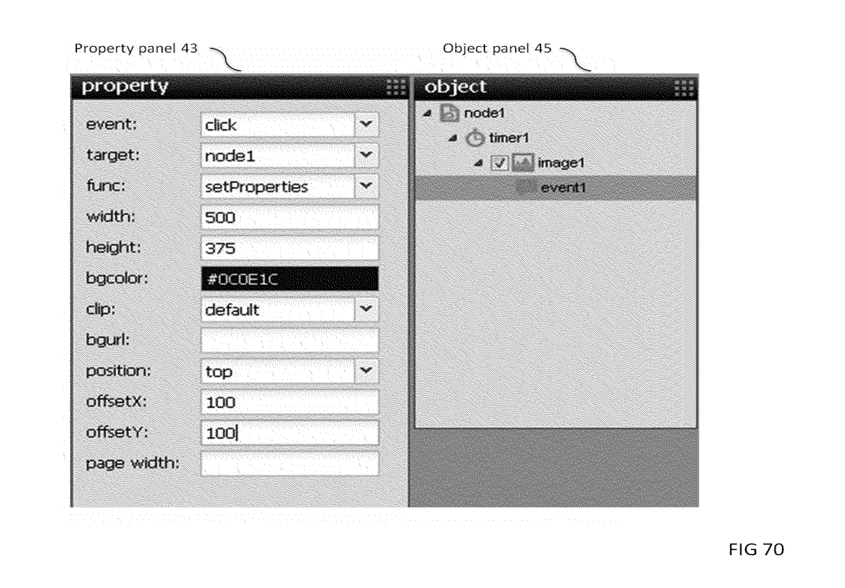

After the triggering object of an event is determined, the other three elements may be set in the property panel 43 corresponding to the event object. As shown in FIG. 67, according to one embodiment of the present invention, the other three elements of an event might be set in the property panel 43 of the event object, which has dropdown menus for users to select the triggering condition, target object and target function from a set of available choices. FIG. 68 shows a more detailed example of this case. As indicated by the object tree, the web object event1 is an event object with the triggering object of image1 (which is its parent object), while image1 is the child object of the timer object timer1, which is the child object of another web object node1 (node 1 is also the root node in this example). When the event object event1 is selected (usually through selecting the node representing event1), the property panel 43 corresponding to event1 will be displayed, wherein the triggering condition (titled as “event” in this example), the target object (titled as “target”), and the target function (title as “func”) can be set from the dropdown menus. The property panel 43 shows that the triggering condition is set to be “click”, the target object is set to be “node 1”, which is the editing stage 44 (it is preferred that the root node always represents the editing stage in this embodiment), and the target function is being selected as “set properties”. The “set properties” function will result in the target object to show certain preset properties when the function is triggered during the playing process of the web case 30, thus the “preset properties” to be shown will need to be specified with the “set properties” function. In a preferred embodiment as shown in FIG. 69, when the “set properties” function or other functions that need to be specified with additional parameter values is selected, all property parameter 431 with data fields corresponding to the target object node1 will be shown in the property panel 43, and the parameter values might be filled within the data fields. As further shown in FIG. 70, the properties of node1 is set to have the width of 500, the height of 375, the background color of black, the position at the top, and both offset X and offset Y as 100, thus, when the web case 30 is being played, the click on image1 will result in the editing stage 44 to show the above specified properties.

It is noted that the above-illustrated method is only one embodiment of the ways to specify the four elements of an event object, while other approaches might also be taken for achieving the same goals. For example, it can be set with the editing engine 10 that the parent object of an event object automatically becomes the target object of the event, while the triggering object, triggering condition and the target function is specified through the property panel 43 of the event object; or, all four elements of the event object are specified through the property panel 43.

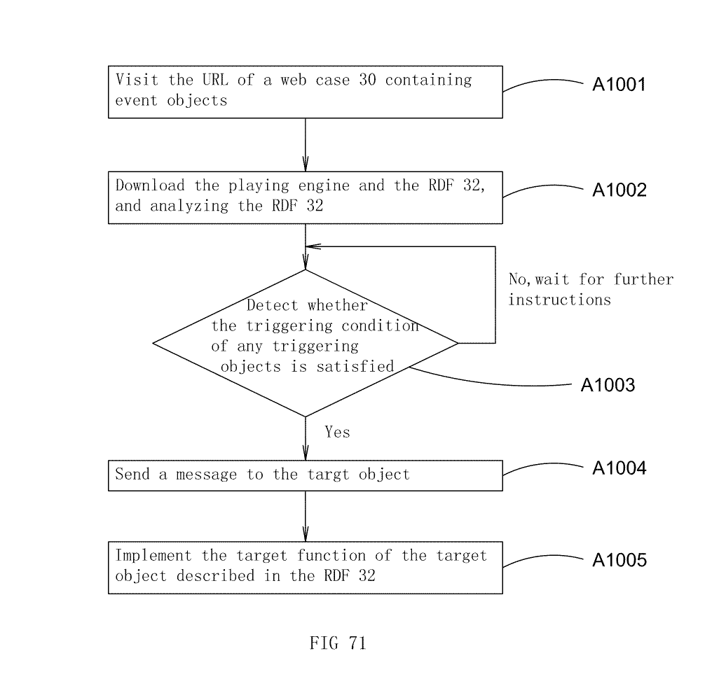

The working process of an event object during the playing process of a web case 30 is shown in FIG. 71 according to a preferred embodiment of the present invention. First, the URL of a web case 30 containing event objects is visited by a web browser 34 (step A1001), and the playing engine 20 and the RDF 32 corresponding to the web case 30 is automatically downloaded (Step A1002) The playing engine 20 will then be loaded, after which it analyzes the RDF 32 to obtain instructions to download resource files 31 and play the web case 30 according to the RDF 32 (step A1002). Then, the playing engine 20 will detect whether any event object contained in the web case 30 is triggered (step A1003), i.e. whether the triggering conditions of the triggering objects of any of the event objects is satisfied, if yes, the next step A1004 will be taken, if not, the editing engine 10 continues to wait for the triggering of an event object. In the next step A1004, the editing engine 10 sends a message to the target object of the triggered event, and in the step A1005, the target function of the target object specified within the RDF 32 is performed.

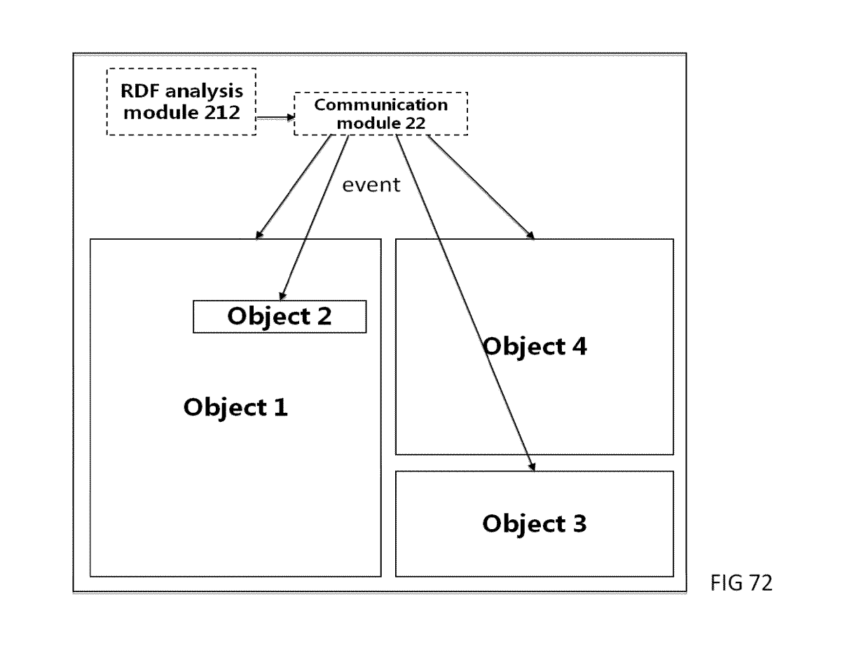

In a preferred embodiment, the above working process of an event object involves the participation of the communication module 22 of the playing engine 20. As shown in FIG. 72, the communication module 22 first obtain the information of all event objects contained in the web case 30 to be played from the RDF 32 analysis module 212, which is capable of analyzing the RDF 32 downloaded with the playing engine 20. After all the information about the event objects is obtained, the communication module 22 then receives information regarding the playing statuses/conditions of all web objects, either from the web objects themselves, or from an independent listening module (not shown) that listens certain playing statuses/conditions from all web objects in the web case 30. Then, the communication module 22 matches the playing statuses/conditions information received with the information about the triggering objects and triggering condition obtained from the RDF 32 analysis engine, and if a triggering condition of a triggering object is matched with a playing status/condition received, the communication engine will send a message immediately to the target object corresponding to the triggered event, instructing the target object to perform the target function.

A screen object or a screen is one of the container objects in the web case 30 of the present invention. According to a preferred embodiment, the container objects include the screen object, the page objects and the layer objects, which are non-displayable objects that define the display range of other objects. During the playing process of a web case 30, the page objects and the layer objects both function within one web browser 34, which define “pages” and “layers” of the web objects being played within the web browser 34. In contrast, the screen object is capable of functioning in between different web browsers, either within the same client device, or different client devices. When there are multiple screen objects within a web case 30, other non-screen web objects are divided into groups according to the screen object they belong to , and in a preferred embodiment, the web objects that belong to a screen object are set as the child objects of the screen object. Different groups of web objects will thus be played in different web browsers 34 or “screens” during the playing process of the web case 30, while interactive relationships still apply within web objects belong to different screens. Thereby, the screen objects make possible the cross-browser and cross-device interactions of web objects, for example, the click on an image object displayed within a browser of one client device will result in a video object displayed in a browser of another device to start playing.

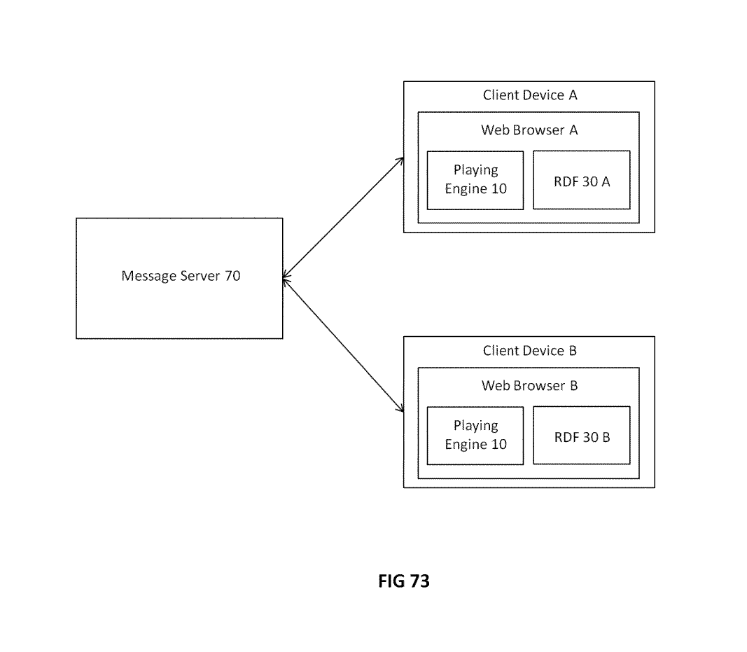

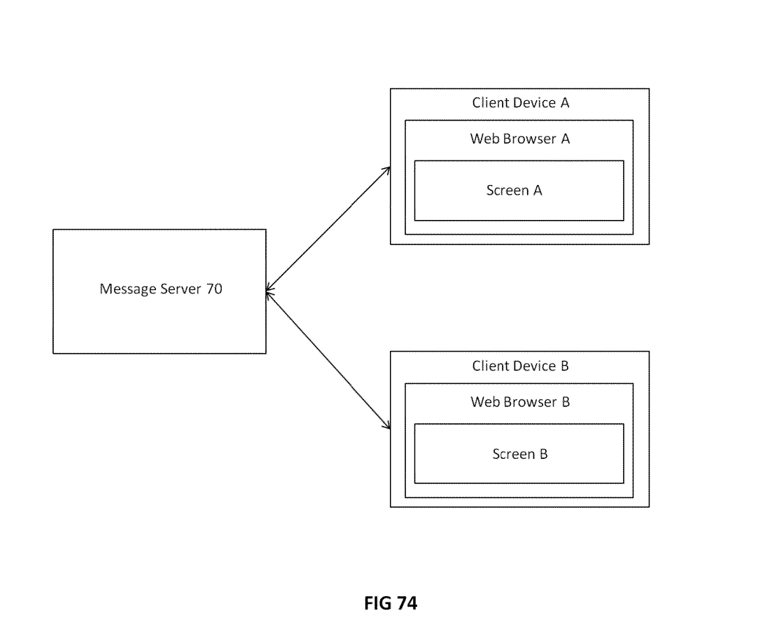

FIG. 73 shows the playing system for realizing the functions of screen objects according to a preferred embodiment of the present invention. The system comprises a message server 70, and two client devices (client device A and client device B) with two web browsers (web browser A and web browser B) to display two screens (not shown in FIG. 73) within a web case 30. After a web case 30 with two screen objects (screen A and screen B, not shown in FIG. 73) are created, the editing engine 10 of the web case 30 will generate two separate RDFs, RDF A and RDF B, respectively describing the playing process of the web objects contained in screen A and screen B (not shown in FIG. 73), in the meantime, two separate sharing codes (sharing code A and sharing code B, not shown in FIG. 73) are generated for each of the two screens, indicating the addresses to download the playing engine 20 and the corresponding RDF (sharing codeA for downloading RDFA, and sharing codeB for downloading RDF B). Then, the web browser A and web browser B respectively visits two webpages with the sharing codes embedded, for example, web browser A visits a webpage with sharing code A instructing to download RDF A, and web browser B visits a webpage with sharing code B instructing to download RDF B. The web browser A will then download the playing engine 20 and RDF A, and the web browser B will download the playing engine 20 and RDF B. It is worth mentioning that the playing engine 20 is the same for both of the browsers. Then, the two browsers both install the playing engine 20 and use the playing engine 20 to play the web case 30 according to the RDFs downloaded. Thus, with RDF A, web browser A will play the web objects contained in screen A, while web browser B will play the web objects within screen B, as shown in FIG. 74. The interactions in between web objects across the two screens are completed by the message server 70. After the sharing codes embedded in the webpages are analyzed by the web browser A and web browser B, the two web browsers respectively sends a message to the message server 70 to register the information of the browsers/screens with the message server 70. When cross-browsers interactions of web objects happens, the communication modules (not shown) in the playing engine 20s of both of the web browsers will work together with the message server 70 to complete the interaction task. For example, when an event object in the web case 30 being played has a triggering object in screen A, and a target object in screen B, then when the triggering condition of the trigger object is satisfied, the communication module (not shown) of the playing engine 20 in browser A will send a message to the message server 70 indicating that the target function of the target object in screen B shall be performed. The message is then forwarded by the message server to the communication module (not shown) of the playing engine 20 in web browser B, which will instruct the target object to perform the target function. This process is similar to the process of web objects interaction during the playing process of a web case 30 within the same screen/browser, except that with the interaction process within the same browser, the communication module of the playing engine 20 will directly send instructions to the target object of an event after the event is triggered, without the need for an intermediary as the message server 70.

For web cases containing more than two screen objects, the playing system are similar to the case illustrated above, except that there will be more client devices and web browsers corresponding to the number of screen objects contained in a web case 30.

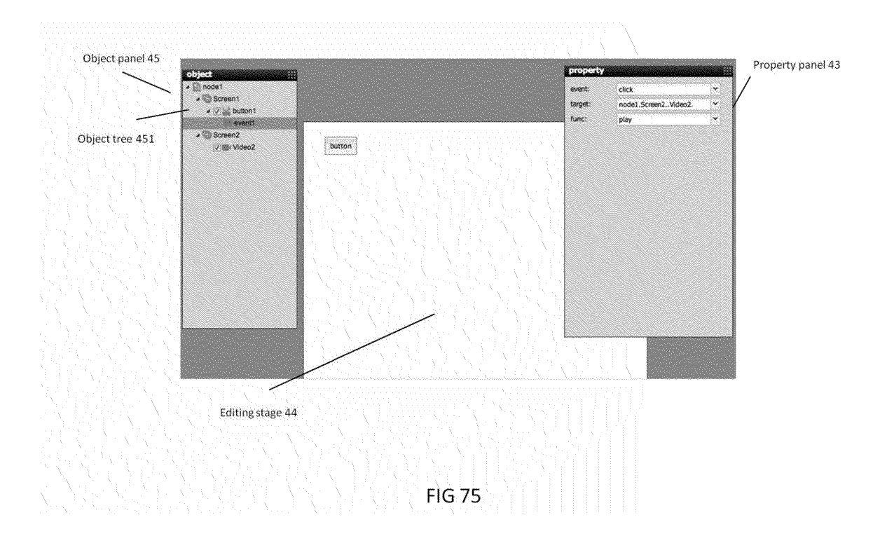

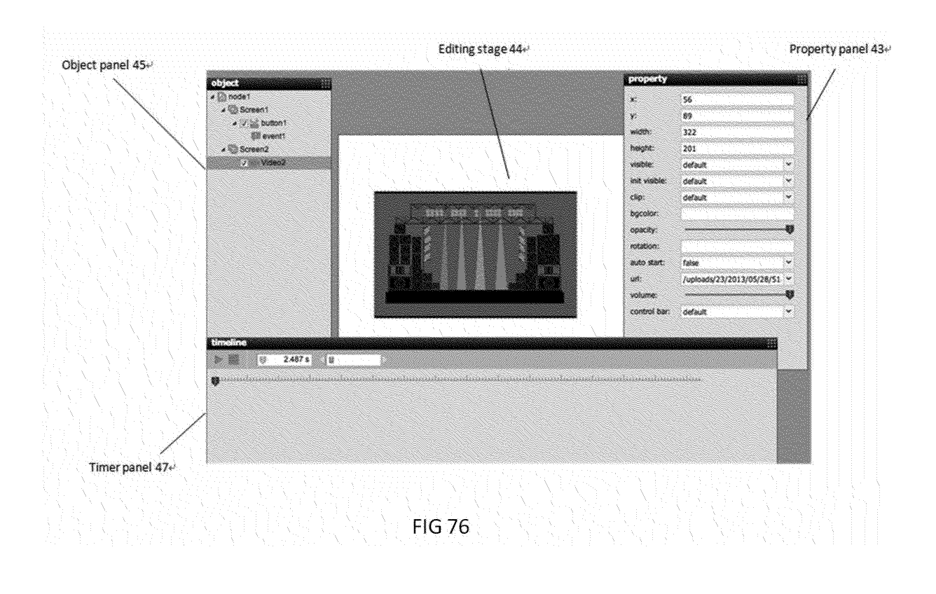

A more detailed example is illustrated in FIG. 75 and FIG. 76, which show a web case 30 with two screens, screen1 and screen 2. As illustrated in the object tree shown in FIG. 75, there are two screen objects, “screen 1” and “screen 2”, under the object “node 1” (which is the root node). The object “screen 1” has a child object “button 1”, which is an image object shown as a button, while the object “button 1” further has a child object “event 1”, whose property panel 43 is shown in FIG. 75; The object “screen 2” also has a child object “video 2”, which is a video object shown in FIG. 76. As specified in the event section of this disclosure, in a preferred embodiment, the parent object of an event object is set to be the triggering object of the event, thus, “button 1” is the triggering object of “event 1”, and the triggering condition, the target object and the target function of “event 1” are specified with the property panel 43. The property panel 43 in FIG. 75 further shows that the triggering condition is set to be “click”, the target object is the object “video 2” under “screen 2” of “node 1”, while the target function is “play”, which will cause a video object to start playing. Referring now to FIG. 76, which shows the property panel 43 of the object “video 2”, note that with the property parameter 431 “auto start”, parameter value is set as “false”, which means that the video object is not going to play automatically when the web case 30 is loaded. Thus, when the web case 30 shown in FIG. 75 and FIG. 76 is being played, two web browsers will respectively load screen 1 which shows the button, and screen 2 which shows a video paused at the start point, and when the button object in screen 1 is being clicked, the video object in screen 2 will start playing. The two web browsers can run on the same client device or different client devices.

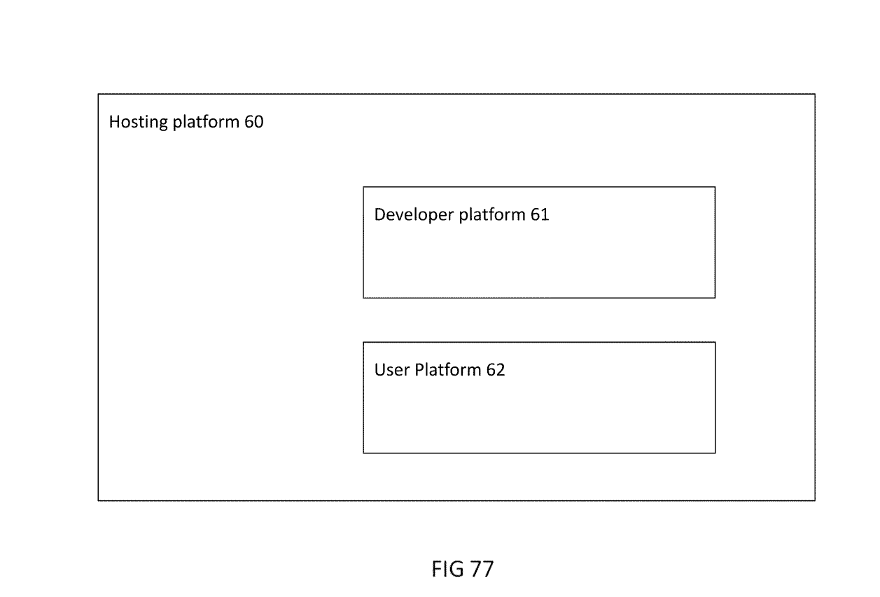

The editing and playing system of the web cases in the present invention further makes possible a new business method. As shown in FIG. 77, the hosting platform 60 of the editing engine might further comprise a developer platform 61 and a user platform 62. The developer platform 61 provides APIs (Application Programming Interface) for public developers to create web applications or widgets on the basis of the core system of the editing engine of the present invention. The user platform 62 provides a widget-selecting interface 621 for users to select applications on the developer platform 61, and a widget usage environment 622 to run the selected applications. It is preferred that all the applications provided in the developer platform 61 are web applications that can be accessed remotely over the Internet through a web browser, and the widgets usage environment 622 provides the basis for running these web applications.

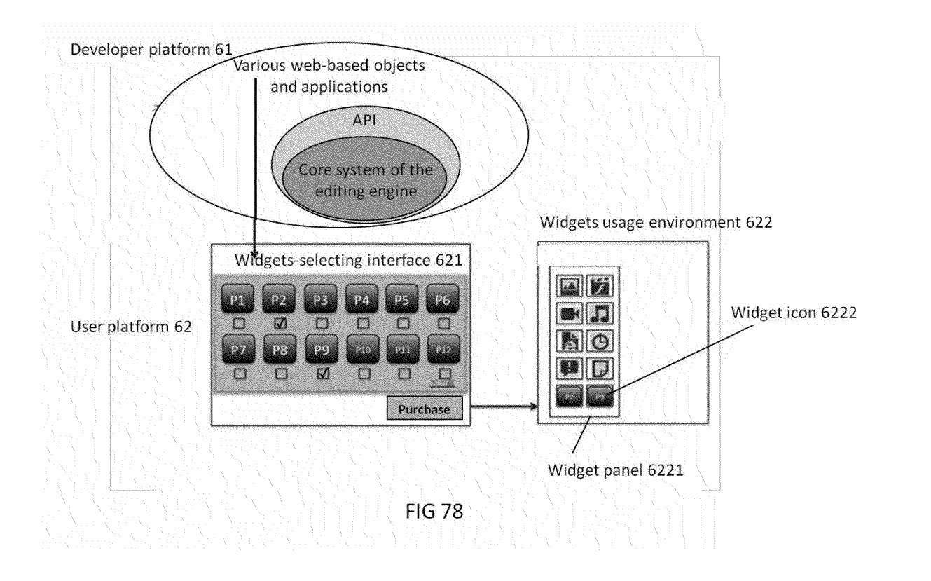

The application developed in the developer platform 61 might be of various types, for example, a developer might provide a new editing tool for creating a new type of web object, or a game application that might be loaded on widget usage environment, or even a widget for managing communications of web objects between different terminals. For all types of applications developed in the developer platform 61, they will be displayed on the widget-selecting interface 621 on the user platform 62, and once a user logon into account in the user platform 62, he/she is able to pick desired applications in the widget-selecting interface 621, either for free or with a certain usage fee. Then the selected application will be shown in the widget panel 6221 with a widget icon 6222, and once the user activates a widget (for example, through click on the corresponding icon or through certain key strokes on the keyboard), the activated widget will be loaded in the widget usage environment 622 for using. In the example shown in FIG. 78, the user picks the widgets P2 and P9 in the widgets-selecting interface 621, and then the widgets P2 and P9 will be shown in the widget panel 6221 as two widget icons 6222 in the widget usage environment 622.

In the user platform 62, every user has a user ID, which corresponds to a unique user account, while each user account further corresponds to a set of selected applications. When there are fees involved in the usage of certain applications, users need pay for the applications they choose to use, and the payment will be shared in between the application developer and the provider of the hosting platform 60.

It is noteworthy that the widget panel 6221 in the widgets usage environment 622 is similar to the tool panel 42 in the editing engine 10 as illustrated previously. The widgets usage environment 622 can be understood as an upgraded version of the editing engine 10, the widgets usage environment 622 provides additional functions other than web case/web object editing on the basis of the editing engine 10, while the applications/widgets developed on the developer platform 61 are analogous to the editing widgets/tools in the tool panel 42. The applications/widgets developed on the developer platform 61 can be some kind of editing tools, or other kinds of applications such as games. Thus, the widgets usage environment 622 enlarges the usage range of the editing engine 10, opens the programming of the editing engine 10 to public developers, while still remains the basic structure of the editing engine 10, i.e. all applications are developed on the basis of the core system of the editing engine, run in a specific environment, the editing engine environment or the widgets usage environment 622, and displayed as widget icons 6222 on a widget panel 6221. In addition, the core system of the editing engine might be modified for better accommodating the needs of developing new types of applications. The widget panel 6221 does not have to be shown as a panel; rather, it can have various and forms when displayed, such as menu.

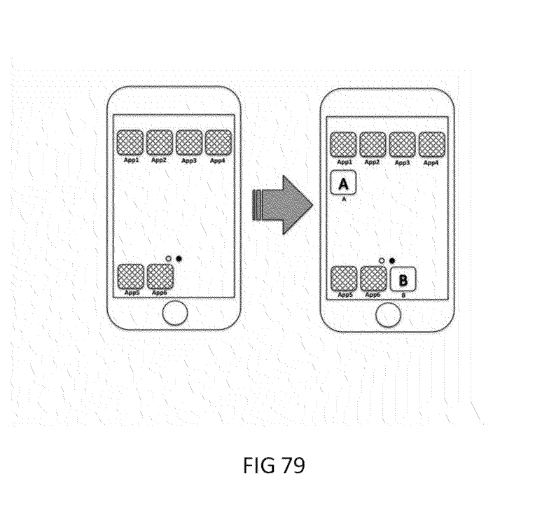

Referring to FIG. 79 and FIG. 48, the engine 10 is capable of generating an application (APP) for mobile devices. The editor engine 10 first generates a web case that can be visited through a certain URL, and then a corresponding APP in a smart mobile device (such as a smart phone, a tablet PC and etc.) is created, and once the APP is activated, it automatically opens a web browser and visits the URL of the previously generated web case. Thus, an APP for a smart mobile device can be generated through the editing engine 10 of the present invention without the need for programming on the basis of the operation system of the smart mobile devices (such as the ios and Android system). For example, as shown in FIG. 79, the APP A and APP B are two applications that automatically visit certain URLs to open pre-designed web cases once activated, and the two APPs show in the GUI of the smart phone with two APP icons “A” and “B”, just as other traditional applications, such as APP1, APP2 and etc. The APPs that links to a web case of the present invention will be referred to as the web case APPs here after.

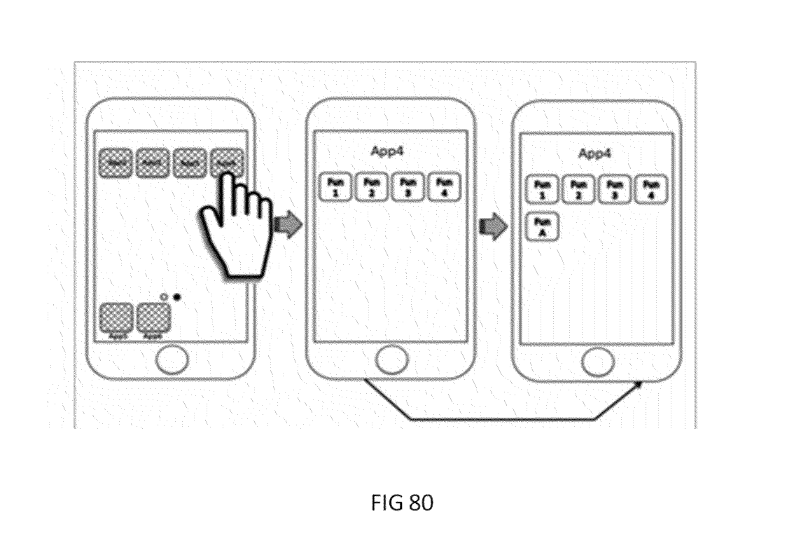

The web case APPs of the present invention can be displayed directly on the GUI of the mobile devices, or be encapsulated into a mother APP, and when the mother APP is opened/activated, the web case APPs encapsulated within the mother APP will be shown. The web case APPs encapsulated in a mother APP will be referred to as the child web case APPs of the mother APP. As shown in FIG. 80, the “APP 4” is the mother APP of the web case APPs “Fun1”, “Fun2”, “Fun 3” and “Fun 4”, and when “APP 4” is activated, the child web case APPs “Fun1”, “Fun2”, “Fun 3” and “Fun 4” will be shown. If a web case APP “FunA” is further generated, then “FunA” can be added under the mother APP “APP 4”, as shown in FIG. 80.

A mother APP acts as the “file folder” of all the web case APPs it holds, and the mother APP of the present invention further provides the function of dynamic synchronizing of child web case APPs First, every mother APP installed on a smart mobile device corresponds to a user account on a remote APP server, the APP server can be the editing server of the present invention, or any other dedicated servers that provides the functions as specified below. The APP server stores the information of the child web case APPs of every mother APP in the corresponding user account, and keeps the child web case APPs run in the mother APP on the mobile device synchronized with the child web case APP information in the corresponding user account. Every user will have a unique user account, and the user account is capable of being visited by the user who owns the account, to manage the child web case APPs to be installed under the mother APP on a smart mobile device. A user is able to add or delete certain child web case APPs in the user account, and the changes made in the user account will be synchronized automatically with the mother APP on the smart mobile device.

A mother APP on a smart mobile device is also capable of downloading and deleting child web case APPs automatically without user operations under instructions of the APP server. For example, when a user with a mother APP installed on a smart mobile device enters a certain restaurant, the mother APP sends message of the location of the smart mobile device to the APP server, the APP server can be set with the mother APP to sends the location information every certain time interval, and the location information can be obtained from the location modules as the GPS module of the smart mobile device, and the APP server recognizes that the location is of the certain restaurant, thus the APP server automatically adds a child web case APP with functions corresponding to the certain restaurant to the user account of the user, and thus the mother APP on the smart mobile device of the user automatically synchronizes with the user account and downloads the child web case APP of the certain restaurant. Similarly, when the user leave the restaurant, the child web case APP of the certain restaurant will be deleted automatically once the mother APP sends a location message to the APP server indicating that the user has left the restaurant and the APP server delete the child web case APP of the restaurant in the user account. There are various ways that the APP server might be triggered to automatically add or delete child web case APPs for a mother APP is a user account, besides the change of the location of the smart mobile device, for example, the APP server might add a “Christmas” child web case APP every Christmas vacation to provide certain Christmas services, and delete the “Christmas” child web case APP once the Christmas vacation is over.

It is noteworthy that there might be multiple mother APPs under one user account, and the user is capable of managing the child web case APPs in all of the mother APPs.

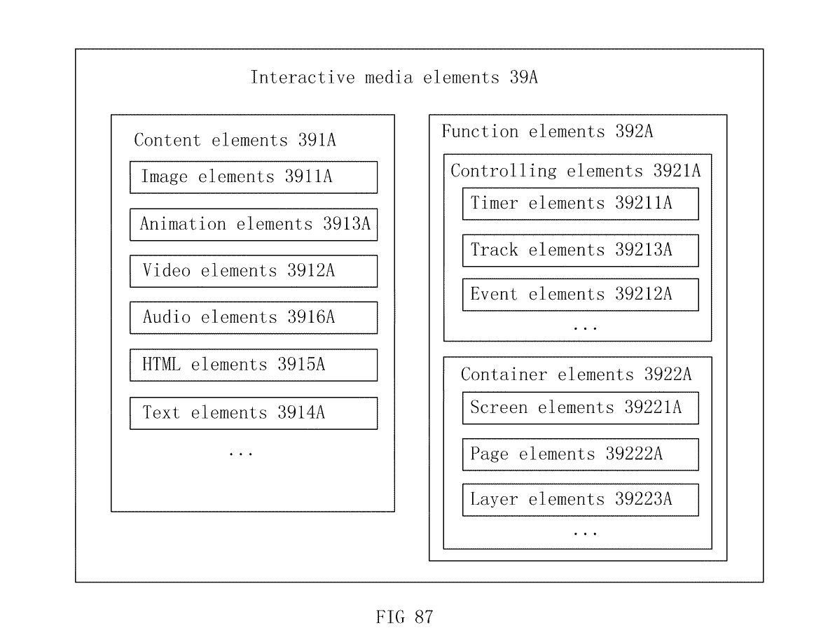

Referring to FIG. 87, a media editing and playing system of the preferred embodiment of the present invention is illustrated. The media editing and playing system provides a media structure. The Media structure is VXPLO media 30A. The VXPLO media 30A comprises at least one interactive media element 39A. The interactive media element 39A has a plurality of properties, and each type of interactive media element 39A has a unique set of properties. Through configuring the properties of each of interactive media element 39A, the interactive relationships between the interactive media elements 39A are created. The VXPLO media 30A further comprises a recorder 32A for recording the properties and the interactive relationships of the interactive media elements 39A. The interactive media element 39A further comprises two categories, which is the content element 391A and the function element 392A. The content element 391A carries media content. The function element 392A manages the playing process and the interactive relationships between the content elements 391A. The content element 391A can be various elements, such as image elements 3911A, video elements 3912A, animation elements 3913A, text elements 3914A and html elements 3915A. The function element 392A can be a controlling element 3921A for controlling the playing process and the interactive relationship between the content elements 391A or be. a container element 3922A for defining the display range of and grouping the content element 3921A. The controlling element 3921A can also be a timer element 39211A for controlling playing process of an interactive media element 39A through a period of time. The controlling element 3921A can also be an event element 39212A for realizing the interactive relationships in between the interactive media element 39A in the VXPLO media. The controlling element 3921A can further be a track element 39213A for associating with the timer element 39211A to define the property changing process of other interactive media elements. The container element 3922A can be a screen element 39221A, a page element 39222A or a layer element 39223A. The VXPLO media 30A work as an integrated media where the content elements 391A interacting with each other.

Preferably, the VXPLO media 30A is a web case 30. Preferably, the content element 391A is a displayable object. Preferably, the function element 392A is a non-displayable object. Preferably, the image element 3911A is an image object 391. Preferably, the video element 3912A is a video object. Preferably, the animation element 3913A is an animation object. Preferably, the text element 3914A is a text object. Preferably, the html elements 3915A is html object. Preferably, the controlling element 3921A is a controlling object. Preferably, the container element 3922A is a container object. Preferably, the timer element 39211A is timer object. Preferably, the event element 39212A is an event object. Preferably, the track element 39213A is a track object. Preferably, the screen element 39221A is a screen object. Preferably, the page element 39222A is a page objet. Preferably, the layer element 39223A is a layer object. Preferably, the recorder 32A is a RDF 32 (resource description file). The editing engine 10 and/or the playing engine 20 is capable of being loaded and played on a carrier 34A. Preferably, the carrier 34A is a web browser 34.

The editing engine 10 is capable of editing the VXPLO media 30A. When the resource file 31 is input, the editing engine 10 identifies the type of the resource file 31, and then the editing engine 10 creates the content element 391A according to the type of the resource file 31. The content element 391A is capable of being edited by the editing engine 10. For example, an image file is input to the editing engine 10. The editing engine 10 identifies the type of the resource file 31 is the image file, and then the editing engine 10 creates the image element 3911A according to the image file, so that the editing engine is capable of editing the properties of the image element 3911A. The editing engine 10 is capable of creating the controlling element 3921A for controlling the image element 3911A. Through editing the properties of the controlling element 3921A for controlling the image element 3911A. After the editing process is finished, the editing engine 10 generates the recorder 32A for recording the properties of the interactive media elements 39A. It is worth mentioning that the recorder 32A records the location or URL for acquiring the resource file 31. It is worth mentioning that the editing engine 10 generates an indicator 35A for sharing the VXPLO media 30A. Preferably, the indicator 35 is the sharing code 35. The indicator 35A is capable of instructing the web browser to acquire the recorder 32A and the resource file 31A.

It is worth mentioning that displaying properties of a content element 391A include, but are not limited to one or multiple items of the following: a URL that specifies the location of a resource file of the content element 391A, the position of the content element 391A, the width of the content element 391A, the height of the content element 391A, the background color of the content element 391A, the opacity of the content element 391A, the rotation angle of the content element 391A, the visibility of the content element 391A, the text of the content element 391A, the font of the content element 391A, the fill color of the content element 391A, the line width of the content element 391A, and the line color of the content element 391A.

It is worth mentioning that displaying properties of a displayable object 391 include, but are not limited to one or multiple items of the following: a URL that specifies the location of a resource file of the displayable object 391, the position of the displayable object 391, the width of the displayable object 391, the height of the displayable object 391, the background color of the displayable object 391, the opacity of the displayable object 391, the rotation angle of the displayable object 391, the visibility of the displayable object 391, the text of the displayable object 391, the font of the displayable object 391, the fill color of the displayable object 391, the line width of the displayable object 391, and the line color of the displayable object 391.

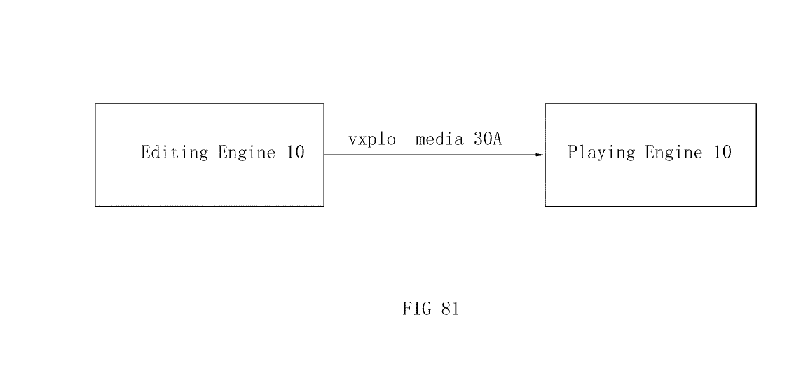

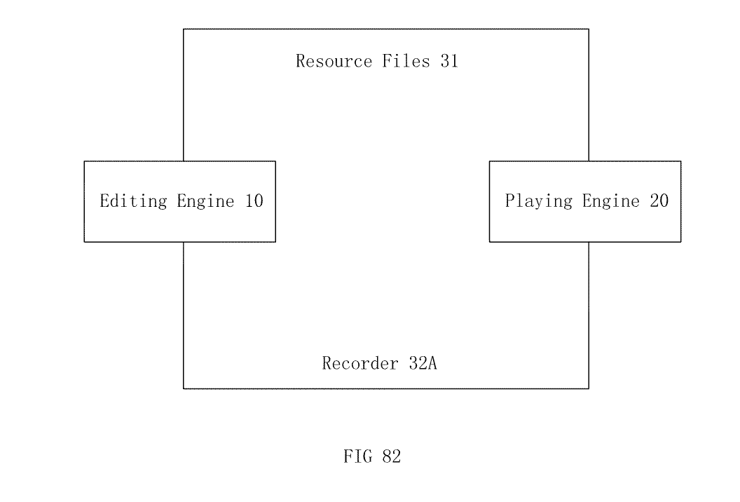

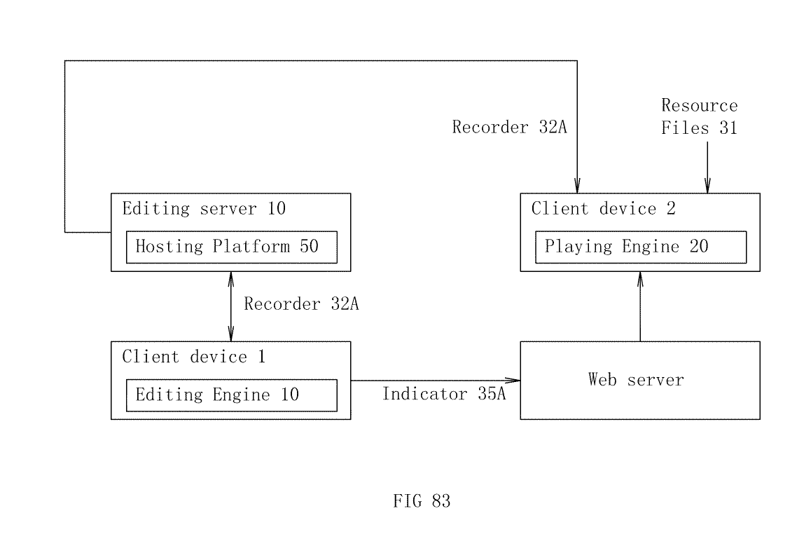

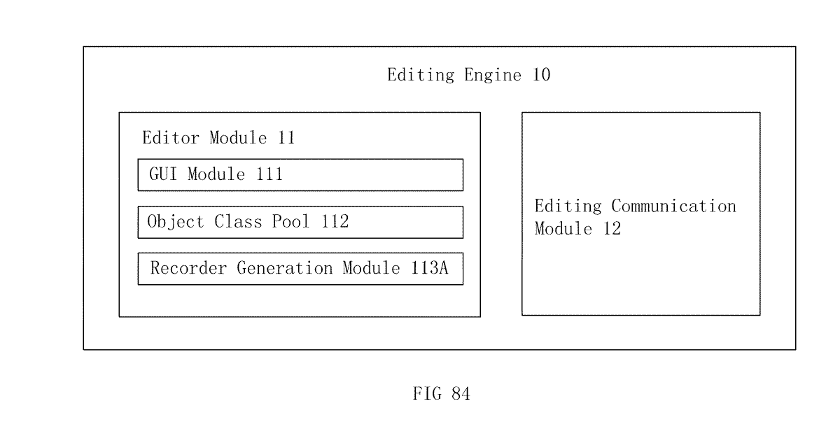

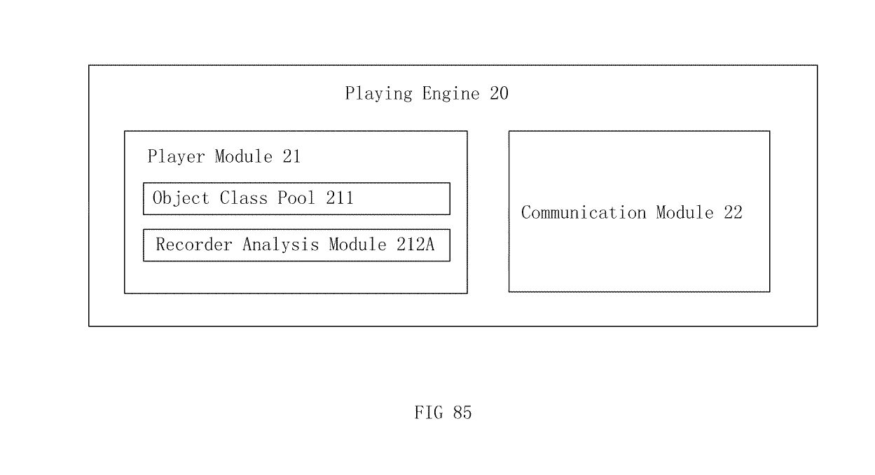

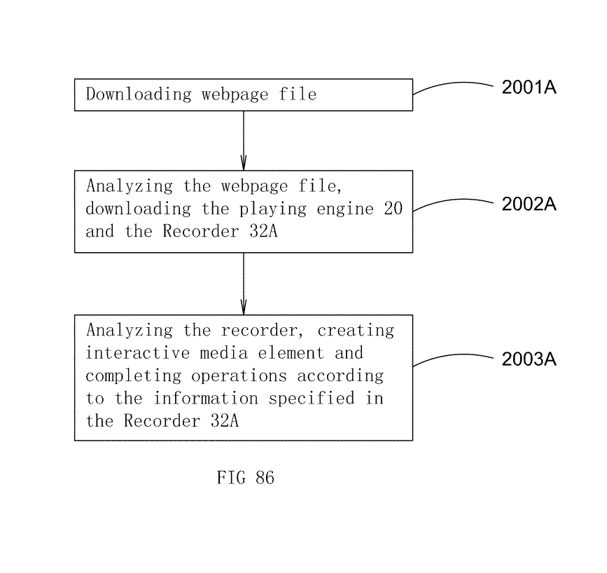

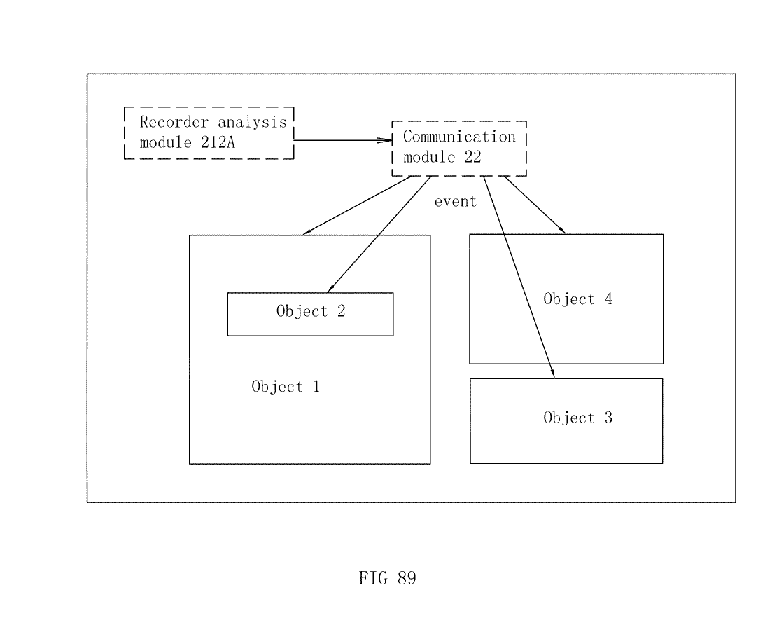

As shown in FIG. 81˜FIG. 89, the Media editing and playing system of the present invention comprises an editing engine 10 and a playing engine 20. The editing engine 10 edits the VXPLO media, and the playing engine 20 plays the VXPLO media. The editing engine 10 edits the resource files 31, and generates a recorder 32A. The editing engine 20 further generating an indicator for indicating to acquire the playing engine 20 and the recorder 32A. The playing engine 20 acquires the recorder 32A, and analyzes the recorder 32A for acquiring the resource files 31.

The editing module 11 of the editing engine 10 has an alternative module, a recorder generation module 113A for generating the recorder. The player module 21 of the playing module has an alternative module, a recorder analysis module 212 for analyzing the recorder 32A. The VXPLO media 30A is capable of being embedded into the webpage. After the webpage file is download (step 2001A), and then analyzing the webpage file for downloading the playing engine 20 and the recorder 32A (step 2002A). After the playing engine 20 and the recorder 32A is downloaded, the playing engine 20 analyzes the recorder 32A for creating the interactive media element 39A and completing operations according to the information of the recorder 32A(step 2003A).

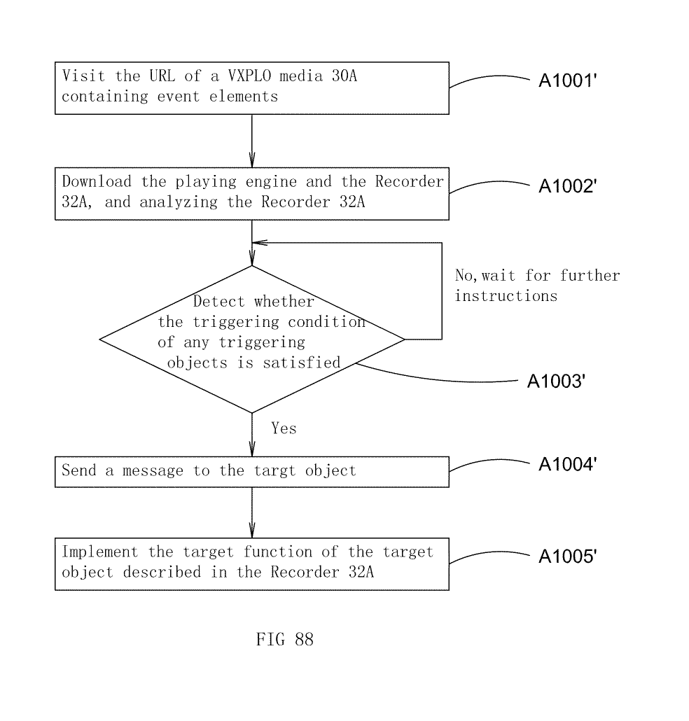

Referring to FIG. 88, the working process of event elements according to the preferred embodiment of the present invention is illustrated. The working process of event elements comprises the steps of:

Step A1001′: Visit the URL of a VXPLO media 30A containing event elements.

Step A1002′: Download the playing engine and the recorder 32A, and analyzing the recorder 32A.

Step: A1003′: Detect whether the triggering condition of any triggering objects is satisfied? If the triggering condition is satisfied, then implement step A1004′. Otherwise, wait for further instructions.

Step: A1004′: Send a message to the target object.

Step: A1005′: Implement the target function of the target object described in the recorder 32A.

As shown in FIG. 89, the communication module 22 of the playing engine 220 first obtain the information of the event elements 39212A contained in the VXPLO media 30A to be played from the recorder 32 analysis module 212, which is capable of analyzing the RDF 32 acquired with the playing engine 20. After all the information about the event objects is obtained, the communication module 22 then receives information regarding the playing statuses/conditions of the interactive media element 39A, either from the interactive media elements themselves, or from an independent listening module (not shown) that listens playing statuses/conditions from the interactive media elements in the VXPLO media 30A. The communication module 22 matches the playing statues/conditions information received with the information about the triggering objects and triggering condition obtained from the recorder 32A analysis module 212A, and if a triggering condition of a triggering object is matched with a playing status/condition received, the communication module 22 sends a message immediately to the target object corresponding to the triggered event, instructing the target object to perform the target function.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of creating a VXPLO media, comprising the steps of:
(a) creating at least one interactive media element, wherein the type of said interactive media element further comprises content elements, and functional elements; wherein each of said content elements corresponds to a resource file having media content; and
(b) editing a plurality of properties of each of said interactive media elements.

2. The method of creating a VXPLO media, as recited in claim 1, comprising the steps of:
(c) recording said properties of said interactive media elements into a recorder.

3. The method of creating a VXPLO media, as recited in claim 1, wherein said interactive media element is played by a web browser, wherein said web browser is operated from a smart device.

4. The method of creating a VXPLO media, as recited in claim 1, wherein the interactive media elements are web objects, wherein said web objects comprise a plurality of displayable objects and a plurality of non-displayable objects.

5. The method of creating a VXPLO media, as recited in claim 4, wherein the web objects include, but are not limited to one or more items of the following: image objects, video objects, audio objects, flash objects, html objects, text objects, image sequence objects, file objects, timer objects, track objects, event objects, counter objects, page objects, layer objects and screen objects.

6. The method of creating a VXPLO media, as recited in claim 4, wherein the properties of the web objects include, but are not limited to one or multiple items of the following: the displaying properties of all displayable objects; the changing of the displaying properties of the displayable objects over a period of time; the interactive relationships of in between different web objects of the same VXPLO media; the interactive relationships in between the web objects and the operations of the viewer of the VXPLO media.

7. The method of creating a VXPLO media, as recited in claim 6, wherein the displaying properties of a displayable object include, but are not limited to one or multiple items of the following: a URL that specifies the location of a resource file of the displayable object, the position of the displayable object, the width of the displayable object, the height of the displayable object, the background color of the displayable object, the opacity of the displayable object, the rotation angle of the displayable object, the visibility of the displayable object, the text of the displayable object, the font of the displayable object, the fill color of the displayable object, the line width of the displayable object, and the line color of the displayable object.

8. The method of creating a VXPLO media, as recited in claim 6, wherein the changing of the displaying properties of the displayable objects over a period of time is edited through and recorded within the properties of the non-displayable objects of said VXPLO media.

9. The method of creating a VXPLO media, as recited in claim 6, wherein the interactive relationships in between different web objects of the same VXPLO media, and the interactive relationships in between web objects and the operations of the viewer of the VXPLO media are edited through and recorded within the properties of the non-displayable objects of the VXPLO media.

10. The method of creating a VXPLO media, as recited in claim 6, wherein the interactive relationships of the web objects include the controlling of the properties of one web object by the changing of the properties of one another web object;

11. The method of creating a VXPLO media, as recited in, claim 6, wherein the operations of the viewer of the VXPLO media include, but are not limited to one or more items of the following: mouse operations, touch or tap operations, keyboard operations, physical operations of mobile devices transmitted by physical sensors.

12. A method of playing a VXPLO media, comprising the steps of:
(a1) creating all interactive media elements contained in a VXPLO media, wherein said interactive media elements further comprises a plurality of content elements, and a plurality of functional elements; wherein each of said content elements corresponds to a resource file having media content; and
(a2) playing all said interactive media elements according to the properties of the interactive media elements.

13. The method of playing a VXPLO media, as recited in claim 12, wherein step (a1) further comprises:
(a1.1) obtaining a recorder that records said properties of all said interactive media elements contained in said VXPLO media.

14. The method of playing a VXPLO media, as recited in claim 13, wherein step (a1) further comprises:
(a1.2) Obtaining said resource files of said content elements in said VXPLO media.

15. The method of playing a VXPLO media, as recited in claim 14, wherein said resource files of different content elements of said same VXPLO media are obtained from different locations.

16. The method of playing a VXPLO media, as recited in claim 14, wherein said resource files of said content elements and said recorder that records said properties of the interactive media element are obtained from different locations.

17. The method of playing a VXPLO media, as recited in claim 13, wherein before step (a1), further comprises a step of obtaining a playing engine for analyzing said recorder that records said properties of all said interactive media element contained in said VXPLO media, creating all said interactive media elements, and playing said interactive media elements according to said properties recorded in a recorder.

18. The method of playing a VXPLO media, as recited in claim 17, wherein the playing engine is obtained from the same location of said recorder that records said properties of all said interactive media elements contained in said VXPLO media.

19. The method of playing a VXPLO media, as recited in claim 18, wherein the means of obtaining said playing engine is recorded in an indicator of said VXPLO media. Wherein said indicator is a set of computer instructions or a piece of computer code that is capable of recording the means to obtain said playing engine.

20. A system of editing and playing a VXPLO media, comprising an editing engine and a playing engine, wherein said editing engine is for creating said VXPLO media through creating at least one interactive media element and a plurality of properties of each of said interactive media element, wherein said playing engine is for playing said VXPLO media, through displaying said interactive media elements of said VXPLO media according to said properties of said interactive media elements, wherein said interactive media elements further comprises a plurality of content elements, and a plurality of functional elements; wherein each of said content elements corresponds to a resource file having media content.

21. The system of editing and playing a VXPLO media, as recited in claim 20, further comprising an editing server and a client device, wherein said editing engine is acquired from said editing server onto the client device to provide the VXPLO media editing function.

22. The system of editing and playing a VXPLO media, as recited in claim 21, further comprising a third-party server and another client device, wherein the third-party web server hosts an indicator of the VXPLO media generated by said editing engine, wherein said another client device acquires said indicator of the VXPLO media from said third-party web server, acquires said playing engine, and plays the VXPLO media corresponding to said indicator.

23. The system of editing and playing a VXPLO media, as recited in claim 22, wherein an address to acquired the playing engine is specified in the indicator.

24. The system of editing and playing a VXPLO media, as recited in claim 22, wherein the another client device first acquires a recorder that records all said properties of said interactive media element contained in said VXPLO media, and then acquires the resource files of said content elements, and then plays all said interactive media elements according to said properties described in said recorder.

25. The system of editing and playing a VXPLO media, as recited in claim 20, further comprising a third-party server and another client device, wherein the third-party web server hosts an indicator of the VXPLO media generated by said editing engine, wherein said another client device acquires said indicator of the VXPLO media from said third-party web server, acquires said playing engine, and plays the VXPLO media corresponding to said indicator.

26. The system of editing and playing a VXPLO media, as recited in claim 20, wherein said editing engine further comprises a GUI module and an object class pool, wherein said GUI module generates a graphic user interface for editing said VXPLO media, wherein said object class pool stores the information of the types of all said interactive media elements supported by said editing engine.

27. The system of editing and playing a VXPLO media, as recited in claim 26, wherein the editing engine further comprises a recorder generation module for recording said properties of all interactive media elements contained in said VXPLO media, and generating a recorder for storing said recorded properties of said interactive media elements.

28. The system of claim 25, wherein the playing engine further comprises a an object class pool; Wherein the object class pool stores the information of the types of all said interactive media elements supported by the editing engine.

29. The system of editing and playing a VXPLO media, as recited in claim 28, wherein said playing engine further comprises a recorder analysis module for analyzing said recorder that records said properties of said interactive media elements contained in said VXPLO media.

30. A system of creating and using plug-in software applications, comprising: a developer platform and a user platform, wherein said developer platform provides means for a software developer to create one or more child software applications on the basis of a mother software application, wherein said user platform provides a user interface to let users select said one or more child software applications from said developer platform, and use the selected child software applications on the basis of said mother application.

31. The system of creating and using plug-in software applications, as recited in claim 30, wherein said selected child software applications appear in the user interface of said mother software application as additional functions or widgets.

32. The system of creating and using plug-in software applications, as recited in claim 30, wherein said mother software application is capable of being used independently without the adding of said child software applications from said developer platform.

33. The system of creating and using plug-in software applications, as recited in claim 30, wherein said developer platform further comprises a software API, wherein the API provides for developers to develop said child software applications for said mother software application;

34. The system of creating and using plug-in software applications, as recited in claim 30, wherein said user platform provides payment means for said users to purchase said child software applications that requires payment.

35. The system of creating and using plug-in software applications, as recited in claim 30, wherein said mother software application is an software application accessed and operated from a web browser.

36. The system of creating and using plug-in software applications, as recited in claim 35, wherein said web browser comprises one or multiple items of the following: Windows Internet Explorer, Safari, Mozilla Firefox, Opera, Google Chrome.

37. The system of creating and using plug-in software applications, as recited in claim 30, wherein said mother software application is a media editor for generating media contents.

38. The system of creating and using plug-in software applications, as recited in claim 37, wherein the media editor is for generating web contents that are accessed and played through a web browser.

39. The system of creating and using plug-in software applications, as recited in claim 30, wherein said user platform is accessed through a web browser.

40. A system of using a VXPLO media, comprising: an application server and a mobile device, wherein a VXPLO media operates through a carrier software application; wherein the mobile device acquires said VXPLO media from said application server, and runs said VXPLO media from said carrier software application installed on said mobile device.

41. The system for using a VXPLO media, as recited in claim 40, wherein said application server further comprises a user interface, wherein users are capable of selecting certain VXPLO medias to be installed onto said mobile device through said user interface.

42. The system for using a VXPLO media, as recited in claim 40, wherein the system further comprises a mother software application; wherein the mother software application is installed on said mobile device; wherein one or a plurality of said VXPLO medias are capable of being accessed through the mother software application.

43. The system for using a VXPLO media, as recited in claim 42, wherein said mother software application communicates with said application server, and synchronizes said VXPLO medias being accessed through the mother software application with a list of said VXPLO medias stored in said application server.

44. The system for using a VXPLO media, as recited in claim 42, wherein said application server further comprises a user interface; wherein through said user interface, users are capable of selecting one or a plurality of said VXPLO medias to be synchronized with said VXPLO medias to be accessed from said mother software application in said mobile device.

45. The system for using a VXPLO media, as recited in claim 42, wherein said mother software application sends a request to said application server, to demand one or a plurality of specific said VXPLO medias to be accessed from said mother software application.

46. The system for using a VXPLO media, as recited in claim 42, wherein said application server provides different accounts for different users; wherein different users may select a different set of said VXPLO medias to be accessed from said mother software application;

47. The system for using a VXPLO media, as recited in claim 42, wherein said application server sends an instruction to said mother software application to acquire the means to access one or a plurality of specific said VXPLO medias from said mother software application installed on said mobile device.
